(19) United States
(12) Patent Application Publication
(10) Pub. No.: US 2013/0346264 A1
(43) Pub. Date: Dec. 26, 2013

(54) Systems and Methods to Identify Affluence Levels of Accounts

(71) Applicant: Visa International Service Association, San Francisco, CA (US)

(72) Inventors: Nathan Kona Falkenborg, Singapore (SG); Abhisek Ghosh, Barrackpore (IN); John Gallaudette Wallace, San Francisco, CA (US)

(73) Assignee: Visa International Service Association, San Francisco, CA (US)

(21) Appl. No.: 13/899,355

(22) Filed: May 21, 2013

Related U.S. Application Data
(63) Continuation of application No. 13/711,532, filed on Dec. 11, 2012.
(60) Provisional application No. 61/569,757, filed on Dec. 12, 2011.

(51) Int. Cl. G06Q 40/00

(52) U.S. Cl. CPC G06Q 40/10
USPC 705/30

(57) ABSTRACT

Systems and methods are provided to generate information indicative of the opportunity to provide offers to affluent account holders, based on transaction data recording the transactions in the accounts of the account holders. The opportunity information may not be indicative of the actual overall spending level of the account holders. The opportunity information is generated based on rankings of the respective accounts based on spending characteristics in a plurality of merchant categories, such as international travel, dining out, specialty retail, etc.

### RELATED APPLICATIONS

The present application is a continuation of U.S. application Ser. No. 13/711,532, filed Dec. 11, 2012, and entitled “Systems and Methods to identify Affluence Levels of Accounts,” which claims priority to Prov. U.S. Pat. App. Ser. No. 61/569,757, filed Dec. 12, 2011, and entitled “Systems and Methods to Identify Affluence Levels of Accounts”, the entire disclosure of each of these applications is hereby incorporated herein by reference.

### FIELD OF THE TECHNOLOGY

At least some embodiments of the present disclosure relate to the processing of transactions, such as payments made via credit cards, debit cards, prepaid cards, etc., and/or providing information based on the processing of the transaction data.

### BACKGROUND

Millions of transactions occur daily through the use of payment cards, such as credit cards, debit cards, prepaid cards, etc. Corresponding records of the transactions are recorded in databases for settlement and financial record keeping (e.g., to meet the requirements of government regulations). Such data can be mined and analyzed for trends, statistics, and other analyses. Sometimes such data are mined for specific advertising goals, such as to provide targeted offers to account holders, as described in PCT Pub. No. WO 2008/067543 A2, published on Jun. 5, 2008 and entitled “Techniques for Targeted Offers.”

U.S. Pat. App. Pub. No. 2009/0216579, published on Aug. 27, 2009 and entitled “Tracking Online Advertising using Payment Services,” discloses a system in which a payment service identifies the activity of a user using a payment card as corresponding with an offer associated with an online advertisement presented to the user.

U.S. Pat. No. 6,298,330, issued on Oct. 2, 2001 and entitled “Communicating with a Computer Based on the Offline Purchase History of a Particular Consumer,” discloses a system in which a targeted advertisement is delivered to a computer in response to receiving an identifier, such as cookie, corresponding to the computer.

U.S. Pat. No. 7,035,855, issued on Apr. 25, 2006 and entitled “Process and System for Integrating Information from Disparate Databases for Purposes of Predicting Consumer Behavior,” discloses a system in which consumer transactional information is used for predicting consumer behavior.

U.S. Pat. No. 6,505,168, issued on Jan. 7, 2003 and entitled “System and Method for Gathering and Standardizing Customer Purchase Information for Target Marketing,” discloses a system in which categories and sub-categories are used to organize purchasing information by credit cards, debit cards, checks and the like. The customer purchase information is used to generate customer preference information for making targeted offers.

U.S. Pat. No. 7,444,658, issued on Oct. 28, 2008 and entitled “Method and System to Perform Content Targeting,” discloses a system in which advertisements are selected to be sent to users based on a user classification performed using credit card purchasing data.

U.S. Pat. App. Pub. No. 2005/0055275, published on Mar. 10, 2005 and entitled “System and Method for Analyzing Marketing Efforts,” discloses a system that evaluates the cause and effect of advertising and marketing programs using card transaction data.

U.S. Pat. App. Pub. No. 2008/0217397, published on Sep. 11, 2008 and entitled “Real-Time Awards Determinations,” discloses a system for facilitating transactions with real-time awards determinations for a cardholder, in which the award may be provided to the cardholder as a credit on the cardholder's statement.

The disclosures of the above discussed patent documents are hereby incorporated herein by reference.

### SUMMARY

An apparatus is disclosed in which means for storing transaction data of a plurality of accounts are provided. The apparatus also includes means for identifying spending characteristics in a plurality of merchant categories based on the transaction data; means for ranking the plurality of accounts based on the spending characteristics to generate ranks of the plurality of accounts in the plurality of merchant categories; and means for computing a score indicative of a opportunity of each account of the plurality of accounts based at least on the ranks of the plurality of accounts in the plurality of merchant categories.

The apparatus as disclosed may additionally provide means for determining a spending level of each account of the plurality of accounts; means for segmenting the plurality of accounts based on the spending level of and the score for each account of the plurality of accounts; means for counting for each respective account of the plurality of accounts, a number of months, within a predetermined period of time, in which months the respective account has at least one transaction meeting a set of predetermined requirements, wherein the score of the respective account is based on the number of months; means for determining decile values of the respective account based on the ranks of the respective account in the plurality of merchant categories among the plurality of accounts; means for combining the decile values of the respective account and the number of months counted for the respective account to obtain the score for the respective account; means for selecting a subset of the plurality of accounts based on the score; and means for providing offers to account holders of the subset of accounts.

A method is also provided in which transaction data of a plurality of accounts is stored by at least one specifically programmed processor. The method also provides identifying, by the at least one specifically programmed processor, spending characteristics in a plurality of merchant categories based on the transaction data; ranking, by the at least one specifically programmed processor, the plurality of accounts based on the spending characteristics to generate ranks of the plurality of accounts in the plurality of merchant categories; and computing, by the at least one specifically programmed processor, a score indicative of a opportunity of each account of the plurality of accounts based at least on the ranks of the plurality of accounts in the plurality of merchant categories.

A computing apparatus is also provided including at least one processor and a memory storing instructions configured to instruct the at least one processor to at least store transaction data of a plurality of accounts. The processor may also be instructed to identify spending characteristics in a plurality of merchant categories based on the transaction data; rank the plurality of accounts based on the spending characteristics to generate ranks of the plurality of accounts in the plurality of merchant categories, wherein the ranks identify decile rank of the respective account in spending in the plurality of merchant categories among the plurality of accounts, wherein the plurality of merchant categories includes restaurant, specialty retail, and lodging; and compute a score indicative of a opportunity of each respective account of the plurality of accounts based at least on the ranks of the plurality of accounts in the plurality of merchant categories.

A method is also provided which stores transaction data of a plurality of accounts. The method further identifying spending characteristics in a plurality of merchant categories based on the transaction data; ranks, by the computing apparatus, the plurality of accounts based on the spending characteristics to generate ranks of the plurality of accounts in the plurality of merchant categories; counts, by the computing apparatus, for each respective account of the plurality of accounts, a number of months, within a predetermined period of time, in which months the respective account has at least one transaction meeting a set of predetermined requirements, wherein the predetermined requirements include a requirement that the at least one transaction is made at retail locations outside a country in which an account holder of the respective account resides and a requirement that the at least one transaction is of a card-present type of transactions; computes, by the computing apparatus, a score indicative of a opportunity of each account of the plurality of accounts based at least on the ranks of the plurality of accounts in the plurality of merchant categories and the number of months; determines, by the computing apparatus, a spending level of each account of the plurality of accounts; segments the plurality of accounts based on the spending level of and the score for each account of the plurality of accounts; selects a subset of the plurality of accounts based on the score; and provides offers to account holders of the subset of accounts.

### BRIEF DESCRIPTION OF THE DRAWINGS

The embodiments are illustrated by way of example and not limitation in the figures of the accompanying drawings in which like references indicate similar elements.

FIG. 1 illustrates a system to provide services based on transaction data according to one embodiment.

FIG. 2 illustrates the generation of an aggregated spending profile according to one embodiment.

FIG. 3 shows a method to generate an aggregated spending profile according to one embodiment.

FIG. 4 shows a system to provide information based on transaction data according to one embodiment.

FIG. 5 illustrates a transaction terminal according to one embodiment.

FIG. 6 illustrates an account identifying device according to one embodiment.

FIG. 7 illustrates a data processing system according to one embodiment.

FIG. 8 shows the structure of account data for providing loyalty programs according to one embodiment.

FIG. 9 illustrates components of a system configured to determine whether an account is associated with a consumer or with a business in accordance with one embodiment.

FIG. 10 shows a method to generate an account classification model in accordance with one embodiment.

FIG. 11 shows an account classification model in accordance with one embodiment.

FIG. 12 shows an account classification model in accordance with one embodiment.

FIG. 13 shows a method to identify parameters of an account classification model in accordance with one embodiment.

FIG. 14 shows a model to generate a score indicative of the opportunity to provide offers to affluent account holders in accordance with one embodiment.

FIG. 15 shows a method to provide offers in accordance with one embodiment.

### DETAILED DESCRIPTION

### Introduction

In one embodiment, transaction data, such as records of transactions made via credit accounts, debit accounts, prepaid accounts, bank accounts, stored value accounts and the like, is processed to provide information for various services, such as reporting, benchmarking, advertising, content or offer selection, customization, personalization, prioritization, etc. In one embodiment, users are required to enroll in a service program and provide consent to allow the system to use related transaction data and/or other data for the related services. The system is configured to provide the services while protecting the privacy of the users in accordance with the enrollment agreement and user consent.

A computing apparatus of, or associated with, the transaction handler uses the transaction data and/or other data, such as account data, merchant data, search data, social networking data, web data, etc., to develop intelligence information about individual customers, or certain types or groups of customers. The intelligence information can be used to select, identify, generate, adjust, prioritize, and/or personalize advertisements/offers to the customers.

In one embodiment, systems, apparatuses and methods are configured to use the transaction data to provide intelligence information to allow issuers of payment accounts and/or payment devices, such as credit cards and debit cards, to identify personal accounts that may have business spending activities, and/or business accounts that may have personal spending activities. The intelligence information allows the issuers to tell apart accounts that are likely being used for business purposes and accounts that are likely being used for personal purposes, based on spending patterns in the transaction data in the respective accounts. When the account type of an account as issued is different from the actual type of primary usage of the account, the issuers may offer accounts suitable for the actual primary usage of the account to the respective account holders and thus align the account offer with the needs of the account holder. In one embodiment, transaction data (and hence actual spending behavior) is used to compute a score to identify the likelihood of an account primarily being used for business purposes, based on spending patterns reflected in the transaction data associated with the use of payment accounts. In one embodiment, the account holders who are determined to have an account of a type different from a type as indicated by the score are identified and targeted for an account re-alignment effort, such as an offer to migrate to a different payment product, an offer to adjust or add account features, etc. Some details in one embodiment are provided in the section entitled “BUSINESS SPENDING.”

In one embodiment, a computing apparatus is configured to determine a score to identify accounts that are more likely to be held by affluent users and which therefore represent opportunities for offers to upgrade to a different product type, and for different lifecycle strategies. Details and examples of the determination of the score and its usage are provided in the section entitled “OPPORTUNITY SCORE.”

In one embodiment, an advertising network is provided based on a transaction handler to present personalized or targeted advertisements/offers on behalf of advertisers.

In one embodiment, the computing apparatus correlates transactions with activities that occurred outside the context of the transaction, such as online advertisements presented to the customers that at least in part cause the offline transactions. The correlation data can be used to demonstrate the success of the advertisements, and/or to improve intelligence information about how individual customers and/or various types or groups of customers respond to the advertisements.

In one embodiment, the computing apparatus correlates, or provides information to facilitate the correlation of, transactions with online activities of the customers, such as searching, web browsing, social networking and consuming advertisements, with other activities, such as watching television programs, and/or with events, such as meetings, announcements, natural disasters, accidents, news announcements, etc.

In one embodiment, the correlation results are used in predictive models to predict transactions and/or spending patterns based on activities or events, to predict activities or events based on transactions or spending patterns, to provide alerts or reports, etc.

In one embodiment, a single entity operating the transaction handler performs various operations in the services provided based on the transaction data. For example, in the presentation of the personalized or targeted advertisements, the single entity may perform the operations such as generating the intelligence information, selecting relevant intelligence information for a given audience, selecting, identifying, adjusting, prioritizing, personalizing and/or generating advertisements based on selected relevant intelligence information, and facilitating the delivery of personalized or targeted advertisements, etc. Alternatively, the entity operating the transaction handler cooperates with one or more other entities by providing information to these entities to allow these entities to perform at least some of the operations for presentation of the personalized or targeted advertisements.

### System

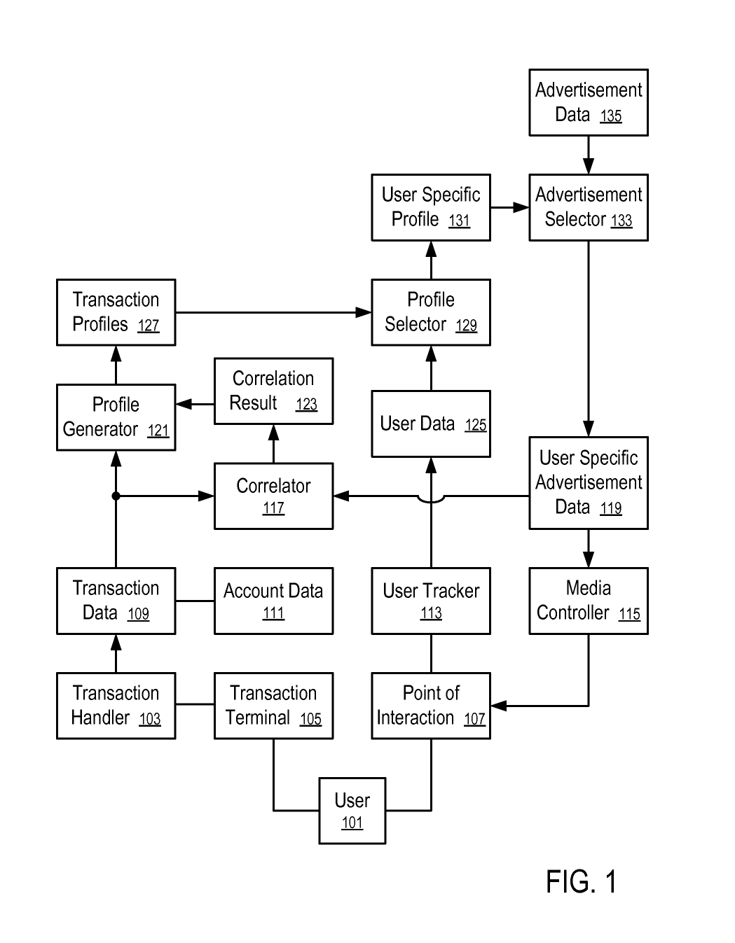

FIG. 1 illustrates a system to provide services based on transaction data according to one embodiment. In FIG. 1, the system includes a transaction terminal (105) to initiate financial transactions for a user (101), a transaction handler (103) to generate transaction data (109) from processing the financial transactions of the user (101) (and the financial transactions of other users), a profile generator (121) to generate transaction profiles (127) based on the transaction data (109) to provide information/intelligence about user preferences and spending patterns, a point of interaction (107) to provide information and/or offers to the user (101), a user tracker (113) to generate user data (125) to identify the user (101) using the point of interaction (107), a profile selector (129) to select a profile (131) specific to the user (101) identified by the user data (125), and an advertisement selector (133) to select, identify, generate, adjust, prioritize and/or personalize advertisements for presentation to the user (101) on the point of interaction (107) via a media controller (115).

In one embodiment, the system further includes a correlator (117) to correlate user specific advertisement data (119) with transactions resulting from the user specific advertisement data (119). The correlation results (123) can be used by the profile generator (121) to improve the transaction profiles (127).

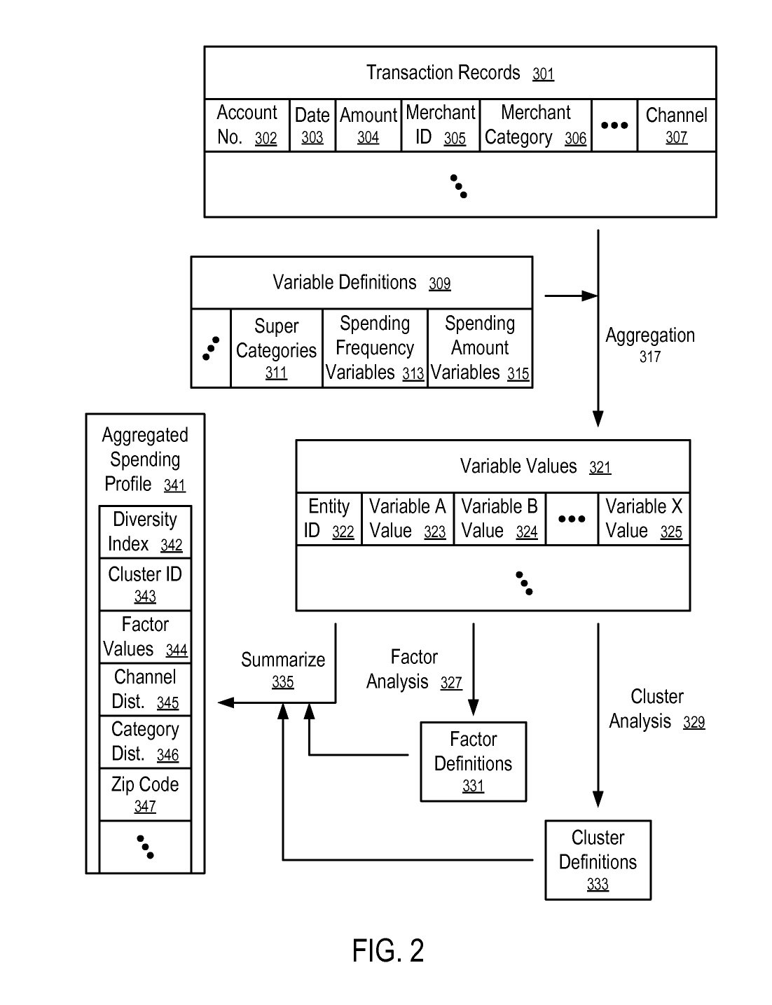

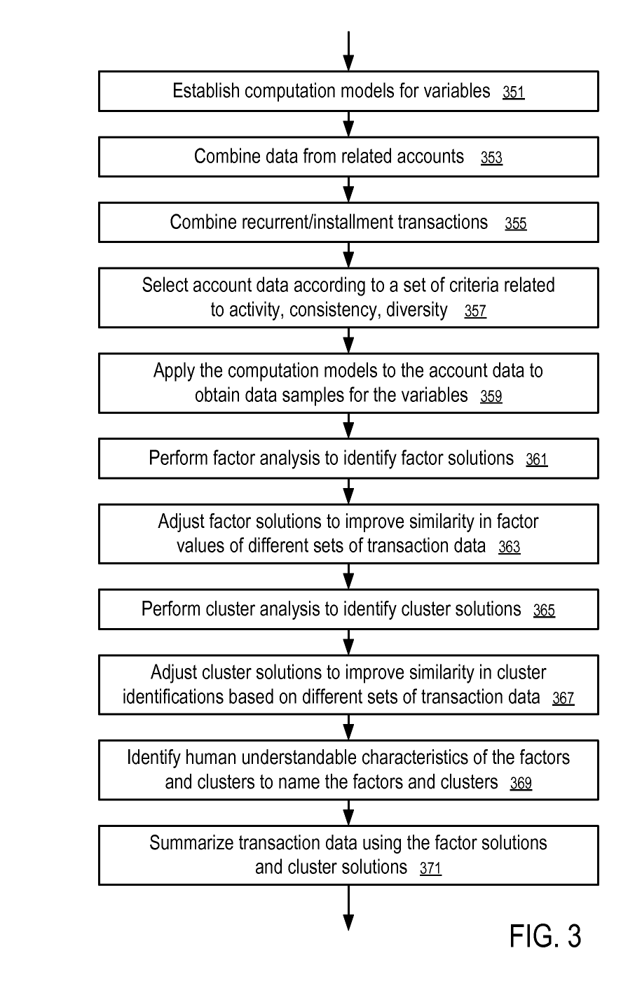

In one embodiment, the transaction profiles (127) are generated from the transaction data (109) in a way as illustrated in FIGS. 2 and 3. For example, in FIG. 3, an aggregated spending profile (341) is generated via the factor analysis (327) and cluster analysis (329) to summarize (335) the spending patterns/behaviors reflected in the transaction records (301).

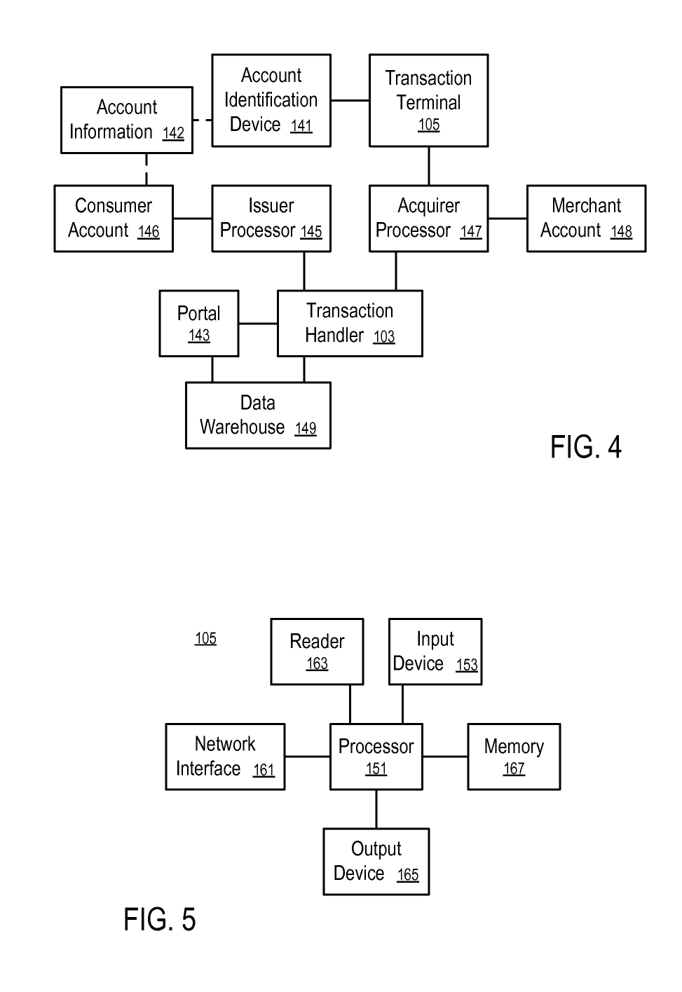

In one embodiment, a data warehouse (149) as illustrated in FIG. 4 is coupled with the transaction handler (103) to store the transaction data (109) and other data, such as account data (111), transaction profiles (127) and correlation results (123). In FIG. 4, a portal (143) is coupled with the data warehouse (149) to provide data or information derived from the transaction data (109), in response to a query request from a third party or as an alert or notification message.

In FIG. 4, the transaction handler (103) is coupled between an issuer processor (145) in control of a consumer account (146) and an acquirer processor (147) in control of a merchant account (148). An account identification device (141) is configured to carry the account information (142) that identifies the consumer account (146) with the issuer processor (145) and provide the account information (142) to the transaction terminal (105) of a merchant to initiate a transaction between the user (101) and the merchant.

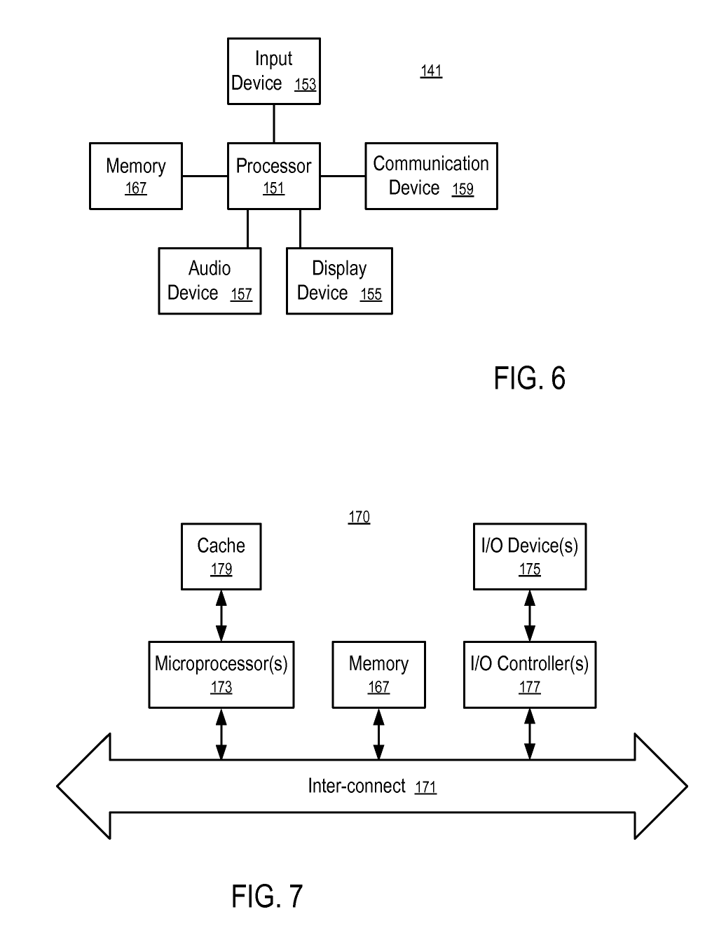

FIGS. 5 and 6 illustrate examples of transaction terminals (105) and account identification devices (141). FIG. 7 illustrates the structure of a data processing system that can be used to implement, with more or fewer elements, at least some of the components in the system, such as the point of interaction (107), the transaction handler (103), the portal (143), the data warehouse, the account identification device (141), the transaction terminal (105), the user tracker (113), the profile generator (121), the profile selector (129), the advertisement selector (133), the media controller (115), etc. Some embodiments use more or fewer components than those illustrated in FIGS. 1 and 4-7, as further discussed in the section entitled “VARIATIONS.”

In one embodiment, the transaction data (109) relates to financial transactions processed by the transaction handler (103); and the account data (111) relates to information about the account holders involved in the transactions. Further data, such as merchant data that relates to the location, business, products and/or services of the merchants that receive payments from account holders for their purchases, can be used in the generation of the transaction profiles (127, 341).

In one embodiment, the financial transactions are made via an account identification device (141), such as financial transaction cards (e.g., credit cards, debit cards, banking cards, etc.); the financial transaction cards may be embodied in various devices, such as plastic cards, chips, radio frequency identification (RFID) devices, mobile phones, personal digital assistants (PDAs), etc.; and the financial transaction cards may be represented by account identifiers (e.g., account numbers or aliases). In one embodiment, the financial transactions are made via directly using the account information (142), without physically presenting the account identification device (141).

Further features, modifications and details are provided in various sections of this description.

### Centralized Data Warehouse

In one embodiment, the transaction handler (103) maintains a centralized data warehouse (149) organized around the transaction data (109). For example, the centralized data warehouse (149) may include, and/or support the determination of, spend band distribution, transaction count and amount, merchant categories, merchant by state, cardholder segmentation by velocity scores, and spending within merchant target, competitive set and cross-section.

In one embodiment, the centralized data warehouse (149) provides centralized management but allows decentralized execution. For example, a third party strategic marketing analyst, statistician, marketer, promoter, business leader, etc., may access the centralized data warehouse (149) to analyze customer and shopper data, to provide follow-up analyses of customer contributions, to develop propensity models for increased conversion of marketing campaigns, to develop segmentation models for marketing, etc. The centralized data warehouse (149) can be used to manage advertisement campaigns and analyze response profitability.

In one embodiment, the centralized data warehouse (149) includes merchant data (e.g., data about sellers), customer/business data (e.g., data about buyers), and transaction records (301) between sellers and buyers over time. The centralized data warehouse (149) can be used to support corporate sales forecasting, fraud analysis reporting, sales/customer relationship management (CRM) business intelligence, credit risk prediction and analysis, advanced authorization reporting, merchant benchmarking, business intelligence for small business, rewards, etc.

In one embodiment, the transaction data (109) is combined with external data, such as surveys, benchmarks, search engine statistics, demographics, competition information, emails, etc., to flag key events and data values, to set customer, merchant, data or event triggers, and to drive new transactions and new customer contacts.

### Transaction Profile

In FIG. 1, the profile generator (121) generates transaction profiles (127) based on the transaction data (109), the account data (111), and/or other data, such as non-transactional data, wish lists, merchant provided information, address information, information from social network websites, information from credit bureaus, information from search engines, and other examples discussed in U.S. patent application Ser. No. 12/614,603, filed Nov. 9, 2009 and entitled “Analyzing Local Non-Transactional Data with Transactional Data in Predictive Models,” the disclosure of which is hereby incorporated herein by reference.

In one embodiment, the transaction profiles (127) provide intelligence information on the behavior, pattern, preference, propensity, tendency, frequency, trend, and budget of the user (101) in making purchases. In one embodiment, the transaction profiles (127) include information about what the user (101) owns, such as points, miles, or other rewards currency, available credit, and received offers, such as coupons loaded into the accounts of the user (101). In one embodiment, the transaction profiles (127) include information based on past offer/coupon redemption patterns. In one embodiment, the transaction profiles (127) include information on shopping patterns in retail stores as well as online, including frequency of shopping, amount spent in each shopping trip, distance of merchant location (retail) from the address of the account holder(s), etc.

In one embodiment, the transaction handler (103) provides at least part of the intelligence for the prioritization, generation, selection, customization and/or adjustment of the advertisement for delivery within a transaction process involving the transaction handler (103). For example, the advertisement may be presented to a customer in response to the customer making a payment via the transaction handler (103).

Some of the transaction profiles (127) are specific to the user (101), or to an account of the user (101), or to a group of users of which the user (101) is a member, such as a household, family, company, neighborhood, city, or group identified by certain characteristics related to online activities, offline purchase activities, merchant propensity, etc.

In one embodiment, the profile generator (121) generates and updates the transaction profiles (127) in batch mode periodically. In other embodiments, the profile generator (121) generates the transaction profiles (127) in real-time, or just in time, in response to a request received in the portal (143) for such profiles.

In one embodiment, the transaction profiles (127) include the values for a set of parameters. Computing the values of the parameters may involve counting transactions that meet one or more criteria, and/or building a statistically-based model in which one or more calculated values or transformed values are put into a statistical algorithm that weights each value to optimize its collective predictiveness for various predetermined purposes.

Further details and examples about the transaction profiles (127) in one embodiment are provided in the section entitled “AGGREGATED SPENDING PROFILE.”

### Non-Transactional Data

In one embodiment, the transaction data (109) is analyzed in connection with non-transactional data to generate transaction profiles (127) and/or to make predictive models.

In one embodiment, transactions are correlated with non-transactional events, such as news, conferences, shows, announcements, market changes, natural disasters, etc. to establish cause and effect relations to predict future transactions or spending patterns. For example, non-transactional data may include the geographic location of a news event, the date of an event from an events calendar, the name of a performer for an upcoming concert, etc. The non-transactional data can be obtained from various sources, such as newspapers, websites, blogs, social networking sites, etc.

In one embodiment, when the cause and effect relationships between the transactions and non-transactional events are known (e.g., based on prior research results, domain knowledge, expertise), the relationships can be used in predictive models to predict future transactions or spending patterns, based on events that occurred recently or are happening in real-time.

In one embodiment, the non-transactional data relates to events that happened in a geographical area local to the user (101) that performed the respective transactions. In one embodiment, a geographical area is local to the user (101) when the distance from the user (101) to locations in the geographical area is within a convenient range for daily or regular travel, such as 20, 50 or 100 miles from an address of the user (101), or within the same city or zip code area of an address of the user (101). Examples of analyses of local non-transactional data in connection with transaction data (109) in one embodiment are provided in U.S. patent application Ser. No. 12/614,603, filed Nov. 9, 2009 and entitled “Analyzing Local Non-Transactional Data with Transactional Data in Predictive Models,” the disclosure of which is hereby incorporated herein by reference.

In one embodiment, the non-transactional data is not limited to local non-transactional data. For example, national non-transactional data can also be used.

In one embodiment, the transaction records (301) are analyzed in frequency domain to identify periodic features in spending events. The periodic features in the past transaction records (301) can be used to predict the probability of a time window in which a similar transaction would occur. For example, the analysis of the transaction data (109) can be used to predict when a next transaction having the periodic feature would occur, with which merchant, the probability of a repeated transaction with a certain amount, the probability of exception, the opportunity to provide an advertisement or offer such as a coupon, etc. In one embodiment, the periodic features are detected through counting the number of occurrences of pairs of transactions that occurred within a set of predetermined time intervals and separating the transaction pairs based on the time intervals. Some examples and techniques for the prediction of future transactions based on the detection of periodic features in one embodiment are provided in U.S. patent application Ser. No. 12/773,770, filed May 4, 2010 and entitled “Frequency-Based Transaction Prediction and Processing,” the disclosure of which is hereby incorporated herein by reference.

Techniques and details of predictive modeling in one embodiment are provided in U.S. Pat. Nos. 6,119,103, 6,018,723, 6,658,393, 6,598,030, and 7,227,950, the disclosures of which are hereby incorporated herein by reference.

In one embodiment, offers are based on the point-of-service to offeree distance to allow the user (101) to obtain in-person services. In one embodiment, the offers are selected based on transaction history and shopping patterns in the transaction data (109) and/or the distance between the user (101) and the merchant. In one embodiment, offers are provided in response to a request from the user (101), or in response to a detection of the location of the user (101). Examples and details of at least one embodiment are provided in U.S. patent application Ser. No. 11/767,218, filed Jun. 22, 2007, assigned Pub. No. 2008/0319843, and entitled “Supply of Requested Offer Based on Point-of-Service to Offeree Distance,” U.S. patent application Ser. No. 11/755,575, filed May 30, 2007, assigned Pub. No. 2008/0300973, and entitled “Supply of Requested Offer Based on Offeree Transaction History,” U.S. patent application Ser. No. 11/855,042, filed Sep. 13, 2007, assigned Pub. No. 2009/0076896, and entitled “Merchant Supplied Offer to a Consumer within a Predetermined Distance,” U.S. patent application Ser. No. 11/855,069, filed Sep. 13, 2007, assigned Pub. No. 2009/0076925, and entitled “Offeree Requested Offer Based on Point-of Service to Offeree Distance,” and U.S. patent application Ser. No. 12/428,302, filed Apr. 22, 2009 and entitled “Receiving an Announcement Triggered by Location Data,” the disclosures of which applications are hereby incorporated herein by reference.

### Targeting Advertisement

In FIG. 1, an advertisement selector (133) prioritizes, generates, selects, adjusts, and/or customizes the available advertisement data (135) to provide user specific advertisement data (119) based at least in part on the user specific profile (131). The advertisement selector (133) uses the user specific profile (131) as a filter and/or a set of criteria to generate, identify, select and/or prioritize advertisement data for the user (101). A media controller (115) delivers the user specific advertisement data (119) to the point of interaction (107) for presentation to the user (101) as the targeted and/or personalized advertisement.

In one embodiment, the user data (125) includes the characterization of the context at the point of interaction (107). Thus, the use of the user specific profile (131), selected using the user data (125), includes the consideration of the context at the point of interaction (107) in selecting the user specific advertisement data (119).

In one embodiment, in selecting the user specific advertisement data (119), the advertisement selector (133) uses not only the user specific profile (131), but also information regarding the context at the point of interaction (107). For example, in one embodiment, the user data (125) includes information regarding the context at the point of interaction (107); and the advertisement selector (133) explicitly uses the context information in the generation or selection of the user specific advertisement data (119).

In one embodiment, the advertisement selector (133) may query for specific information regarding the user (101) before providing the user specific advertisement data (119). The queries may be communicated to the operator of the transaction handler (103) and, in particular, to the transaction handler (103) or the profile generator (121). For example, the queries from the advertisement selector (133) may be transmitted and received in accordance with an application programming interface or other query interface of the transaction handler (103), the profile generator (121) or the portal (143) of the transaction handler (103).

In one embodiment, the queries communicated from the advertisement selector (133) may request intelligence information regarding the user (101) at any level of specificity (e.g., segment level, individual level). For example, the queries may include a request for a certain field or type of information in a cardholders aggregate spending profile (341). As another example, the queries may include a request for the spending level of the user (101) in a certain merchant category over a prior time period (e.g., six months).

In one embodiment, the advertisement selector (133) is operated by an entity that is separate from the entity that operates the transaction handler (103). For example, the advertisement selector (133) may be operated by a search engine, a publisher, an advertiser, an ad network, or an online merchant. The user specific profile (131) is provided to the advertisement selector (133) to assist the customization of the user specific advertisement data (119).

In one embodiment, advertising is targeted based on shopping patterns in a merchant category (e.g., as represented by a Merchant Category Code (MCC)) that has high correlation of spending propensity with other merchant categories (e.g., other MCCs). For example, in the context of a first MCC for a targeted audience, a profile identifying second MCCs that have high correlation of spending propensity with the first MCC can be used to select advertisements for the targeted audience.

In one embodiment, the aggregated spending profile (341) is used to provide intelligence information about the spending patterns, preferences, and/or trends of the user (101). For example, a predictive model can be established based on the aggregated spending profile (341) to estimate the needs of the user (101). For example, the factor values (344) and/or the cluster ID (343) in the aggregated spending profile (341) can be used to determine the spending preferences of the user (101). For example, the channel distribution (345) in the aggregated spending profile (341) can be used to provide a customized offer targeted for a particular channel, based on the spending patterns of the user (101).

In one embodiment, mobile advertisements, such as offers and coupons, are generated and disseminated based on aspects of prior purchases, such as timing, location, and nature of the purchases, etc. In one embodiment, the size of the benefit of the offer or coupon is based on purchase volume or spending amount of the prior purchase and/or the subsequent purchase that may qualify for the redemption of the offer. Further details and examples of one embodiment are provided in U.S. patent application Ser. No. 11/960,162, filed Dec. 19, 2007, assigned Pub. No 2008/0201226, and entitled “Mobile Coupon Method and Portable Consumer Device for Utilizing Same,” the disclosure of which is hereby incorporated herein by reference.

In one embodiment, conditional rewards are provided to the user (101); and the transaction handler (103) monitors the transactions of the user (101) to identify redeemable rewards that have satisfied the respective conditions. In one embodiment, the conditional rewards are selected based on transaction data (109). Further details and examples of one embodiment are provided in U.S. patent application Ser. No. 11/862,487, filed Sep. 27, 2007 and entitled “Consumer Specific Conditional Rewards,” the disclosure of which is hereby incorporated herein by reference. The techniques to detect the satisfied conditions of conditional rewards can also be used to detect the transactions that satisfy the conditions specified to locate the transactions that result from online activities, such as online advertisements, searches, etc., to correlate the transactions with the respective online activities.

Further details about targeted offer delivery in one embodiment are provided in U.S. patent application Ser. No. 12/185,332, filed Aug. 4, 2008, assigned Pub. No. 2010/0030644, and entitled “Targeted Advertising by Payment Processor History of Cashless Acquired Merchant Transaction on Issued Consumer Account,” and in U.S. patent application Ser. No. 12/849,793, filed Aug. 3, 2010 and entitled “Systems and Methods for Targeted Advertisement Delivery,” the disclosures of which are hereby incorporated herein by reference.

### Profile Matching

In FIG. 1, the user tracker (113) obtains and generates context information about the user (101) at the point of interaction (107), including user data (125) that characterizes and/or identifies the user (101). The profile selector (129) selects a user specific profile (131) from the set of transaction profiles (127) generated by the profile generator (121), based on matching the characteristics of the transaction profiles (127) and the characteristics of the user data (125). For example, the user data (125) indicates a set of characteristics of the user (101); and the profile selector (129) selects the user specific profile (131) that is for a particular user or a group of users and that best matches the set of characteristics specified by the user data (125).

In one embodiment, the profile selector (129) receives the transaction profiles (127) in a batch mode. The profile selector (129) selects the user specific profile (131) from the batch of transaction profiles (127) based on the user data (125). Alternatively, the profile generator (121) generates the transaction profiles (127) in real-time; and the profile selector (129) uses the user data (125) to query the profile generator (121) to generate the user specific profile (131) in real-time, or just in time. The profile generator (121) generates the user specific profile (131) that best matches the user data (125).

In one embodiment, the user tracker (113) identifies the user (101) based on the user activity on the transaction terminal (105) (e.g., having visited a set of websites, currently visiting a type of web pages, search behavior, etc.).

In one embodiment, the user data (125) includes an identifier of the user (101), such as a global unique identifier (GUID), a personal account number (PAN) (e.g., credit card number, debit card number, or other card account number), or other identifiers that uniquely and persistently identify the user (101) within a set of identifiers of the same type. Alternatively, the user data (125) may include other identifiers, such as an Internet Protocol (IP) address of the user (101), a name or user name of the user (101), or a browser cookie ID, which identify the user (101) in a local, temporary, transient and/or anonymous manner. Some of these identifiers of the user (101) may be provided by publishers, advertisers, ad networks, search engines, merchants, or the user tracker (113). In one embodiment, such identifiers are correlated to the user (101) based on the overlapping or proximity of the time period of their usage to establish an identification reference table.

In one embodiment, the identification reference table is used to identify the account information (142) (e.g., account number (302)) based on characteristics of the user (101) captured in the user data (125), such as browser cookie ID, IP addresses, and/or timestamps on the usage of the IP addresses. In one embodiment, the identification reference table is maintained by the operator of the transaction handler (103). Alternatively, the identification reference table is maintained by an entity other than the operator of the transaction handler (103).

In one embodiment, the user tracker (113) determines certain characteristics of the user (101) to describe a type or group of users of which the user (101) is a member. The transaction profile of the group is used as the user specific profile (131). Examples of such characteristics include geographical location or neighborhood, types of online activities, specific online activities, or merchant propensity. In one embodiment, the groups are defined based on aggregate information (e.g., by time of day, or household), or segment (e.g., by cluster, propensity, demographics, cluster IDs, and/or factor values). In one embodiment, the groups are defined in part via one or more social networks. For example, a group may be defined based on social distances to one or more users on a social network website, interactions between users on a social network website, and/or common data in social network profiles of the users in the social network website.

In one embodiment, the user data (125) may match different profiles at a different granularity or resolution (e.g., account, user, family, company, neighborhood, etc.), with different degrees of certainty. The profile selector (129) and/or the profile generator (121) may determine or select the user specific profile (131) with the finest granularity or resolution with acceptable certainty. Thus, the user specific profile (131) is most specific or closely related to the user (101).

In one embodiment, the advertisement selector (133) uses further data in prioritizing, selecting, generating, customizing and adjusting the user specific advertisement data (119). For example, the advertisement selector (133) may use search data in combination with the user specific profile (131) to provide benefits or offers to a user (101) at the point of interaction (107). For example, the user specific profile (131) can be used to personalize the advertisement, such as adjusting the placement of the advertisement relative to other advertisements, adjusting the appearance of the advertisement, etc.

### Browser Cookie

In one embodiment, the user data (125) uses browser cookie information to identify the user (101). The browser cookie information is matched to account information (142) or the account number (302) to identify the user specific profile (131), such as aggregated spending profile (341) to present effective, timely, and relevant marketing information to the user (101), via the preferred communication channel (e.g., mobile communications, web, mail, email, POS, etc.) within a window of time that could influence the spending behavior of the user (101). Based on the transaction data (109), the user specific profile (131) can improve audience targeting for online advertising. Thus, customers will get better advertisements and offers presented to them; and the advertisers will achieve better return-on-investment for their advertisement campaigns.

In one embodiment, the browser cookie that identifies the user (101) in online activities, such as web browsing, online searching, and using social networking applications, can be matched to an identifier of the user (101) in account data (111), such as the account number (302) of a financial payment card of the user (101) or the account information (142) of the account identification device (141) of the user (101). In one embodiment, the identifier of the user (101) can be uniquely identified via matching IP address, timestamp, cookie ID and/or other user data (125) observed by the user tracker (113).

In one embodiment, a look up table is used to map browser cookie information (e.g., IP address, timestamp, cookie ID) to the account data (111) that identifies the user (101) in the transaction handler (103). The look up table may be established via correlating overlapping or common portions of the user data (125) observed by different entities or different user trackers (113).

For example, in one embodiment, a first user tracker (113) observes the card number of the user (101) at a particular IP address for a time period identified by a timestamp (e.g., via an online payment process); a second user tracker (113) observes the user (101) having a cookie ID at the same IP address for a time period near or overlapping with the time period observed by the first user tracker (113). Thus, the cookie ID as observed by the second user tracker (113) can be linked to the card number of the user (101) as observed by the first user tracker (113). The first user tracker (113) may be operated by the same entity operating the transaction handler (103) or by a different entity. Once the correlation between the cookie ID and the card number is established via a database or a look up table, the cookie ID can be subsequently used to identify the card number of the user (101) and the account data (111).

In one embodiment, the portal (143) is configured to observe a card number of a user (101) while the user (101) uses an IP address to make an online transaction. Thus, the portal (143) can identify a consumer account (146) based on correlating an IP address used to identify the user (101) and IP addresses recorded in association with the consumer account (146).

For example, in one embodiment, when the user (101) makes a payment online by submitting the account information (142) to the transaction terminal (105) (e.g., an online store), the transaction handler (103) obtains the IP address from the transaction terminal (105) via the acquirer processor (147). The transaction handler (103) stores data to indicate the use of the account information (142) at the IP address at the time of the transaction request. When an IP address in the query received in the portal (143) matches the IP address previously recorded by the transaction handler (103), the portal (143) determines that the user (101) identified by the IP address in the request is the same user (101) associated with the account of the transaction initiated at the IP address. In one embodiment, a match is found when the time of the query request is within a predetermined time period from the transaction request, such as a few minutes, one hour, a day, etc. In one embodiment, the query may also include a cookie ID representing the user (101). Thus, through matching the IP address, the cookie ID is associated with the account information (142) in a persistent way.

In one embodiment, the portal (143) obtains the IP address of the online transaction directly. For example, in one embodiment, a user (101) chooses to use a password in the account data (111) to protect the account information (142) for online transactions. When the account information (142) is entered into the transaction terminal (105) (e.g., an online store or an online shopping cart system), the user (101) is connected to the portal (143) for the verification of the password (e.g., via a pop up window, or via redirecting the web browser of the user (101)). The transaction handler (103) accepts the transaction request after the password is verified via the portal (143). Through this verification process, the portal (143) and/or the transaction handler (103) obtain the IP address of the user (101) at the time the account information (142) is used.

In one embodiment, the web browser of the user (101) communicates the user provided password to the portal (143) directly without going through the transaction terminal (105) (e.g., the server of the merchant). Alternatively, the transaction terminal (105) and/or the acquirer processor (147) may relay the password communication to the portal (143) or the transaction handler (103).

In one embodiment, the portal (143) is configured to identify the consumer account (146) based on the IP address identified in the user data (125) through mapping the IP address to a street address. For example, in one embodiment, the user data (125) includes an IP address to identify the user (101); and the portal (143) can use a service to map the IP address to a street address. For example, an Internet service provider knows the street address of the currently assigned IP address. Once the street address is identified, the portal (143) can use the account data (111) to identify the consumer account (146) that has a current address at the identified street address. Once the consumer account (146) is identified, the portal (143) can provide a transaction profile (131) specific to the consumer account (146) of the user (101).

In one embodiment, the portal (143) uses a plurality of methods to identify consumer accounts (146) based on the user data (125). The portal (143) combines the results from the different methods to determine the most likely consumer account (146) for the user data (125).

Details about the identification of consumer account (146) based on user data (125) in one embodiment are provided in U.S. patent application Ser. No. 12/849,798, filed Aug. 3, 2010 and entitled “Systems and Methods to Match Identifiers,” the disclosure of which is hereby incorporated herein by reference.

### Close the Loop

In one embodiment, the correlator (117) is used to “close the loop” for the tracking of consumer behavior across an on-line activity and an “off-line” activity that results at least in part from the on-line activity. In one embodiment, online activities, such as searching, web browsing, social networking, and/or consuming online advertisements, are correlated with respective transactions to generate the correlation result (123) in FIG. 1. The respective transactions may occur offline, in “brick and mortar” retail stores, or online but in a context outside the online activities, such as a credit card purchase that is performed in a way not visible to a search company that facilitates the search activities.

In one embodiment, the correlator (117) is to identify transactions resulting from searches or online advertisements. For example, in response to a query about the user (101) from the user tracker (113), the correlator (117) identifies an offline transaction performed by the user (101) and sends the correlation result (123) about the offline transaction to the user tracker (113), which allows the user tracker (113) to combine the information about the offline transaction and the online activities to provide significant marketing advantages.

For example, a marketing department could correlate an advertising budget to actual sales. For example, a marketer can use the correlation result (123) to study the effect of certain prioritization strategies, customization schemes, etc. on the impact on the actual sales. For example, the correlation result (123) can be used to adjust or prioritize advertisement placement on a web site, a search engine, a social networking site, an online marketplace, or the like.

In one embodiment, the profile generator (121) uses the correlation result (123) to augment the transaction profiles (127) with data indicating the rate of conversion from searches or advertisements to purchase transactions. In one embodiment, the correlation result (123) is used to generate predictive models to determine what a user (101) is likely to purchase when the user (101) is searching using certain keywords or when the user (101) is presented with an advertisement or offer. In one embodiment, the portal (143) is configured to report the correlation result (123) to a partner, such as a search engine, a publisher, or a merchant, to allow the partner to use the correlation result (123) to measure the effectiveness of advertisements and/or search result customization, to arrange rewards, etc.

Illustratively, a search engine entity may display a search page with particular advertisements for flat panel televisions produced by companies A, B, and C. The search engine entity may then compare the particular advertisements presented to a particular consumer with transaction data of that consumer and may determine that the consumer purchased a flat panel television produced by Company B. The search engine entity may then use this information and other information derived from the behavior of other consumers to determine the effectiveness of the advertisements provided by companies A, B, and C. The search engine entity can determine if the placement, the appearance, or other characteristic of the advertisement results in actual increased sales. Adjustments to advertisements (e.g., placement, appearance, etc.) may be made to facilitate maximum sales.

In one embodiment, the correlator (117) matches the online activities and the transactions based on matching the user data (125) provided by the user tracker (113) and the records of the transactions, such as transaction data (109) or transaction records (301). In another embodiment, the correlator (117) matches the online activities and the transactions based on the redemption of offers/benefits provided in the user specific advertisement data (119).

In one embodiment, the portal (143) is configured to receive a set of conditions and an identification of the user (101), determine whether there is any transaction of the user (101) that satisfies the set of conditions, and if so, provide indications of the transactions that satisfy the conditions and/or certain details about the transactions, which allows the requester to correlate the transactions with certain user activities, such as searching, web browsing, consuming advertisements, etc.

In one embodiment, the requester may not know the account number (302) of the user (101); and the portal (143) is to map the identifier provided in the request to the account number (302) of the user (101) to provide the requested information. Examples of the identifier being provided in the request to identify the user (101) include an identification of an iFrame of a web page visited by the user (101), a browser cookie ID, an IP address and the day and time corresponding to the use of the IP address, etc.

The information provided by the portal (143) can be used in pre-purchase marketing activities, such as customizing content or offers, prioritizing content or offers, selecting content or offers, etc., based on the spending pattern of the user (101). The content that is customized, prioritized, selected, or recommended may be the search results, blog entries, items for sale, etc.

The information provided by the portal (143) can be used in post-purchase activities. For example, the information can be used to correlate an offline purchase with online activities. For example, the information can be used to determine purchases made in response to media events, such as television programs, advertisements, news announcements, etc.

Details about profile delivery, online activity to offline purchase tracking, techniques to identify the user specific profile (131) based on user data (125) (such as IP addresses), and targeted delivery of advertisement/offer/benefit in some embodiments are provided in U.S. patent application Ser. No. 12/849,789, filed Aug. 3, 2010 and entitled “Systems and Methods for Closing the Loop between Online Activities and Offline Purchases,” U.S. patent application Ser. No. 12/851,138, filed Aug. 5, 2010 and entitled “Systems and Methods for Propensity Analysis and Validation,” and U.S. patent application Ser. No. 12/854,022, filed Aug. 10, 2010 and entitled “System and Methods for Targeting Offers,” the disclosures of which applications are incorporated herein by reference.

### Matching Advertisement & Transaction

In one embodiment, the correlator (117) is configured to receive information about the user specific advertisement data (119), monitor the transaction data (109), identify transactions that can be considered results of the advertisement corresponding to the user specific advertisement data (119), and generate the correlation result (123), as illustrated in FIG. 1.

When the advertisement and the corresponding transaction both occur in an online checkout process, a website used for the online checkout process can be used to correlate the transaction and the advertisement. However, the advertisement and the transaction may occur in separate processes and/or under control of different entities (e.g., when the purchase is made offline at a retail store, while the advertisement is presented outside the retail store). In one embodiment, the correlator (117) uses a set of correlation criteria to identify the transactions that can be considered as the results of the advertisements.

In one embodiment, the correlator (117) identifies the transactions linked or correlated to the user specific advertisement data (119) based on various criteria. For example, the user specific advertisement data (119) may include a coupon offering a benefit contingent upon a purchase made according to the user specific advertisement data (119). The use of the coupon identifies the user specific advertisement data (119), and thus allows the correlator (117) to correlate the transaction with the user specific advertisement data (119).

In one embodiment, the user specific advertisement data (119) is associated with the identity or characteristics of the user (101), such as global unique identifier (GUID), personal account number (PAN), alias, IP address, name or user name, geographical location or neighborhood, household, user group, and/or user data (125). The correlator (117) can link or match the transactions with the advertisements based on the identity or characteristics of the user (101) associated with the user specific advertisement data (119). For example, the portal (143) may receive a query identifying the user data (125) that tracks the user (101) and/or characteristics of the user specific advertisement data (119); and the correlator (117) identifies one or more transactions matching the user data (125) and/or the characteristics of the user specific advertisement data (119) to generate the correlation result (123).

In one embodiment, the correlator (117) identifies the characteristics of the transactions and uses the characteristics to search for advertisements that match the transactions. Such characteristics may include GUID, PAN, IP address, card number, browser cookie information, coupon, alias, etc.

In FIG. 1, the profile generator (121) uses the correlation result (123) to enhance the transaction profiles (127) generated from the profile generator (121). The correlation result (123) provides details on the purchases and/or indicates the effectiveness of the user specific advertisement data (119).

In one embodiment, the correlation result (123) is used to demonstrate to the advertisers the effectiveness of the advertisements, to process incentive or rewards associated with the advertisements, to obtain at least a portion of advertisement revenue based on the effectiveness of the advertisements, to improve the selection of advertisements, etc.

### Coupon Matching

In one embodiment, the correlator (117) identifies a transaction that is a result of an advertisement (e.g., 119) when an offer or benefit provided in the advertisement is redeemed via the transaction handler (103) in connection with a purchase identified in the advertisement.

For example, in one embodiment, when the offer is extended to the user (101), information about the offer can be stored in association with the account of the user (101) (e.g., as part of the account data (111)). The user (101) may visit the portal (143) of the transaction handler (103) to view the stored offer.

The offer stored in the account of the user (101) may be redeemed via the transaction handler (103) in various ways. For example, in one embodiment, the correlator (117) may download the offer to the transaction terminal (105) via the transaction handler (103) when the characteristics of the transaction at the transaction terminal (105) match the characteristics of the offer.

After the offer is downloaded to the transaction terminal (105), the transaction terminal (105) automatically applies the offer when the condition of the offer is satisfied in one embodiment. Alternatively, the transaction terminal (105) allows the user (101) to selectively apply the offers downloaded by the correlator (117) or the transaction handler (103). In one embodiment, the correlator (117) sends reminders to the user (101) at a separate point of interaction (107) (e.g., a mobile phone) to remind the user (101) to redeem the offer. In one embodiment, the transaction handler (103) applies the offer (e.g., via statement credit), without having to download the offer (e.g., coupon) to the transaction terminal (105). Examples and details of redeeming offers via statement credit are provided in U.S. patent application Ser. No. 12/566,350, filed Sep. 24, 2009 and entitled “Real-Time Statement Credits and Notifications,” the disclosure of which is hereby incorporated herein by reference.

In one embodiment, the offer is captured as an image and stored in association with the account of the user (101). Alternatively, the offer is captured in a text format (e.g., a code and a set of criteria), without replicating the original image of the coupon.

In one embodiment, when the coupon is redeemed, the advertisement presenting the coupon is correlated with a transaction in which the coupon is redeemed, and/or is determined to have resulted in a transaction. In one embodiment, the correlator (117) identifies advertisements that have resulted in purchases, without having to identify the specific transactions that correspond to the advertisements.

Details about offer redemption via the transaction handler (103) in one embodiment are provided in U.S. patent application Ser. No. 12/849,801, filed Aug. 3, 2010 and entitled “Systems and Methods for Multi-Channel Offer Redemption,” the disclosure of which is hereby incorporated herein by reference.

### On ATM & POS Terminal

In one example, the transaction terminal (105) is an automatic teller machine (ATM), which is also the point of interaction (107). When the user (101) approaches the ATM to make a transaction (e.g., to withdraw cash via a credit card or debit card), the ATM transmits account information (142) to the transaction handler (103). The account information (142) can also be considered as the user data (125) to select the user specific profile (131). The user specific profile (131) can be sent to an advertisement network to query for a targeted advertisement. After the advertisement network matches the user specific profile (131) with user specific advertisement data (119) (e.g., a targeted advertisement), the transaction handler (103) may send the advertisement to the ATM, together with the authorization for cash withdrawal.

In one embodiment, the advertisement shown on the ATM includes a coupon that offers a benefit that is contingent upon the user (101) making a purchase according to the advertisement. The user (101) may view the offer presented on a white space on the ATM screen and select to load or store the coupon in a storage device of the transaction handler (103) under the account of the user (101). The transaction handler (103) communicates with the bank to process the cash withdrawal. After the cash withdrawal, the ATM prints the receipt which includes a confirmation of the coupon, or a copy of the coupon. The user (101) may then use the coupon printed on the receipt. Alternatively, when the user (101) uses the same account to make a relevant purchase, the transaction handler (103) may automatically apply the coupon stored under the account of the user (101), or automatically download the coupon to the relevant transaction terminal (105), or transmit the coupon to the mobile phone of the user (101) to allow the user (101) to use the coupon via a display of the coupon on the mobile phone. The user (101) may visit a web portal (143) of the transaction handler (103) to view the status of the coupons collected in the account of the user (101).

In one embodiment, the advertisement is forwarded to the ATM via the data stream for authorization. In another embodiment, the ATM makes a separate request to a server of the transaction handler (103) (e.g., a web portal) to obtain the advertisement. Alternatively, or in combination, the advertisement (including the coupon) is provided to the user (101) at separate, different points of interactions, such as via a text message to a mobile phone of the user (101), via an email, via a bank statement, etc.

Details of presenting targeted advertisements on ATMs based on purchasing preferences and location data in one embodiment are provided in U.S. patent application Ser. No. 12/266,352, filed Nov. 6, 2008 and entitled “System Including Automated Teller Machine with Data Bearing Medium,” the disclosure of which is hereby incorporated herein by reference.

In another example, the transaction terminal (105) is a POS terminal at the checkout station in a retail store (e.g., a self-service checkout register). When the user (101) pays for a purchase via a payment card (e.g., a credit card or a debit card), the transaction handler (103) provides a targeted advertisement having a coupon obtained from an advertisement network. The user (101) may load the coupon into the account of the payment card and/or obtain a hardcopy of the coupon from the receipt. When the coupon is used in a transaction, the advertisement is linked to the transaction.

Details of presenting targeted advertisements during the process of authorizing a financial payment card transaction in one embodiment are provided in U.S. patent application Ser. No. 11/799,549, filed May 1, 2007, assigned Pub No. 2008/0275771, and entitled “Merchant Transaction Based Advertising,” the disclosure of which is hereby incorporated herein by reference.

In one embodiment, the user specific advertisement data (119), such as offers or coupons, is provided to the user (101) via the transaction terminal (105) in connection with an authorization message during the authorization of a transaction processed by the transaction handler (103). The authorization message can be used to communicate the rewards qualified for by the user (101) in response to the current transaction, the status and/or balance of rewards in a loyalty program, etc. Examples and details related to the authorization process in one embodiment are provided in U.S. patent application Ser. No. 11/266,766, filed Nov. 2, 2005, assigned Pub. No. 2007/0100691, and entitled “Method and System for Conducting Promotional Programs,” the disclosure of which is hereby incorporated herein by reference.

In one embodiment, when the user (101) is conducting a transaction with a first merchant via the transaction handler (103), the transaction handler (103) may determine whether the characteristics of the transaction satisfy the conditions specified for an announcement, such as an advertisement, offer or coupon, from a second merchant. If the conditions are satisfied, the transaction handler (103) provides the announcement to the user (101). In one embodiment, the transaction handler (103) may auction the opportunity to provide the announcements to a set of merchants. Examples and details related to the delivery of such announcements in one embodiment are provided in U.S. patent application Ser. No. 12/428,241, filed Apr. 22, 2009 and entitled “Targeting Merchant Announcements Triggered by Consumer Activity Relative to a Surrogate Merchant,” the disclosure of which is hereby incorporated herein by reference.

### On Third Party Site

In a further example, the user (101) may visit a third party website, which is the point of interaction (107) in FIG. 1. The third party website may be a web search engine, a news website, a blog, a social network site, etc. The behavior of the user (101) at the third party website may be tracked via a browser cookie, which uses a storage space of the browser to store information about the user (101) at the third party website. Alternatively, or in combination, the third party website uses the server logs to track the activities of the user (101). In one embodiment, the third party website may allow an advertisement network to present advertisements on portions of the web pages. The advertisement network tracks the user behavior using its server logs and/or browser cookies. For example, the advertisement network may use a browser cookie to identify a particular user across multiple websites. Based on the referral uniform resource locators (URL) that cause the advertisement network to load advertisements in various web pages, the advertisement network can determine the online behavior of the user (101) via analyzing the web pages that the user (101) has visited. Based on the tracked online activities of the user (101), the user data (125) that characterizes the user (101) can be formed to query the profiler selector (129) for a user specific profile (131).

In one embodiment, the cookie identity of the user (101) as tracked using the cookie can be correlated to an account of the user (101), the family of the user (101), the company of the user (101), or other groups that include the user (101) as a member. Thus, the cookie identity can be used as the user data (125) to obtain the user specific profile (131). For example, when the user (101) makes an online purchase from a web page that contains an advertisement that is tracked with the cookie identity, the cookie identity can be correlated to the online transaction and thus to the account of the user (101). For example, when the user (101) visits a web page after authentication of the user (101), and the web page includes an advertisement from the advertisement network, the cookie identity can be correlated to the authenticated identity of the user (101). For example, when the user (101) signs in to a web portal of the transaction handler (103) to access the account of the user (101), the cookie identity used by the advertisement network on the web portal can be correlated to the account of the user (101).

Other online tracking techniques can also be used to correlate the cookie identity of the user (101) with an identifier of the user (101) known by the profile selector (129), such as a GUID, PAN, account number, customer number, social security number, etc. Subsequently, the cookie identity can be used to select the user specific profile (131).

### Multiple Communications

In one embodiment, the entity operating the transaction handler (103) may provide intelligence for providing multiple communications regarding an advertisement. The multiple communications may be directed to two or more points of interaction with the user (101).

For example, after the user (101) is provided with an advertisement via the transaction terminal (105), reminders or revisions to the advertisements can be sent to the user (101) via a separate point of interaction (107), such as a mobile phone, email, text message, etc. For example, the advertisement may include a coupon to offer the user (101) a benefit contingent upon a purchase. If the correlator (117) determines that the coupon has not been redeemed, the correlator (117) may send a message to the mobile phone of the user (101) to remind the user (101) about the offer, and/or revise the offer.

Examples of multiple communications related to an offer in one embodiment are provided in U.S. patent application Ser. No. 12/510,167, filed Jul. 27, 2009 and entitled “Successive Offer Communications with an Offer Recipient,” the disclosure of which is hereby incorporated herein by reference.

### Auction Engine

In one embodiment, the transaction handler (103) provides a portal to allow various clients to place bids according to clusters (e.g., to target entities in the clusters for marketing, monitoring, researching, etc.).

For example, the cardholders may register in a program to receive offers, such as promotions, discounts, sweepstakes, reward points, direct mail coupons, email coupons, etc. The cardholders may register with issuers, or with the portal (143) of the transaction handler (103). Based on the transaction data (109) or transaction records (301) and/or the registration data, the profile generator (121) is to identify the clusters of cardholders and the values representing the affinity of the cardholders to the clusters. Various entities may place bids according to the clusters and/or the values to gain access to the cardholders, such as the user (101). For example, an issuer may bid on access to offers; an acquirer and/or a merchant may bid on customer segments. An auction engine receives the bids and awards segments and offers based on the received bids. Thus, the customers can get great deals; and merchants can get customer traffic and thus sales.

Some techniques to identify a segment of users (101) for marketing are provided in U.S. patent application Ser. No. 12/288,490, filed Oct. 20, 2008, assigned Pub. No. 2009/0222323, and entitled “Opportunity Segmentation,” U.S. patent application Ser. No. 12/108,342, filed Apr. 23, 2008, assigned Pub. No. 2009/0271305, and entitled “Payment Portfolio Optimization,” and U.S. patent application Ser. No. 12/108,354, filed Apr. 23, 2008, assigned Pub. No. 2009/0271327, and entitled “Payment Portfolio Optimization,” the disclosures of which applications are hereby incorporated herein by reference.

### Social Network Validation

In one embodiment, the transaction data (109) is combined with social network data and/or search engine data to provide benefits (e.g., coupons) to a consumer. For example, a data exchange apparatus may identify cluster data based upon consumer search engine data, social network data, and payment transaction data to identify like groups of individuals who would respond favorably to particular types of benefits such as coupons and statement credits. Advertisement campaigns may be formulated to target the cluster of cardholders.

In one embodiment, search engine data is combined with social network data and/or the transaction data (109) to evaluate the effectiveness of the advertisements and/or conversion pattern of the advertisements. For example, after a search engine displays advertisements about flat panel televisions to a consumer, a social network that is used by a consumer may provide information about a related purchase made by the consumer. For example, the blog of the consumer, and/or the transaction data (109), may indicate that the flat panel television purchased by the consumer is from company B. Thus, the search engine data and the social network data and/or the transaction data (109) can be combined to correlate advertisements to purchases resulting from the advertisements and to determine the conversion pattern of the advertisement to the consumer. Adjustments to advertisements (e.g., placement, appearance, etc.) can be made to improve the effectiveness of the advertisements and thus increase sales.

### Loyalty Program

In one embodiment, the transaction handler (103) uses the account data (111) to store information for third party loyalty programs. The transaction handler (103) processes payment transactions made via financial transaction cards, such as credit cards, debit cards, banking cards, etc.; and the financial transaction cards can be used as loyalty cards for the respective third party loyalty programs. Since the third party loyalty programs are hosted on the transaction handler (103), the consumers do not have to carry multiple, separate loyalty cards (e.g., one for each merchant that offers a loyalty program); and the merchants do not have to spend a large setup and investment fee to establish the loyalty program. The loyalty programs hosted on the transaction handler (103) can provide flexible awards for consumers, retailers, manufacturers, issuers, and other types of business entities involved in the loyalty programs. The integration of the loyalty programs into the accounts of the customers on the transaction handler (103) allows new offerings, such as merchant cross-offerings or bundling of loyalty offerings.

In one embodiment, an entity operating the transaction handler (103) hosts loyalty programs for third parties using the account data (111) of the users (e.g., 101). A third party, such as a merchant, a retailer, a manufacturer, an issuer or other entity that is interested in promoting certain activities and/or behaviors, may offer loyalty rewards on existing accounts of consumers. The incentives delivered by the loyalty programs can drive behavior changes without the hassle of loyalty card creation. In one embodiment, the loyalty programs hosted via the accounts of the users (e.g., 101) of the transaction handler (103) allow the consumers to carry fewer cards and may provide more data to the merchants than traditional loyalty programs.

The loyalty programs integrated with the accounts of the users (e.g., 101) of the transaction handler (103) can provide tools to enable nimble programs that are better aligned for driving changes in consumer behaviors across transaction channels (e.g., online, offline, via mobile devices). The loyalty programs can be ongoing programs that accumulate benefits for the customers (e.g., points, miles, cash back), and/or programs that provide one time benefits or limited time benefits (e.g., rewards, discounts, incentives).

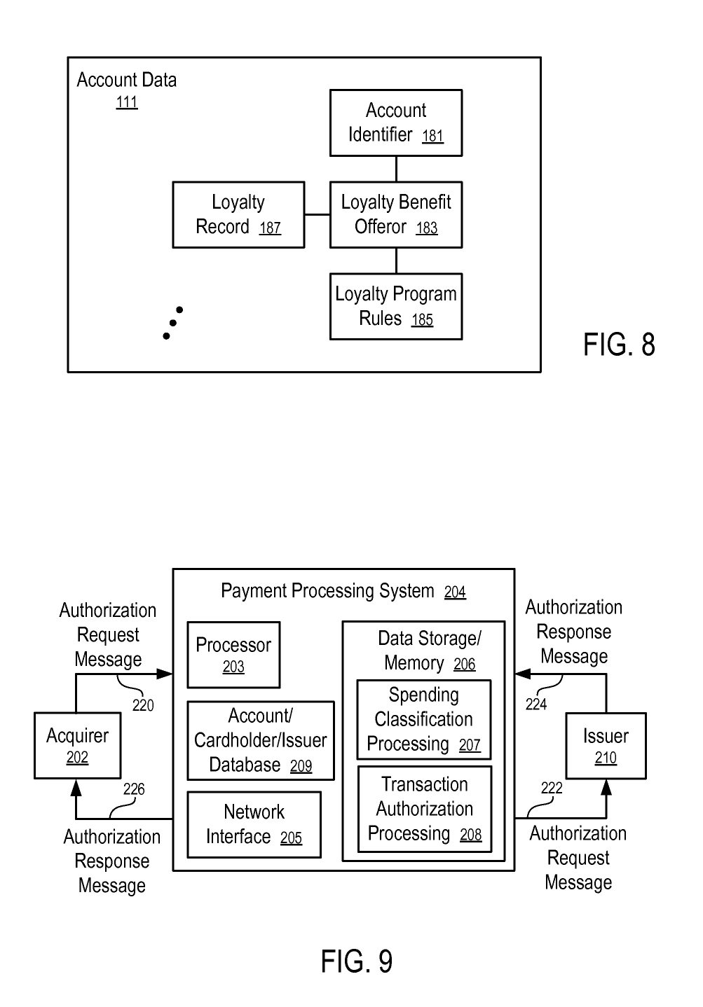

FIG. 8 shows the structure of account data (111) for providing loyalty programs according to one embodiment. In FIG. 8, data related to a third party loyalty program may include an identifier of the loyalty benefit offeror (183) that is linked to a set of loyalty program rules (185) and loyalty record (187) for the loyalty program activities of the account identifier (181). In one embodiment, at least part of the data related to the third party loyalty program is stored under the account identifier (181) of the user (101), such as the loyalty record (187).

FIG. 8 illustrates the data related to one third party loyalty program of a loyalty benefit offeror (183). In one embodiment, the account identifier (181) may be linked to multiple loyalty benefit offerors (e.g., 183), corresponding to different third party loyalty programs.

In one embodiment, a third party loyalty program of the loyalty benefit offeror (183) provides the user (101), identified by the account identifier (181), with benefits, such as discounts, rewards, incentives, cash back, gifts, coupons, and/or privileges.

In one embodiment, the association between the account identifier (181) and the loyalty benefit offeror (183) in the account data (111) indicates that the user (101) having the account identifier (181) is a member of the loyalty program. Thus, the user (101) may use the account identifier (181) to access privileges afforded to the members of the loyalty programs, such as rights to access a member only area, facility, store, product or service, discounts extended only to members, or opportunities to participate in certain events, buy certain items, or receive certain services reserved for members.

In one embodiment, it is not necessary to make a purchase to use the privileges. The user (101) may enjoy the privileges based on the status of being a member of the loyalty program. The user (101) may use the account identifier (181) to show the status of being a member of the loyalty program.

For example, the user (101) may provide the account identifier (181) (e.g., the account number of a credit card) to the transaction terminal (105) to initiate an authorization process for a special transaction which is designed to check the member status of the user (101), as if the account identifier (181) were used to initiate an authorization process for a payment transaction. The special transaction is designed to verify the member status of the user (101) via checking whether the account data (111) is associated with the loyalty benefit offeror (183). If the account identifier (181) is associated with the corresponding loyalty benefit offeror (183), the transaction handler (103) provides an approval indication in the authorization process to indicate that the user (101) is a member of the loyalty program. The approval indication can be used as a form of identification to allow the user (101) to access member privileges, such as access to services, products, opportunities, facilities, discounts, permissions, which are reserved for members.

In one embodiment, when the account identifier (181) is used to identify the user (101) as a member to access member privileges, the transaction handler (103) stores information about the access of the corresponding member privilege in loyalty record (187). The profile generator (121) may use the information accumulated in the loyalty record (187) to enhance transaction profiles (127) and provide the user (101) with personalized/targeted advertisements, with or without further offers of benefit (e.g., discounts, incentives, rebates, cash back, rewards, etc.).

In one embodiment, the association of the account identifier (181) and the loyalty benefit offeror (183) also allows the loyalty benefit offeror (183) to access at least a portion of the account data (111) relevant to the loyalty program, such as the loyalty record (187) and certain information about the user (101), such as name, address, and other demographic data.

In one embodiment, the loyalty program allows the user (101) to accumulate benefits according to loyalty program rules (185), such as reward points, cash back, levels of discounts, etc. For example, the user (101) may accumulate reward points for transactions that satisfy the loyalty program rules (185); and the user (101) may use the reward points to redeem cash, gift, discounts, etc. In one embodiment, the loyalty record (187) stores the accumulated benefits; and the transaction handler (103) updates the loyalty record (187) associated with the loyalty benefit offeror (183) and the account identifier (181), when events that satisfy the loyalty program rules occur.

In one embodiment, the accumulated benefits as indicated in the loyalty record (187) can be redeemed when the account identifier (181) is used to perform a payment transaction, when the payment transaction satisfies the loyalty program rules. For example, the user (101) may redeem a number of points to offset or reduce an amount of the purchase price.

In one embodiment, when the user (101) uses the account identifier (181) to make purchases as a member, the merchant may further provide information about the purchases; and the transaction handler (103) can store the information about the purchases as part of the loyalty record (187). The information about the purchases may identify specific items or services purchased by the member. For example, the merchant may provide the transaction handler (103) with purchase details at stock-keeping unit (SKU) level, which are then stored as part of the loyalty record (187). The loyalty benefit offeror (183) may use the purchase details to study the purchase behavior of the user (101); and the profile generator (121) may use the SKU level purchase details to enhance the transaction profiles (127).

In one embodiment, the SKU level purchase details are requested from the merchants or retailers via authorization responses, when the account (146) of the user (101) is enrolled in a loyalty program that allows the transaction handler (103) (and/or the issuer processor (145)) to collect the purchase details.

In one embodiment, the profile generator (121) may generate transaction profiles (127) based on the loyalty record (187) and provide the transaction profiles (127) to the loyalty benefit offeror (183) (or other entities when permitted).

In one embodiment, the loyalty benefit offeror (183) may use the transaction profiles (e.g., 127 or 131) to select candidates for membership offering. For example, the loyalty program rules (185) may include one or more criteria that can be used to identify which customers are eligible for the loyalty program. The transaction handler (103) may be configured to automatically provide the qualified customers with the offer of membership in the loyalty program when the corresponding customers are performing transactions via the transaction handler (103) and/or via points of interaction (107) accessible to the entity operating the transaction handler (103), such as ATMs, mobile phones, receipts, statements, websites, etc. The user (101) may accept the membership offer via responding to the advertisement. For example, the user (101) may load the membership into the account in the same way as loading a coupon into the account of the user (101).

In one embodiment, the membership offer is provided as a coupon or is associated with another offer of benefits, such as a discount, reward, etc. When the coupon or benefit is redeemed via the transaction handler (103), the account data (111) is updated to enroll the user (101) into the corresponding loyalty program.

In one embodiment, a merchant may enroll a user (101) into a loyalty program when the user (101) is making a purchase at the transaction terminal (105) of the merchant.

For example, when the user (101) is making a transaction at an ATM, performing a self-assisted check out on a POS terminal, or making a purchase transaction on a mobile phone or a computer, the user (101) may be prompted to join a loyalty program, while the transaction is being authorized by the transaction handler (103). If the user (101) accepts the membership offer, the account data (111) is updated to have the account identifier (181) associated with the loyalty benefit offeror (183).

In one embodiment, the user (101) may be automatically enrolled in the loyalty program, when the profile of the user (101) satisfies a set of conditions specified in the loyalty program rules (185). The user (101) may opt out of the loyalty program.

In one embodiment, the loyalty benefit offeror (183) may personalize and/or target loyalty benefits based on the transaction profile (131) specific to or linked to the user (101). For example, the loyalty program rules (185) may use the user specific profile (131) to select gifts, rewards, or incentives for the user (101) (e.g., to redeem benefits, such as reward points, accumulated in the loyalty record (187)). The user specific profile (131) may be enhanced using the loyalty record (187), or generated based on the loyalty record (187). For example, the profile generator (121) may use a subset of transaction data (109) associated with the loyalty record (187) to generate the user specific profile (131), or provide more weight to the subset of the transaction data (109) associated with the loyalty record (187) while also using other portions of the transaction data (109) in deriving the user specific profile (131).

In one embodiment, the loyalty program may involve different entities For example, a first merchant may offer rewards as discounts, or gifts from a second merchant that has a business relationship with the first merchant. For example, an entity may allow a user (101) to accumulate loyalty benefits (e.g., reward points) via purchase transactions at a group of different merchants. For example, a group of merchants may jointly offer a loyalty program, in which loyalty benefits (e.g., reward points) can be accumulated from purchases at any of the merchants in the group and redeemable in purchases at any of the merchants.

In one embodiment, the information identifying the user (101) as a member of a loyalty program is stored on a server connected to the transaction handler (103). Alternatively or in combination, the information identifying the user (101) as a member of a loyalty program can also be stored in the financial transaction card (e.g., in the chip, or in the magnetic strip).

In one embodiment, loyalty program offerors (e.g., merchants, manufacturers, issuers, retailers, clubs, organizations, etc.) can compete with each other in making loyalty program related offers. For example, loyalty program offerors may place bids on loyalty program related offers; and the advertisement selector (133) (e.g., under the control of the entity operating the transaction handler (103), or a different entity) may prioritize the offers based on the bids. When the offers are accepted or redeemed by the user (101), the loyalty program offerors pay fees according to the corresponding bids. In one embodiment, the loyalty program offerors may place an auto bid or maximum bid, which specifies the upper limit of a bid; and the actual bid is determined to be the lowest possible bid that is larger than the bids of the competitors, without exceeding the upper limit.

In one embodiment, the offers are provided to the user (101) in response to the user (101) being identified by the user data (125). If the user specific profile (131) satisfies the conditions specified in the loyalty program rules (185), the offer from the loyalty benefit offeror (183) can be presented to the user (101). When there are multiple offers from different offerors, the offers can be prioritized according to the bids.

In one embodiment, the offerors can place bids based on the characteristics that can be used as the user data (125) to select the user specific profile (131). In another embodiment, the bids can be placed on a set of transaction profiles (127).

In one embodiment, the loyalty program based offers are provided to the user (101) just in time when the user (101) can accept and redeem the offers. For example, when the user (101) is making a payment for a purchase from a merchant, an offer to enroll in a loyalty program offered by the merchant or related offerors can be presented to the user (101). If the user (101) accepts the offer, the user (101) is entitled to receive member discounts for the purchase.

For example, when the user (101) is making a payment for a purchase from a merchant, a reward offer can be provided to the user (101) based on loyalty program rules (185) and the loyalty record (187) associated with the account identifier (181) of the user (101) (e.g., the reward points accumulated in a loyalty program). Thus, the user effort for redeeming the reward points can be reduced; and the user experience can be improved.

In one embodiment, a method to provide loyalty programs includes the use of a computing apparatus of a transaction handler (103). The computing apparatus processes (301) a plurality of payment card transactions. After the computing apparatus receives (303) a request to track transactions for a loyalty program, such as the loyalty program rules (185), the computing apparatus stores and updates (305) loyalty program information in response to transactions occurring in the loyalty program. The computing apparatus provides (307) to a customer (e.g., 101) an offer of a benefit when the customer satisfies a condition defined in the loyalty program, such as the loyalty program rules (185).

Examples of loyalty programs through collaboration between collaborative constituents in a payment processing system, including the transaction handler (103) in one embodiment are provided in U.S. patent application Ser. No. 11/767,202, filed Jun. 22, 2007, assigned Pub. No. 2008/0059302, and entitled “Loyalty Program Service,” U.S. patent application Ser. No. 11/848,112, filed Aug. 30, 2007, assigned Pub. No. 2008/0059306, and entitled “Loyalty Program Incentive Determination,” and U.S. patent application Ser. No. 11/848,179, filed Aug. 30, 2007, assigned Pub. No. 2008/0059307, and entitled “Loyalty Program Parameter Collaboration,” the disclosures of which applications are hereby incorporated herein by reference.

Examples of processing the redemption of accumulated loyalty benefits via the transaction handler (103) in one embodiment are provided in U.S. patent application Ser. No. 11/835,100, filed Aug. 7, 2007, assigned Pub. No. 2008/0059303, and entitled “Transaction Evaluation for Providing Rewards,” the disclosure of which is hereby incorporated herein by reference.

In one embodiment, the incentive, reward, or benefit provided in the loyalty program is based on the presence of correlated related transactions. For example, in one embodiment, an incentive is provided if a financial payment card is used in a reservation system to make a reservation and the financial payment card is subsequently used to pay for the reserved good or service. Further details and examples of one embodiment are provided in U.S. patent application Ser. No. 11/945,907, filed Nov. 27, 2007, assigned Pub. No. 2008/0071587, and entitled “Incentive Wireless Communication Reservation,” the disclosure of which is hereby incorporated herein by reference.

In one embodiment, the transaction handler (103) provides centralized loyalty program management, reporting and membership services. In one embodiment, membership data is downloaded from the transaction handler (103) to acceptance point devices, such as the transaction terminal (105). In one embodiment, loyalty transactions are reported from the acceptance point devices to the transaction handler (103); and the data indicating the loyalty points, rewards, benefits, etc. are stored on the account identification device (141). Further details and examples of one embodiment are provided in U.S. patent application Ser. No. 10/401,504, filed Mar. 27, 2003, assigned Pub. No. 2004/0054581, and entitled “Network Centric Loyalty System,” the disclosure of which is hereby incorporated herein by reference.

In one embodiment, the portal (143) of the transaction handler (103) is used to manage reward or loyalty programs for entities such as issuers, merchants, etc. The cardholders, such as the user (101), are rewarded with offers/benefits from merchants. The portal (143) and/or the transaction handler (103) track the transaction records for the merchants for the reward or loyalty programs. Further details and examples of one embodiment are provided in U.S. patent application Ser. No. 11/688,423, filed Mar. 20, 2007, assigned Pub. No. 2008/0195473, and entitled “Reward Program Manager,” the disclosure of which is hereby incorporated herein by reference.

In one embodiment, a loyalty program includes multiple entities providing access to detailed transaction data, which allows the flexibility for the customization of the loyalty program. For example, issuers or merchants may sponsor the loyalty program to provide rewards; and the portal (143) and/or the transaction handler (103) stores the loyalty currency in the data warehouse (149). Further details and examples of one embodiment are provided in U.S. patent application Ser. No. 12/177,530, filed Jul. 22, 2008, assigned Pub. No. 2009/0030793, and entitled “Multi-Vender Multi-Loyalty

[symbol]

In one embodiment, an incentive program is created on the portal (143) of the transaction handler (103). The portal (143) collects offers from a plurality of merchants and stores the offers in the data warehouse (149). The offers may have associated criteria for their distributions. The portal (143) and/or the transaction handler (103) may recommend offers based on the transaction data (109). In one embodiment, the transaction handler (103) automatically applies the benefits of the offers during the processing of the transactions when the transactions satisfy the conditions associated with the offers. In one embodiment, the transaction handler (103) communicates with transaction terminals (105) to set up, customize, and/or update offers based on market focus, product categories, service categories, targeted consumer demographics, etc. Further details and examples of one embodiment are provided in U.S. patent application Ser. No. 12/413,097, filed Mar. 27, 2009, assigned Pub. No. 2010-0049620, and entitled “Merchant Device Support of an Integrated Offer Network,” the disclosure of which is hereby incorporated herein by reference.

In one embodiment, the transaction handler (103) is configured to provide offers from merchants to the user (101) via the payment system, making accessing and redeeming the offers convenient for the user (101). The offers may be triggered by and/or tailored to a previous transaction, and may be valid only for a limited period of time starting from the date of the previous transaction. If the transaction handler (103) determines that a subsequent transaction processed by the transaction handler (103) meets the conditions for the redemption of an offer, the transaction handler (103) may credit the consumer account (146) for the redemption of the offer and/or provide a notification message to the user (101). Further details and examples of one embodiment are provided in U.S. patent application Ser. No. 12/566,350, filed Sep. 24, 2009 and entitled “Real-Time Statement Credits and Notifications,” the disclosure of which is hereby incorporated herein by reference.

Details on loyalty programs in one embodiment are provided in U.S. patent application Ser. No. 12/896,632, filed Oct. 1, 2010 and entitled “Systems and Methods to Provide Loyalty Programs,” the disclosure of which is hereby incorporated herein by reference.

### SKU

In one embodiment, merchants generate stock-keeping unit (SKU) or other specific information that identifies the particular goods and services purchased by the user (101) or customer. The SKU information may be provided to the operator of the transaction handler (103) that processed the purchases. The operator of the transaction handler (103) may store the SKU information as part of transaction data (109), and reflect the SKU information for a particular transaction in a transaction profile (127 or 131) associated with the person involved in the transaction.

When a user (101) shops at a traditional retail store or browses a website of an online merchant, an SKU-level profile associated specifically with the user (101) may be provided to select an advertisement appropriately targeted to the user (101) (e.g., via mobile phones, POS terminals, web browsers, etc.). The SKU-level profile for the user (101) may include an identification of the goods and services historically purchased by the user (101). In addition, the SKU-level profile for the user (101) may identify goods and services that the user (101) may purchase in the future. The identification may be based on historical purchases reflected in SKU-level profiles of other individuals or groups that are determined to be similar to the user (101). Accordingly, the return on investment for advertisers and merchants can be greatly improved.

In one embodiment, the user specific profile (131) is an aggregated spending profile (341) that is generated using the SKU-level information. For example, in one embodiment, the factor values (344) correspond to factor definitions (331) that are generated based on aggregating spending in different categories of products and/or services. A typical merchant offers products and/or services in many different categories.

In one embodiment, the user (101) may enter into transactions with various online and “brick and mortar” merchants. The transactions may involve the purchase of various items of goods and services. The goods and services may be identified by SKU numbers or other information that specifically identifies the goods and services purchased by the user (101).

In one embodiment, the merchant may provide the SKU information regarding the goods and services purchased by the user (101) (e.g., purchase details at SKU level) to the operator of the transaction handler (103). In one embodiment, the SKU information may be provided to the operator of the transaction handler (103) in connection with a loyalty program, as described in more detail below. The SKU information may be stored as part of the transaction data (109) and associated with the user (101). In one embodiment, the SKU information for items purchased in transactions facilitated by the operator of the transaction handler (103) may be stored as transaction data (109) and associated with its associated purchaser. In one embodiment, the SKU level purchase details are requested from the merchants or retailers via authorization responses, when the account (146) of the user (101) is enrolled in a program that allows the transaction handler (103) (and/or the issuer processor (145)) to collect the purchase details.

In one embodiment, based on the SKU information and perhaps other transaction data, the profile generator (121) may create an SKU-level transaction profile for the user (101). In one embodiment, based on the SKU information associated with the transactions for each person entering into transactions with the operator of the transaction handler (103), the profile generator (121) may create an SKU-level transaction profile for each person.

In one embodiment, the SKU information associated with a group of purchasers may be aggregated to create an SKU-level transaction profile that is descriptive of the group. The group may be defined based on one or a variety of considerations. For example, the group may be defined by common demographic features of its members. As another example, the group may be defined by common purchasing patterns of its members.

In one embodiment, the user (101) may later consider the purchase of additional goods and services. The user (101) may shop at a traditional retailer or an online retailer. With respect to an online retailer, for example, the user (101) may browse the website of an online retailer, publisher, or merchant. The user (101) may be associated with a browser cookie to, for example, identify the user (101) and track the browsing behavior of the user (101).

In one embodiment, the retailer may provide the browser cookie associated with the user (101) to the operator of the transaction handler (103). Based on the browser cookie, the operator of the transaction handler (103) may associate the browser cookie with a personal account number of the user (101). The association may be performed by the operator of the transaction handler (103) or another entity in a variety of manners such as, for example, using a look up table.

Based on the personal account number, the profile selector (129) may select a user specific profile (131) that constitutes the SKU-level profile associated specifically with the user (101). The SKU-level profile may reflect the individual, prior purchases of the user (101) specifically, and/or the types of goods and services that the user (101) has purchased.

The SKU-level profile for the user (101) may also include identifications of goods and services the user (101) may purchase in the future. In one embodiment, the identifications may be used for the selection of advertisements for goods and services that may be of interest to the user (101). In one embodiment, the identifications for the user (101) may be based on the SKU-level information associated with historical purchases of the user (101). In one embodiment, the identifications for the user (101) may be additionally or alternatively based on transaction profiles associated with others. The recommendations may be determined by predictive association and other analytical techniques.

For example, the identifications for the user (101) may be based on the transaction profile of another person. The profile selector (129) may apply predetermined criteria to identify another person who, to a predetermined degree, is deemed sufficiently similar to the user (101). The identification of the other person may be based on a variety of factors including, for example, demographic similarity and/or purchasing pattern similarity between the user (101) and the other person. As one example, the common purchase of identical items or related items by the user (101) and the other person may result in an association between the user (101) and the other person, and a resulting determination that the user (101) and the other person are similar. Once the other person is identified, the transaction profile constituting the SKU-level profile for the other person may be analyzed. Through predictive association and other modeling and analytical techniques, the historical purchases reflected in the SKU-level profile for the other person may be employed to predict the future purchases of the user (101).

As another example, the identifications of the user (101) may be based on the transaction profiles of a group of persons. The profile selector (129) may apply predetermined criteria to identify a multitude of persons who, to a predetermined degree, are deemed sufficiently similar to the user (101). The identification of the other persons may be based on a variety of factors including, for example, demographic similarity and/or purchasing pattern similarity between the user (101) and the other persons. Once the group constituting the other persons is identified, the transaction profile constituting the SKU-level profile for the group may be analyzed. Through predictive association and other modeling and analytical techniques, the historical purchases reflected in the SKU-level profile for the group may be employed to predict the future purchases of the user (101).

The SKU-level profile of the user (101) may be provided to select an advertisement that is appropriately targeted. Because the SKU-level profile of the user (101) may include identifications of the goods and services that the user (101) may be likely to buy, advertisements corresponding to the identified goods and services may be presented to the user (101). In this way, targeted advertising for the user (101) may be optimized. Further, advertisers and publishers of advertisements may improve their return on investment, and may improve their ability to cross-sell goods and services.

In one embodiment, SKU-level profiles of others who are identified to be similar to the user (101) may be used to identify a user (101) who may exhibit a high propensity to purchase goods and services. For example, if the SKU-level profiles of others reflect a quantity or frequency of purchase that is determined to satisfy a threshold, then the user (101) may also be classified or predicted to exhibit a high propensity to purchase. Accordingly, the type and frequency of advertisements that account for such propensity may be appropriately tailored for the user (101).

In one embodiment, the SKU-level profile of the user (101) may reflect transactions with a particular merchant or merchants. The SKU-level profile of the user (101) may be provided to a business that is considered a peer with or similar to the particular merchant or merchants. For example, a merchant may be considered a peer of the business because the merchant offers goods and services that are similar to or related to those of the business. The SKU-level profile reflecting transactions with peer merchants may be used by the business to better predict the purchasing behavior of the user (101) and to optimize the presentation of targeted advertisements to the user (101).

Details on SKU-level profile in one embodiment are provided in U.S. patent application Ser. No. 12/899,144, filed Oct. 6, 2010 and entitled “Systems and Methods for Advertising Services Based on an SKU-Level Profile,” the disclosure of which is hereby incorporated herein by reference.

### Business Spending

There exists a very competitive market for the issuance and management of consumer accounts (146) and consumer payment devices (e.g., account identification device (141)). The competitive market leads to a large variety of payment devices, payment device features, pricing strategies, incentive programs for consumers, loyalty programs, and other features intended to differentiate an issuer's payment device in the market and thereby attract and maintain consumer loyalty.

In one embodiment, there are two primary types of payment accounts: 1) individual accounts tailored to the needs of individuals (e.g., personal consumers) and typically used for everyday household spending; and 2) commercial accounts designed for companies (e.g., large or small businesses) and typically used for business procurement. Different types of account owners have different needs; and therefore, different types of accounts are designed to have different features and functions to accommodate the different needs of the respective account owners.

However, when an issuer acquires a customer, the issuer might not always issue the account of the correct type to the customer, primarily due to a lack of accurate information regarding the account owner type of the customer. The issuer may lack accurate information about business entities, especially small business entities. As a result, in some of the individual consumer account portfolios, there might be a significant number of accounts that are owned and utilized by business owners to conduct their business operations.

Similarly, the opposite situation may also occur: in some of the small business account portfolios, there are accounts that are owned and used by individual consumers for personal spending.

There may be other reasons for the mismatch between the designed account types of accounts issued to account holders and the actual spending types of the respective accounts. For example, in addition to the lack of sufficiently accurate information to identify the correct type of a potential account holder (e.g., whether the account holder is of a type of a business entity, or of a type of a personal consumer entity), business entities are much more dynamic than individuals. The average life span of a small business is less than 3 years, whereas an individual's credit life span can last more than 50 years. After an account is issued to an account holder as a business entity, the account holder may change from using the account for a business purpose to using the account for personal purposes.

For example, after an account is issued to an account holder as a personal consumer, the account holder may start using the account for a business purpose, as the account holder starts a business and uses the account as a procurement and finance tool.

Sometimes, an issuer may have an incentive to issue a different product due to the fee structure and regulatory concerns.

The mismatch between the account designed for a particular spending type and the actual spending type reflected in the actual usage of the account can cause sub-optimal product alignment, lost opportunities for product and service cross-selling; and customers may experience confusion and inconvenience because the payment accounts being used by the account owner are not the type intended for use by (and specifically directed at) that entity.

In one embodiment, a system and method is provided to identify the likelihood of the spending in an account being of a particular type, based on the transaction data recorded in the account. The identified likelihood allows the identification of a mismatch in designed and actual account types. When the mismatch between an account designed for a spending type and the actual spending type of the transactions in the account is detected, the account holder is offered with a different account, a different set of account features, and/or a realignment of the account product offering and value proposition, to reduce or eliminate the mismatch.

In one embodiment, a system, apparatus, and method is provided to identify characteristics of accounts (such as spending amounts, spending patterns, spending categories, etc.) that may be used to differentiate between consumer spending and business spending. Based on the characteristics, a classification model or decision tool is developed. In one embodiment, the model is used to evaluate the transactions in an account to determine whether it is more suitable to configure the account for personal consumption or business procurement and financing. Based on the results of the evaluation, the account owners (whether a consumer or business) can be more effectively targeted for marketing or product development activities that will be of the most value and interest to the account owners.

In one embodiment, the transaction data (109) generated by a transaction handler (103) is used for the targeting of products and services to consumers as individuals as opposed to business owners, or to business owners as opposed to consumers as individuals, due to their different needs and interests in terms of product features and support. The transaction handler (103) is configured to provide information, based on the transaction data (109), to allow an issuer to determine if an account is most likely associated with a consumer or with a business and thus most effectively direct marketing and product development efforts at the intended audience. Once a determination of the actual spending type of an account is made, the issuer can target promotional materials, incentive offers and new products or services more effectively to the respective account holder. An issuer can also redirect existing marketing efforts away from an account owner for whom the efforts were not intended, thereby possibly saving money that would otherwise have been spent in a less than optimal manner.

FIG. 9 illustrates components of a system configured to determine whether an account is associated with a consumer or with a business in accordance with one embodiment. In FIG. 9, the payment processing system (204) is configured to interact with acquirers (e.g., 202) and issuers (e.g., 210). In FIG. 9, the acquirer (202) provides an authorization request message (220) for a payment transaction to the payment processing system (204) (e.g., using the acquirer processor (147)). The payment processing system (204) provides a processed authorization request message (222) to the issuer (210) (e.g., via the issuer processor (145)). The payment processing system (204) may process the authorization request message (220) received from the acquirer (202) to assist the issuer (210) in deciding whether to authorize or deny the transaction. The issuer (210) provides the payment processing system (204) with an authorization response message (224) containing an indication of whether the transaction has been approved or denied. In response, the payment processing system (204) provides an authorization response message (226) to the acquirer (202) to inform acquirer (202) (and ultimately the merchant and the user) if the transaction has been approved or denied. The authorization response message (226) provided to the acquirer (202) may be the same as the authorization response message (224) received from the issuer (210), or may contain other information added by the payment processing system (204).

In one embodiment, the payment processing system (204) includes at least one processor (e.g., a central processing unit) (203) that is programmed to execute a set of instructions to perform various operations for the payment processing system (204). Some or all of the instructions are stored in data storage device or memory (206). The operations performed by the payment processing system (204) are in accordance with the instructions.

In one embodiment, the instruction set (208) is configured for the transaction authorization processing; and the instruction set (207) is configured for the determination of whether an account is associated with an individual consumer or with a business, and/or for the identification of characteristics of the spending behavior in an account that may be used to determine whether the account is associated with an individual consumer or with a business.

In one embodiment, the payment processing system (204) includes one or more databases (209) containing transaction data (109), account data (111) and other information (e.g., merchant data, issuer data, etc.). In one embodiment, the one or more databases (209) are hosted on the data warehouse (149) of the transaction handler (103). The data stored in the one or more databases (209) is used by payment processing system (204) to identify account holders whose accounts designed for personal spending are being used for business purposes and/or account holders whose accounts designed for business spending are being used for personal purposes. Such data or information may include (but is not limited to) data regarding a group of account holders who are issued with personal accounts from different issuers, a group of account holders who are issued with business accounts from different issuers, the characteristics (e.g., merchant types, transaction amounts, date and time of transactions, etc.) of the payment transactions that such account holders engaged in, etc.

In one embodiment, the payment processing system (204) is configured to utilize at least one network interface (205) to communicate with the acquirer processor (147) of the acquirer (202) and the issuer processor (145) of the issuer (210).

In one embodiment, the payment processing system (204) includes the transaction handler (103) and the portal (143) configured to receive input data, such as a list of accounts (e.g., 146) that have been issued to users (e.g., 101) as individuals, a list of accounts (e.g., 146) that have been issued to users (e.g., 101) as businesses, an identification of an account (e.g., 146) for which a business spending score is requested to indicate the likelihood that the spending of the account (e.g., 146) relates to business procurement (or personal consumption), etc. In one embodiment, the portal (143) is also configured to provide data, such as the requested business spending score, regarding an offer to the user (101) of the customer account (146) based on the business score, etc. In one embodiment, the payment processing system (204) includes at least some of the components illustrated in FIG. 1 for providing the offer.

Some details about the transaction handler (103) and the portal (143) in one embodiment are provided in the section entitled “TRANSACTION DATA BASED PORTAL.”

In one embodiment, the payment processing system (204) is implemented on a computing system having a cluster of computers, each having a system bus connecting at least one microprocessor, memory, and peripherals and input/output (I/O) devices, such as a network interface, and/or other optional devices such as a fixed disk, a display adapter, a printer, a keyboard, a monitor, a serial port, a mouse input device, or a scanner.

In one embodiment, the transaction data (109), recorded by the transaction handler (103) for transactions made using accounts (e.g., 146) issued by different issuers, is used to identify characteristics of the spending behavior of account owners that may be used to develop a classification model or decision tool for determining if a payment account is associated with a consumer or with a business, and/or if the spending in the payment account is primarily for business purposes or for personal purposes.

In one embodiment, a data processing or analysis method, such as a linear regression model, is applied to the transaction data (109) to determine the spending factors or variables (such as spending categories, spending patterns, spending amounts, spending trends, etc.) that may be used to differentiate a consumer account from a business account, or to tell apart accounts primarily used for personal consumption and accounts primarily used for business procurement. The spending factors or variables (along with their associated coefficients or scaling factors) are used in a classification model or decision tool that can be applied to the transaction data (109) of a specified account (e.g., 146) to determine whether the account is more likely to be a consumer account or a business account, whether the account is more likely being used for personal consumption or business procurement, or whether the account is more suitable to be configured as a consumer account or a business account, based on the actual spending in the account. In one embodiment, based on this determination, marketing and product development activities can be more effectively directed at the intended audience.

In one embodiment, the spending classification processing instructions (207) are configured to (1) access/process transaction data (109) for payment transactions associated with multiple payment accounts (e.g., 146) issued by different issuers to different entities (e.g., individual consumers and businesses); (2) statistically analyze the transaction data (109) to identify one or more transaction characteristics and/or spending behavior characteristics or variables that may be used to differentiate between a consumer account and a business account (such as those characteristics most strongly correlated with one or the other type of account based on a linear regression analysis), and which therefore might serve as indicia that an account is actually associated with a consumer as opposed to a business (or vice versa); and (3) generate a predictive model or decision tool (and associated score or indicia) that can be used to determine the likelihood that a particular payment account is actually associated with a consumer or a business.

In one embodiment, the spending classification processing instructions (207) are configured to instruct the at least one processor (203) to use the transaction data (109) in identifying the account classification model for computing a business spending score. The account classification model includes a set of variables identified using the transaction data (109) and a set of parameters that are used to combined the variables to generate the business spending score. In one embodiment, the parameters represent the weight for the variables in a linear combination of the variables selected for the account classification model.

In one embodiment, the spending classification processing instructions (207) are configured to instruct the at least one processor (203) to generate a business spending score or indicia based on the account classification model. In one embodiment, the spending classification model processing instructions (207) include instructions for the evaluation of the selected variables for a given consumer account (146) using the transaction data (109) recording the transactions in the consumer account (146). In one embodiment, the spending classification model processing instructions (207) further include the set of parameters for the combination of variables.

In one embodiment, the data storage/memory (206) further stores instructions configured for identifying a payment device or consumer account (146) that has a business spending score higher than a threshold, where the threshold corresponds to a predetermined probability that the user (101) is using the consumer account (146) primarily for a business purpose. After the consumer account (146) is identified using the business spending score, the advertisement selector (133) is configured to target the user (101) of the consumer account (146) with communications and/or offers related to the business needs of the user (101). The advertisement selector (133) may be associated with the issuer (210) of the consumer account (146), the transaction handler (103), or a third party. In one embodiment, the offers (e.g., user specific advertisement data (119)) include incentives, pricing adjustments, loyalty program benefits, etc. Similarly, account holders (e.g., 101) of business accounts that have a business spending score lower than a threshold can be selected and targeted with communications and/or offers customized to meet personal needs of the users (e.g., 101).

In one embodiment, the transaction profile (127) of the user (101) is used to select, customize, and personalize the offers. In one embodiment, the transaction profile (127) of the user (101) is based on the transaction data (109) of the user (101) in a plurality of accounts which may be issued by one or more different issuers (210).

In one embodiment, the transaction profile (127 or 341) contains information that identifies the value of existing users (e.g., 101), which allows the issuers (210) to select the most valuable existing customers, and identify which of those are most likely to have a misaligned account (e.g., business account used for personal spending, or personal account used for business procurement), and then to implement an offer program in an effort to better serve the needs of the respective account holders.

In one embodiment, an issuer (210) is to identify those existing customers most likely to have misaligned accounts, identify the most valuable among such customers, and then implement an offer program in an effort to realign the accounts with the spending needs of the account holders.

In one embodiment, a payment processor or central entity, such as an operator of the transaction handler (103), is in an advantageous position to create and utilize the analytic tools described above as an integral part of a strategy to provide the optimal type of payment device and services to a consumer or to a business. The payment processor or central entity, such as the transaction handler (103) or a processor coupled with the transaction handler (103), is positioned at a centralized location within the payment processing network to observe transactions involving various issuers (210) and acquirers (202). By data mining transactional data (109) and evaluating account holder spending patterns, the payment processor or other entity can develop insights into the ways in which the spending behaviors of a consumer may be differentiated from those of a business and thus, provide an opportunity for product re-alignment and offering a new or improved value proposition to an account holder, whether they are a consumer or a business.

In one embodiment, the data mining functionality is integrated with the transaction handler (103) to allow more efficient, faster and more secure access to the transaction data (109), while providing a classification model that is not specific to a particular issuer and that is better supported statistically by diverse transaction patterns and account usages in accounts issued by different issuers.

In one embodiment, to develop the classification model or decision tool for the identification of whether a payment account is actually being used by a consumer or a business, a computing device is configured to a) sample both consumer (individual) account portfolios and commercial (business) account portfolios, and retrieve transactional data (109) of the sampled accounts; b) model the spending behavior of the accounts to identify the most relevant distinctions between the spending patterns (spending categories, spending amounts, spending trends, etc.) of the consumer type accounts and the commercial business type accounts; and c) use the developed model or decision tool to determine the likelihood of a candidate account being actually either a consumer (individual) account or a business account in accordance with the actual spending in the account.

In one embodiment, the developed model or decision tool is unique at least in part because it relies on the transaction data (109) available to a payment processing network, such as the transaction handler (103), which processes transactions made via accounts of different issuers.

In one embodiment, one model output is the score or indicia that represents the likelihood of account being of a business type (e.g., actually held by a business, used by a business, or suitable to be configured as a business account). In one embodiment, such a score is provided to issuers to assists issuers in identifying accounts that are more likely to be business accounts among consumer account portfolios. Issuers can then develop marketing initiatives for cross-selling or product adjustments.

In one embodiment, an account classification model is applied to the transaction data (109) of a set of accounts for model validation. The accounts are selected from business accounts and personal accounts. The accounts are ranked based on the business spending score computed using the account classification model generated according to one embodiment. In one instance, more than 60% of the accounts ranked at the highest decile according to the business spending score are business accounts; and about 3% of the accounts ranked at the lowest decile according to the business spending score are business accounts. In one instance, the percentages of business accounts in various deciles, ranging from highest to lowest, are 61.6%, 38.3%, 23.9%, 14.8%, 10.0%, 7.3%, 5.7%, 4.6%, 3.9% and 3.1%. Such a validation result demonstrates the significant differentiation power in identifying the business accounts based on spending patterns reflected in the transaction data (109) and thus validates the account classification model. Based on the model performance, it is concluded that consumer accounts and business accounts have clear distinctions in spending patterns; and such distinctions can be identified using data mining techniques. The accuracy of the model allows the use of such a spending score in applications within the areas of payment product management, cross-selling and customer experience optimization.

In one embodiment, a first multiplicity of accounts (e.g., 3.2 million) are selected from consumer account portfolios, and a second multiplicity of accounts (e.g., 1.6 million) are selected from business account portfolios. The selected accounts are used as account samples. The transaction data (109) of payment transactions performed within a predetermined period of time (e.g., the past 12 months) are retrieved from the data warehouse (149) of the transaction handler (103) for each of the sampled accounts (e.g., 4.8 million selected accounts). In one embodiment, a first percentage (e.g., 70%) of sampled accounts are used as a training sample, with the remaining accounts (e.g., 30%) being used as the holdout sample for validation.

In one embodiment, a statistics analysis method, such as logistic regression, is applied as the optimization tool on the training sample to select the predictive variables to best distinguish the different spending behavior between the business accounts and individual (consumer) accounts and to form an account classification model for computing the business spending score. The account classification model performance is validated using the holdout sample that is not part of the training sample. After the model is validated to show the significant ability to differentiate which accounts are more likely to be actually used as a business account as opposed to a consumer account, based on the spending behavior reflected in the actual transaction data (109), the account classification model can be used to generate business spending scores to target offers to users (e.g., 101) of accounts that have a misalignment between the designed usage and the actual usage with respect to personal consumption and business procurement.

For example, in one use case, the classification model, built and validated on the sample accounts (e.g., 4.8 million), is applied to active consumer accounts (146). The accounts with a business spending score above a predetermined threshold are identified as most likely being actually used as a business account. In one embodiment, using the model results and the transaction data (109) associated with accounts that are issued by various issuers and processed by the transaction handler (103), the inventors estimate that more than 2% (approximately 1.6 million) of the active consumer credit accounts may be actually used primarily for business transactions, representing more than $18 billion in spending. This provides a significant opportunity for targeted account and feature offers that can improve user experiences and service quality.

Similarly, the classification model or decision tool can also be applied to active business accounts to determine which of those accounts are more likely to be actually used as a consumer account.

The business spending score generated from the classification tool can be used in multiple ways to assist issuers (210). For example, in one embodiment, a stand-alone business spending score (or the probability of business usage of an account) is provided as a score input into a customer relationship management (CRM) system for customer service interactions between consumers and call centers or bank branches. In one embodiment, when the CRM system is used in connection with providing a service to the user (101) of the consumer account (146), the CRM system is configured to query the portal (143) of the transaction handler (103) to obtain the business spending score of the consumer account (146) and/or the transaction profile (127 or 341). The business spending score and/or the transaction profile (127 or 341) allow the representative operating the CRM system to determine whether to provide offers of account features, or a separate account, to meet the business needs of the user (101). In one embodiment, the CRM system is configured to use the business spending score and/or the transaction profile (127 or 341) to make an automated decision on whether to provide offers tailored for businesses. For example, in one embodiment, when the business spending score is above a threshold and/or certain parameters (e.g., 342 to 346) satisfy a set of predetermined criteria, the CRM system suggests, or automatically starts, an offer flow targeted based on business needs.

In one embodiment, the business spending score computed from the classification tool is used as one of the input variables to build a more comprehensive classification indicator, for example, along with information such as risk profile data, credit score, chargeback data, dispute resolution data, other account data, adversary triggers, consumer profit score, etc.

In one embodiment, a multiplicity of variables (e.g., approximately 2000) are created based on the transaction data (109) as candidate classification variables and are used in the training process to select a plurality of selected predictive variables (e.g., 42).

In one embodiment, the candidate classification variables include, but are not limited to: customer/cardholder spending volume, transaction frequency, average transaction amount, spending volume in each of the merchant sub-segments (such as Airline, Auto Rental, Lounge, Supermarket, etc.), transaction frequency in each of the sub-segments, percentage of spend volume in each of the merchant sub-segments, percentage of transaction frequency in each of the sub-segments, geographic dispersion of transactions, etc.

In one embodiment, the candidate classification variables are evaluated/aggregated at an individual account level. Examples of the candidate classification variables include, but are not limited to:

cardholder spending volume: the total spend amount aggregated for transactions within each preselected time interval during the period of the transaction data (109) (e.g., twelve months) selected for the model training, such as amounts aggregated monthly (e.g., 12 variables for the twelve-month period), quarterly (e.g., 4 variables for the twelve-month period), bi-annually (e.g., 2 variables for the twelve-month period), or annually (e.g., 1 variable for the twelve-month period);

transaction frequency: the number of transactions aggregated for transactions within each preselected time interval during the period of the transaction data (109) (e.g., twelve months) selected for the model training, such as transaction counts aggregated monthly (e.g., 12 variables for the twelve-month period), quarterly (e.g., 4 variables for the twelve-month period), bi-annually (e.g., 2 variables for the twelve-month period), or annually (e.g., 1 variable for the twelve-month period);

average ticket size: the total spend amount aggregated for transactions within each preselected time interval during the period of the transaction data (109) (e.g., twelve months) selected for the model training, divided by the corresponding number of transactions aggregated in the corresponding time interval, such as average transaction size computed monthly (e.g., 12 variables for the twelve-month period), quarterly (e.g., 4 variables for the twelve-month period), bi-annually (e.g., 2 variables for the twelve-month period), or annually (e.g., 1 variable for the twelve-month period);

spend volume in each merchant category group, such as Airline, Auto Rental, Lounge, Supermarket, etc., aggregated for each preselected time interval, such as monthly, quarterly, bi-annually, or annually, which results in over 500 variables in one embodiment;

percentage of spend volume in each merchant category group, such as Airline, Auto Rental, Lounge, Supermarket, etc., aggregated for each preselected time interval, such as monthly, quarterly, bi-annually, or annually, which results in over 500 variables in one embodiment;

transaction frequency in each merchant category group, such as Airline, Auto Rental, Lounge, Supermarket, etc., counted for each preselected time interval, such as monthly, quarterly, bi-annually, or annually, which results in over 500 variables in one embodiment;

percentage of transaction frequency in each merchant category group, such as Airline, Auto Rental, Lounge, Supermarket, etc., counted for each preselected time interval, such as monthly, quarterly, bi-annually, or annually, which results in over 500 variables in one embodiment;

geographic dispersion of transactions, such as represented by a count of zip code areas where the transactions are conducted;

spending ratios in various classifications, such as domestic spending vs. international spending, weekday spending vs. weekend spending, face to face spending vs. card not present spending, large ticket spending (e.g., a single transaction having an amount above $1,000) vs. non-large ticket spending, small ticket spending (e.g., a single transaction having an amount below $10) vs. non-small ticket spending, etc.;

imputed residential zip code determined based on the merchant zip code where most of the “face to face” transactions are conducted; and

IRS tax return data based on imputed residential zip code, such as average salary and wages, average itemized deductions, average tax deducted gross income, percentage of filed contribution deductions, percentage of filed exemptions, percentage of filed earned income credit, percentage of filed individual retirement account payment deduction, percentage of filed Schedule C net profit/loss, percentage of filed Schedule F net profit/loss, etc.

In one embodiment, after the candidate classification variables are initially identified, a variable correlation analysis is performed to eliminate some of the variables that have the highest correlation coefficients, to avoid the possibility of a co-linearity problem at the stage of regression analysis.

In one embodiment, logistic regression is used to select the most useful predictive variables from the candidates for performance optimization. A statistical model based on the logistic regression predicts the probability (likelihood) of an outcome (e.g., whether a given account is a business account) based on a given set of conditions quantified by the values of a set of variables, such as a subset of the candidate predictive variables.

In one embodiment, an optimization is performed to select a subset of the candidate classification variables that are effective in classifying a given account. In one embodiment, the candidate classification variables are provided as inputs to a logistic regression procedure (e.g., a system developed by SAS Institute, Inc.) to perform a stepwise variable screening for the determination of a selected set of predictive variables, based on the statistical significance level and model performance, to best separate the business accounts and the non-business accounts in the training dataset.

In one embodiment, the predictive model formulated based on the selected set of predictive variables is applied to the validation dataset for scoring and model performance validation.

In one embodiment, the following set of predictive variables are selected:

V₁: an average transaction amount;

V₂: a count of “card not present” transactions;

V₃: a count of face-to-face transactions;

V₄: a count of international transactions;

V₅: a total spending amount outside US;

V₆: a count of transactions each having an amount exceeding a first threshold (e.g., $1000);

V₇: a percentage of spending of transactions each having an amount exceeding the first threshold (e.g., $1000) in total spending;

V₈: a total spending amount of transactions each having an amount exceeding the first threshold (e.g., $1000);

V₉: the percentage of annual spending volume in the category of auto rental;

V₁₀: the percentage of annual spending volume in the category of bill pay;

V₁₁: the percentage of annual spending volume in the category of business to business;

V₁₂: the percentage of annual spending volume in the category of department store;

V₁₃: the percentage of annual spending volume in the category of direct marketing;

V₁₄: the percentage of annual spending volume in the category of discount store;

V₁₅: the percentage of annual spending volume in the category of drug store;

V₁₆: the percentage of annual spending volume in the category of furniture equipment;

V₁₇: the percentage of annual spending volume in the category of government;

V₁₈: the percentage of annual spending volume in the category of health care;

V₁₉: the percentage of annual spending volume in the category of lodging;

V₂₀: the percentage of annual spending volume in the category of specialty retail;

V₂₁: the percentage of annual spending volume in the category of oil/gas;

V₂₂: the percentage of annual spending volume in the category of emerging merchants;

V₂₃: the percentage of annual spending volume in the category of other retails;

V₂₄: the percentage of annual spending volume in the category of other travel and entertainment;

V₂₅: the percentage of annual spending volume in the category of quick service restaurants;

V₂₆: the percentage of annual spending volume in the category of other merchants;

V₂₇: the percentage of annual spending volume in the category of restaurants

V₂₈: the percentage of annual spending volume in the category of sporting goods;

V₂₉: the percentage of annual spending volume in the category of cruise lines;

V₃₀: the percentage of annual spending volume in the category of supermarket;

V₃₁: the percentage of annual spending volume in the category of toll and bridges;

V₃₂: the percentage of annual spending volume in the category of travel agencies;

V₃₃: the percentage of annual spending volume in the category of wholesale clubs;

V₃₄: a total spending amount of transactions each having an amount below a second threshold (e.g., $10);

V₃₅: a percentage of spending of transactions each having an amount below the first threshold (e.g., $10) in total spending;

V₃₆: a spending amount over weekends;

V₃₇: an average amount of tax deducted gross income;

V₃₈: a count of zip codes of merchants involved in the transactions;

V₃₉: percentage of filed contribution deductions in tax returns for entities in the imputed residential zip code determined based on the merchant zip code where most of the “face to face” transactions are conducted;

V₄₀: percentage of filed income credit in tax returns for entities in the imputed residential zip code;

V₄₁: percentage of filed individual retirement account payment deduction in tax returns for entities in the imputed residential zip code; and

V₄₂: the percentage filed Schedule C net profit/loss among business tax returns in the imputed residential zip code.

In one embodiment, a combination of the above identified variables is found to be sufficient for a reliable indicator of whether the account is actually used for a business or an individual consumer.

In one embodiment, a business spending score (Z) is a linear combination of the variables V₁, V₂, . . . , V₄₂ identified above. For example,

Business Spending Score=Z=Constant+a₁×V₁+a₂×V₂+ . . . +a₄₂×V₄₂

The coefficients a₁, a₂, . . . , a₄₂ of the linear combination represent the desired weights for the respective variables and reflect the relative contribution of the respective variables to the business spending score (Z).

In one embodiment, the constant is −2.7033; a₁=0.001500; a₂=0.003770; a₃=−0.000150; a₄=−0.005090; a₅=0.000021; a₆=0.062800; a₇=−0.160300; a₈=−0.000030; a₉=0.704400; a_{10=1.166600}; a₁₁=4.839900; a₁₂=−9.493000; a₁₃=−0.636000; a₁₄=−6.936000; a₁₅=−6.373900; a₁₅=−1.189100; a₁₇=0.307900; a₁₈=−2.806400; a₁₉=0.939900; a₂₀=0.972500; a₂₁=2.098000; a₂₂=0.332300; a_{23=0.676700}; a₂₄=−1.450400; a₂₅=4.096800; a₂₆=1.028300; a₂₇=2.040400; a₂₈=−2.377600; a₂₉=−2.683500; a₃₀=−2.814700; a₃₁=0.301800; a₃₂=−1.429800; a₃₃=0.471400; a₃₄=−0.000930; a₃₅=−3.984300; a₃₆=−0.000120; a_{37=0.000001}; a₃₈=0.029000; a₃₉=0.570700; a₄₀=1.304400; a₄₁=−4.131100; and a₄₂=3.254600.

In one embodiment, a predicted probability (P) of an account actually being used by a business is the logistic function of the business spending score (Z):

P=exp(Z)/[1+exp(Z)]=1/(1+exp(−Z))

In the above example, a total of 42 variables are used in the regression model for the classification of an account. Even though the 42 variables are statistically significant, some of the variables are a relatively stronger indicator of an account being a consumer account or a business account than others. In one embodiment, the most significant variables in the model are identified as:

V₃₈: a count of zip codes of merchants involved in the transactions, which has a positive impact on business spending score Z;

V₁₁: the percentage of annual spending volume in the category of business to business, which has a positive impact on business spending score Z;

V₂₁: the percentage of annual spending volume in the category of oil/gas, which has a positive impact on business spending score Z;

V₁: an average transaction amount, which has a positive impact on business spending score Z;

V₆: a count of transactions each having an amount exceeding a first threshold (e.g., $1000), which has a positive impact on business spending score Z;

V₁₄: the percentage of annual spending volume in the category of discount store, which has a negative impact on business spending score Z;

V₁₂: the percentage of annual spending volume in the category of department store, which has a negative impact on business spending score Z;

V₁₅: the percentage of annual spending volume in the category of drug store, which has a negative impact on business spending score Z;

V₃₀: the percentage of annual spending volume in the category of supermarket, which has a negative impact on business spending score Z;

V₁₈: the percentage of annual spending volume in the category of health care, which has a negative impact on business spending score Z;

V₃₆: a spending amount over weekends, which has a negative impact on business spending score Z; and

V₃₅: a percentage of spending of transactions each having an amount below the first threshold (e.g., $10) in total spending, which has a negative impact on business spending score Z.

Thus, the less significant variables may be absent from the regression model for the account classification between personal and business in some embodiments.

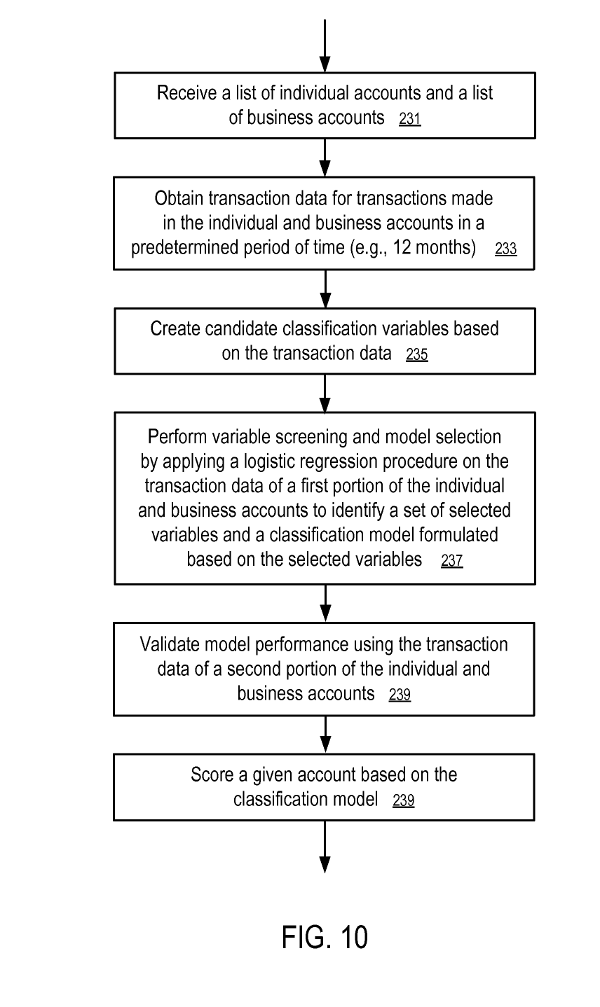

FIG. 10 shows a method to generate an account classification model in accordance with one embodiment. In FIG. 10, a computing apparatus is configured to receive (231) a list of individual accounts (e.g., 146) and a list of business accounts. In one embodiment, the majority of the individual accounts are assumed to be used for personal purposes; and the majority of the business accounts are assumed to be used for business purposes. Thus, a statistics based analysis can be used to identify parameters that characterize the spending pattern distinctions between business spending and personal spending, even when some of the accounts may not be actually used for the purposes in accordance with the design of the accounts.

In one embodiment, the individual accounts and the business accounts are selected from accounts issued by different issuers. Thus, the lists of the accounts and the spending patterns in the respective accounts are not limited by the characteristics of issuers.

In one embodiment, since the computing apparatus is coupled to the transaction handler (103) and/or the data warehouse (149) of the transaction handler (103), the computing apparatus does not need further information from issuers for the development of the account classification model.

In one embodiment, the computing apparatus is configured to obtain (233) transaction data (109) (e.g., from the data warehouse (149) of the transaction handler (109)) for transactions made in the individual and business accounts, as identified in the received lists, wherein the transactions occurred within a predetermined scoring period of time (e.g., a 12-month time period prior to the generation of the classification model).

In one embodiment, the computing apparatus is configured to create (235) candidate classification variables based on the transaction data (109). Each of the candidate classification variables are computed based on the transaction data (109). In one embodiment, codes defining the computation of the variables are provided as input. In one embodiment, the values of the variables are determined from the transaction data (109) and provided as input.

In one embodiment, the computing apparatus is configured to perform (237) variable screening and model selection by applying a logistic regression procedure on the transaction data (109) of a first portion of the individual and business accounts, obtained for the predetermined scoring period of time, to identify a set of selected variables and a predictive model formulated based on the selected variables.

In one embodiment, the computing apparatus is further configured to validate (239) model performance using the transaction data (109) of a second portion of the individual and business accounts obtained for the predetermined scoring period of time.

After the classification model is developed (237) and validated (239), including the identification of selected variables (e.g., V₁, V₂, . . . , V₄₂ disclosed above) and the coefficients or weights (e.g., a₁, a₂, . . . , a₄₂) for the respective variables, the computing apparatus is configured to score (239) a given account based on the classification model. In one embodiment, the business spending score (e.g., Z disclosed above) can be computed for any of the customer accounts (e.g., 146) regardless of the identity of the issuer (210) of the respective customer account (e.g., 146).

In one embodiment, the classification model is implemented on a computing device that is different from the computing device configured to generate and/or validate the classification model.

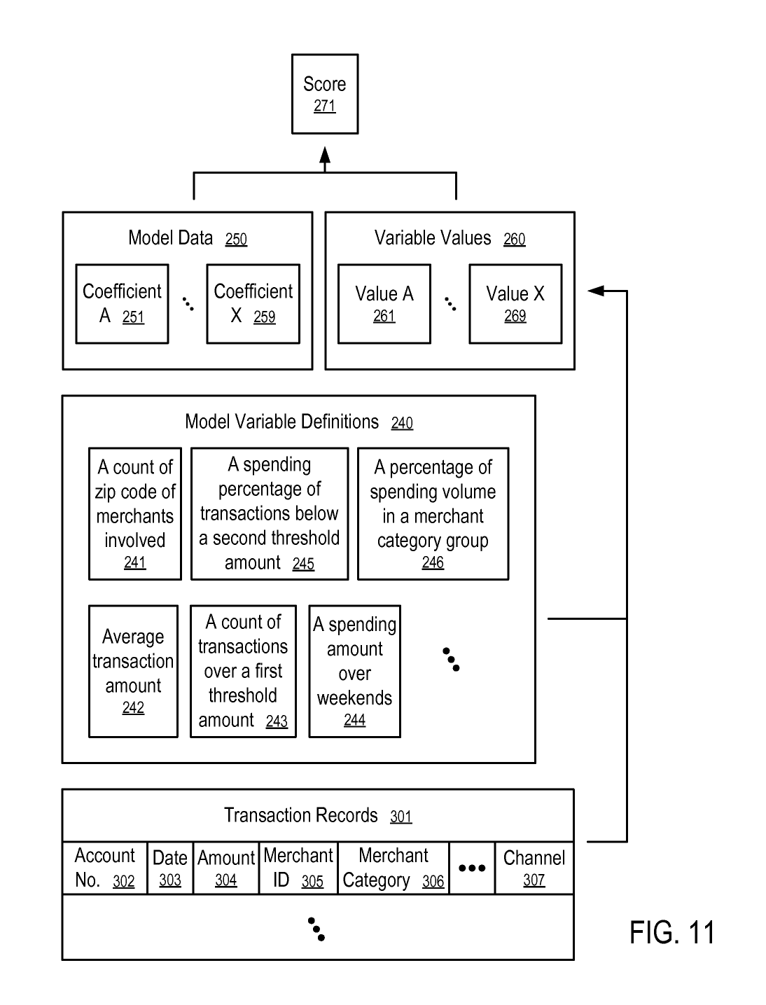

FIG. 11 shows an account classification model in accordance with one embodiment. In FIG. 11, a consumer account (146) is identified by the account number (302) in the transaction records (301). To evaluate the business spending score (271) for a given consumer account (146) of a user (101), a computing apparatus associated with the transaction handler (103), or the issuer processor (145) that has access to the set of transaction records (301) associated with the account number (302), is configured to evaluate the variable values (260) by applying the model variable definitions (240) to the transaction records (301) having the account number (302) of the consumer account (146) of the user (101).

In one embodiment, the model variable definitions (240) for variables (241, . . . , 245) correspond to some of the variables disclosed above, such as V₃₈, V₁, V₆, V₃₆, and V₃₅; the variable (246) represents some of the variables, such as V₁₁, V₁₂, V₁₄, V₁₅, V₁₈, V₂₁, or V₃₀; and the model variable definitions (240) may also include definitions for other classification variables discussed above.

In one embodiment, the model data (250) includes coefficients (251, . . . , 259) corresponding to the coefficients disclosed above for the respective variables. In one embodiment, the model data (250) and the variable values (260) are combined to generate the business spending score (271) in a way similar to the generation of business spending score (Z) from variables V₁, V₂, . . . , V₄₂ and coefficients a₁, a₂, . . . , a₄₂ discussed above.

In one embodiment, the predictive model, including the model variable definitions (240) and the model data (250), is periodically updated based on the above identified procedure for the development of the predictive model and the recent transaction data (109), which better captures the recent spending behavior associated with account distinctions. The updated predictive model may select more or less variables than the variables V₁, V₂, . . . , V₄₂ disclosed above and may suggest different variables. The updated predictive model may also include updated coefficients (251, . . . , 259) as the weights of the corresponding variable values (260).

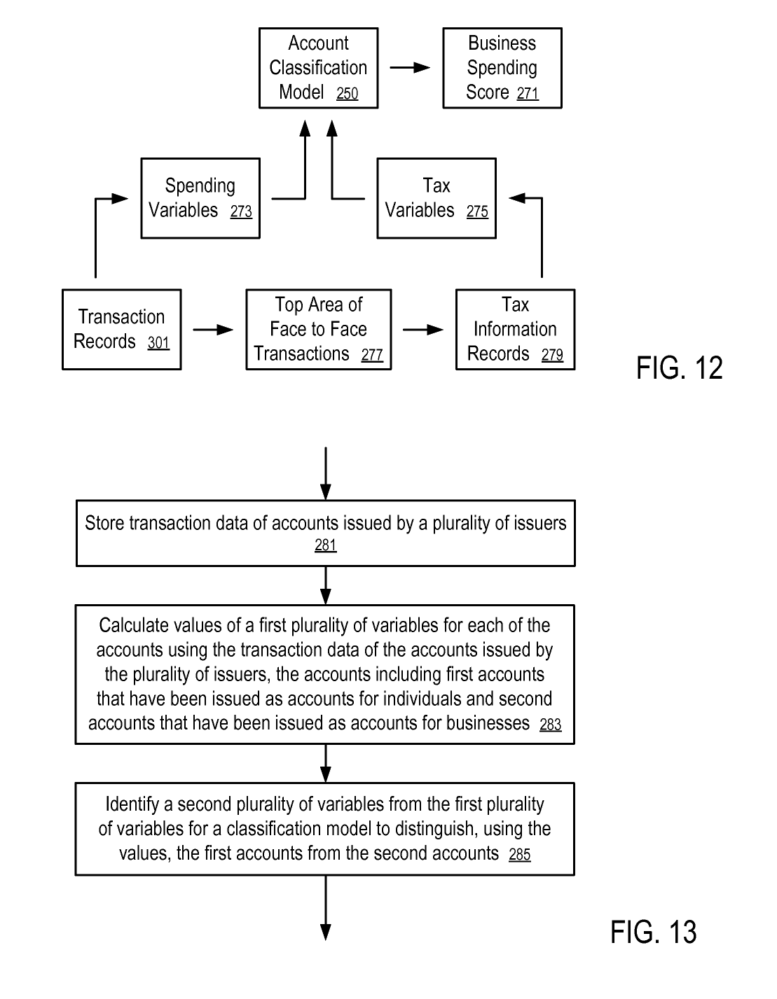

FIG. 12 shows an account classification model in accordance with one embodiment. In FIG. 12, the account classification model (250) used to compute the business spending score (271), which indicates the probability of an account (146) being actually used for a business purpose, is based on both the transaction records (301) in the account (146) and the tax information records (279).

In FIG. 12, the transaction records (301) (e.g., for the transactions that occurred within the past 12 months in the account (146)) are analyzed to determine the top area of face to face transactions (277). In one embodiment, the top area of face to face transactions (277) is represented by a zip code (or an identification of a region, a city, a neighborhood, etc.). In one embodiment, the transaction locations are determined by the locations of the merchants involved in the transaction records (301).

In one embodiment, the face to face transactions are identified via the transaction channel (307) (e.g., online, offline, via mobile devices) recorded in the transaction records (301). In one embodiment, certain transactions channels are considered an indication of face to face transactions; and other transactions channels are considered an indication of non-face to face transactions.

For example, in one embodiment, the transactions performed via channels (307) associated with face to face transactions are counted for the transaction records for each of the distinct zip codes of the merchant locations, as identified via the transaction records (301); and the zip code having the highest transaction count is used as the identification of the top area of face to face transactions (277).

In one embodiment, the top area of face to face transactions (277) is used to identify statistical data about tax information for entities residing in the respective area. For example, in FIG. 12, the tax information records (279) are used to generate the tax variables (275) (e.g., V₃₉, V₄₀, V₄₁, and V₄₂ discussed above) that characterize the tax information about the entities residing in the top area of face to face transactions (277) in the account (146).

In one embodiment, the spending variables (273) (e.g., V₁, V₂, . . . , and V₃₈) are derived based on the transaction records (301) and do not rely upon the tax information records (279). The account classification model (250) uses both the spending variables (273) and the tax variables (275) to generate the business spending score (271).

In some embodiments, the tax variables (275) are not used, since they are not associated with the most significant variables identified above. However, the use of the tax variables (275) can improve the classification accuracy of the account classification model (250).

FIG. 13 shows a method to identify parameters of an account classification model in accordance with one embodiment. A computing apparatus is configured to store (281), in a data warehouse (149) or database (209), transaction data (109) of accounts (e.g., 146) issued by a plurality of issuers (210); calculate (283) values of a first plurality of variables for each of the accounts (e.g., 146) using the transaction data (109) of the accounts (e.g., 146) issued by the plurality of issuers (210), wherein the accounts (e.g., 146) include first accounts that have been issued as accounts for individuals and second accounts that have been issued as accounts for businesses; and identify (285) a second plurality of variables (e.g., 241-246) from the first plurality of variables for a classification model to distinguish, using the values, the first accounts from the second accounts.

In one embodiment, the second plurality of variables is identified based on logistic regression and stepwise variable screening.

In one embodiment, at least a portion of the first plurality of variables are based on tax information.

In one embodiment, the transaction data (109) records payment transactions made in the first accounts and the second accounts; and the computing apparatus further includes a transaction handler (103) configured to process each respective transaction of the payment transactions, where each respective transaction includes a payment from a respective issuer to a respective acquirer settled via the transaction handler (103).

In one embodiment, the predictive model includes a linear combination of the second plurality of variables (e.g., 241-244); when computed for an account (146), the linear combination provides a score (271) indicative of a probability of the account (146) being actually used by a business during the predetermined period of time. In one embodiment, a predicted probability of the account being actually used by a business during the predetermined period of time is a logistic function of the score (271).

In one embodiment, the second plurality of variables include: a count of zip codes of merchants involved in transactions in the account (146) (e.g., V₃₈ or variable (241)); an average amount of transactions in the account (146) (e.g., V₁ or variable (242)); a count of transactions in the account (146) each having a transaction amount above a first threshold (e.g., V₆ or variable (243)); a spending amount of transactions in the account (146) performed over weekends (e.g., V₃₆ or variable (244)); a spending percentage of transactions in the account (146) each having a transaction amount below a second threshold (e.g., V₃₅ or variable (245)); and a spending percentage of transactions of the account (146) in a predetermined merchant category group (e.g., variable (246), such as V₁₁, V₁₂, V₁₄, V₁₅, V₁₈, V₂₁, or V₃₀). Examples of the predetermined merchant category group include: business to business, oil/gas, discount store, department store, drug store, supermarket, and health care.

In one embodiment, the second plurality variables (e.g., 273 and 275) include tax statistical data (e.g., 279) for entities residing in a region (e.g., 277) where, during the predetermined period of time, most face to face transactions in the account were conducted.

In one embodiment, the computing apparatus is configured to process payment transactions for a plurality of accounts (e.g., 146), store transaction data (109) recording the payment transactions for the plurality of accounts (e.g., 146), compute a score (271) for each respective account of the accounts (e.g., 146) based on the transaction data (109), and provide the score (271) to an issuer of the respective account to determine whether to provide an offer to a user (101) of the respective account. In one embodiment, the score is configured to be indicative of a probability of the respective account being actually used for business purposes.

In one embodiment, the probability of the respective account being actually used for business purposes is a logistic function of the score (271); and examples of the offer include an upgrade to a business account or an account feature tailored for business procurement.

In one embodiment, the score is a combination of variables (e.g., 273 and 275, or 241, 242, . . . , 246) evaluated using transaction data (109) recorded for the respective account (146).

In one embodiment, at least a portion of the variables (e.g., 275) are evaluated based on statistical data (279) about tax returns identified via the transaction data (109), such as the top area of face to face transactions (277) in the transaction records (301) of the respective account (146).

In one embodiment, the offer is determined based on an aggregated spending profile (341) for transactions aggregated for the respective account.

In one embodiment, the computing apparatus includes: the data warehouse (149) storing first transaction data (109) recording payment transactions processed for a plurality of accounts, a memory (206) storing model data (250) derived from second transaction data of accounts issued by a plurality of issuers (e.g., 210); and at least one processor (203) coupled with the memory (206) and the data warehouse (149) to compute a score (271) for each respective account of the plurality of accounts using the first transaction data (109) and the model data (250). In one embodiment, the model data (250) is configured to provide a predicted probability of the respective account being actually used by a business entity as a logistic function of the score (271).

In one embodiment, the computing apparatus further includes a transaction handler (103) configured to process the payment transactions and coupled to the data warehouse (149) to record the first transaction data (109).

In one embodiment, the transaction handler (103) is configured to communicate with issuer processors (e.g., 145) and acquirer processors (e.g., 147) to settle the payment transactions recorded in the second transaction data.

In one embodiment, the computing apparatus includes a portal (e.g., 143) coupled with the at least one processor (203) to receive a request from an issuer (210) and provide the score (271) to the issuer (210) when an account (146) that has a probability of actually being used by a business higher than a threshold is issued by the issuer (210).

In one embodiment, the computing apparatus includes the offer selector (407), the advertisement selector (133), the profile selector (129), and/or the profile generator (121). In one embodiment, the computing apparatus is configured to select the offer and provide the offer via the portal (143) to the user (101) of the respective account (146).

### Opportunity Score

In one embodiment, a score is computed using the transaction data (109) to identify affluent users (e.g., 101) of consumer accounts (e.g., 146). Personalized and/or targeted offers can be provided to the users (e.g., 101) based on the score and/or other information such as transaction profiles (e.g., 127, and 341).

For example, transaction data (109) of a first type of consumer accounts (e.g., 146) is used to identify a subset of accounts having behaviors that mirror the behavior of accounts of a second type in one embodiment, and thus have the opportunity to be offered with accounts of the second type. Information identifying a list of accounts of the first type and scores of the respective accounts can be generated and provided to an account issuer for actions, such as offering account holders having high scores an upgrade to the accounts of the second type, or providing the account holders with incentives and/or rewards, etc. to improve account holder loyalty and/or promote account usage.

In one embodiment, the computing of the information indicative of the level of opportunities is based on the transaction data (109) recorded by the transaction handler (103) and does not require additional information from issuers of the accounts (e.g., 146).

The inventors realized that several behavioral characteristics can be used to construct transactional variables for a predictive model for affluence level. For example, the affluent travel much more; and the higher the level of affluence, the more they travel. This is especially true of international travel. For example, affluent people dine out more frequently than the non-affluent. For example, affluent people have more disposable income, and would therefore be more likely to purchase items that are not necessities, such as items in the merchant category of “specialty retail.”

The inventors developed a hypothesis that behavior related to restaurants, airlines, and specialty retail may indicate level of affluence (and therefore upgrade opportunity), in addition to the presence of international travel. To statistically verify the hypothesis, the inventors performed a chi-square test of various merchant category groups by major merchant category. For the most part, the chi-square test supported the hypothesis. However, it was found that the lodging category had a higher chi-square value than the airline category, and also reached more cardholders. Thus, the category of lodging is substituted for the category of airline in one embodiment of scoring the affluence level of the accounts.

In one embodiment, to help separate people that eat out every day in inexpensive restaurants from those that are truly wealthy, the inventors hypothesized that the restaurant transaction value (ticket size) would be a better indicator of affluence than the amount a user spends in the restaurant category.

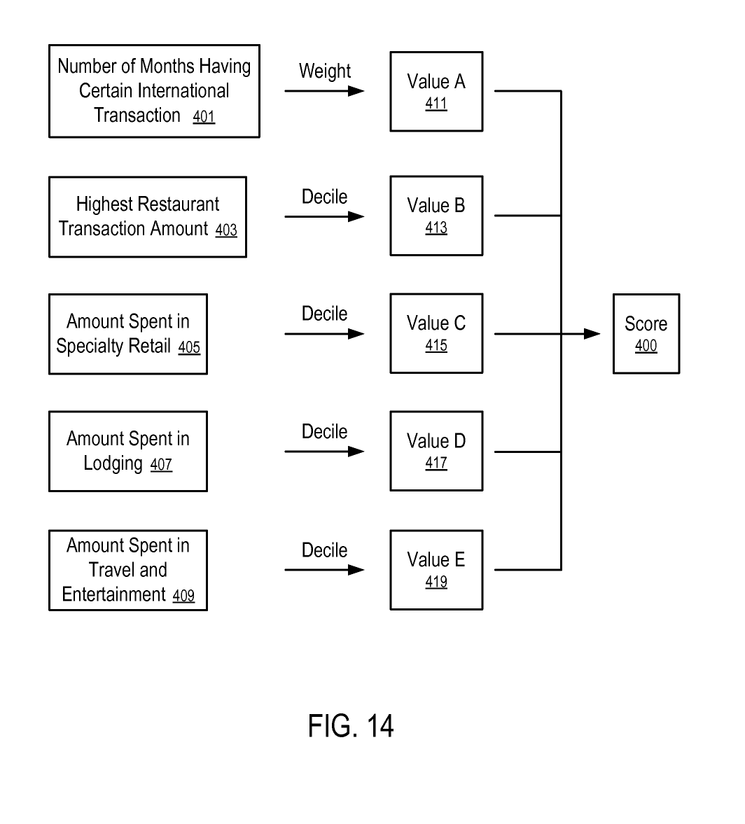

Based on the above analysis, a model to predict the affluence level of an account is constructed. FIG. 14 shows a model to generate a score indicative of the opportunity to provide offers to affluent account holders in accordance with one embodiment. In FIG. 14, the model includes the following variables:

1) number of months (401) in which there are face-to-face international transactions (e.g., the “card-present” type of transactions at retail locations outside the country where the account holder resides);

2) highest restaurant transaction value (403);

3) aggregated spending amount in the merchant category of specialty retail (405);

4) aggregated spending amount in the merchant category of lodging (407); and

5) aggregated spending amount in the merchant category of “other travel and entertainment” (409).

In one embodiment, a computing device is configured to evaluate the values of the above identified variables (401-409) to generate a score (400) indicative of the affluence level of the account holder (e.g., user (101)).

Frequency of international travel is a predictor of wealth. However, the number of international transactions per account is not in itself a descriptor of frequency of international travel. Describing the unique number of international travel occurrences for each account is difficult. To get a sense of the frequency of international travel per account, a computing apparatus is configured to compute a proxy of the frequency of international travel.

In one embodiment, the international travel proxy is computed via:

1) identifying every account (146) that had a face-to-face international transaction in a predetermined time period (e.g., in a predetermined number of past months), excluding airline and direct marketing transactions;

2) for each of these accounts, counting how many months in which the respective account (146) had a face-to-face international transaction; and

3) tagging each account (146) with the counted number (401) of months having face-to-face international transactions.

In one embodiment, the counted number (401) of months having face-to-face international transactions is limited in the range of zero to five; and a weight of two is provided to the counted number of months having face-to-face international transactions to generate a value (411) for travel variable (401) for combination with other variables (e.g., 403-409) that have values in the range of zero to ten.

In one embodiment, the value (413) of a dining variable is computed via:

1) analyzing each account (146) for restaurant transactions in a predetermined time period (e.g., in the past X months);

2) identifying the highest transaction value (403) of the restaurant transactions for each account (146);

3) ranking and dividing the accounts into deciles based on the highest restaurant transaction value (403) for each account (146); and

4) assigning each account (146) a restaurant deciles value (413) in the range of zero to ten in accordance with their deciles.

In one embodiment, the value (415) of a specialty retail variable is computed via:

1) identifying transactions in the merchant category of “specialty retail” in each account (146) in a predetermined time period (e.g., in the predetermined number of past months);

2) summing the identified transactions in the merchant category of “specialty retail” to obtain an aggregated amount of specialty retail (405) for each account (146);

3) ranking and dividing the accounts into deciles based on the aggregated amount of specialty retail (405); and

4) assigning each account (146) a specialty retail deciles value (415) in the range of zero to ten in accordance with the deciles group the respective account (146) is in.

In one embodiment, the value (417) of a lodging variable is computed via:

1) identifying transactions in the merchant category of “lodging” in each account (146) in a predetermined time period (e.g., in the predetermined number of past months);

2) summing the identified transactions in the merchant category of “lodging” to obtain an aggregated amount of lodging (407) for each account (146);

3) ranking and dividing the accounts into deciles based on the aggregated amount of lodging (407); and

4) assigning each account (146) a lodging deciles value (417) in the range of zero to ten in accordance with the deciles group the respective account (146) is in.

In one embodiment, the value (419) of a travel and entertainment variable is computed via:

1) identifying transactions in the merchant category of “travel and entertainment” in each account (146) in a predetermined time period (e.g., in the predetermined number of past months);

2) summing the identified transactions in the merchant category of “travel and entertainment” to obtain an aggregated amount of travel and entertainment (409) for each account (146);

3) ranking and dividing the accounts into deciles based on the aggregated amount of travel and entertainment (409); and

4) assigning each account (146) a travel and entertainment deciles value (419) in the range of zero to ten in accordance with the deciles group the respective account (146) is in.

In one embodiment, each of the values (411-419) of the travel variable, the dining variable, the specialty retail variable, the lodging variable, and the travel and entertainment variable is in the range from zero to ten and is evaluated for each account (146) based on the transaction data (109) recorded by the transaction handler (103). For each account (146), the values (411-419) are squared, summed and scaled by a constant (e.g., ten) to generate the score (400) indicative of the affluence level of the account holder of the respective account (146). In one embodiment, the values (411-419) are raised to a power larger than one, before being summed.

In one embodiment, to measure the actual spending level of the respective account (146), the computing device is configured to compute the total spending of the respective account (146) in the predetermined period of time (e.g., in the predetermined number of past months). The total spending is indicative of the actual spending of the respective account (146).

In one embodiment, the total spending and the score (400) indicative of the affluence level of the account (146) is used to segment the account population; and targeted offers are provided the account holders in different segments based on the characteristics of the segments and/or the transaction profiles (127) of the accounts (146).

In one embodiment, the score (400) indicative of the affluence level of the account (146) is included in the transaction profile (e.g., 127 or 341) of the respective account holder.

In one embodiment, the score (400) indicative of the affluence level is determined for individual accounts (e.g., 146), regardless of whether the accounts are held by the same person or not.

In one embodiment, the score (400) indicative of the affluence level is determined for individual account holders (e.g., user (101)), by aggregating the transaction data of each account holder across multiple accounts issued by different or same issuers, where the accounts (146) are processed via the transaction handler (103).

In one embodiment, the score (400) indicative of the affluence level is used to rank the account holders for product recommendations. For example, in one embodiment, a first percentage of the top ranked accounts (e.g., 3.4%) are recommended for platinum accounts; and a second percentage of the next top ranked accounts (e.g., 11%) are recommended for gold accounts.

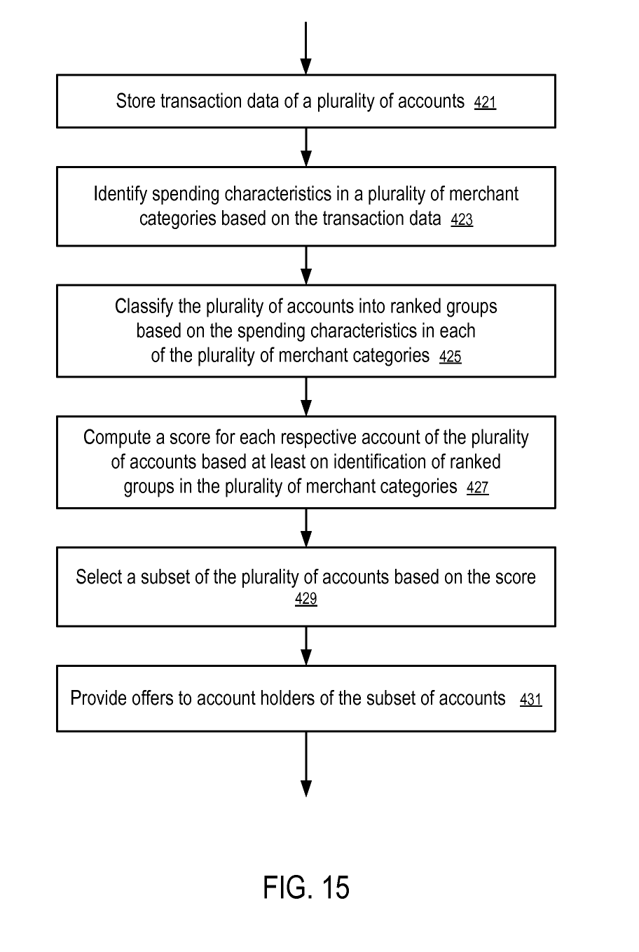

FIG. 15 shows a method to provide offers in accordance with one embodiment. In FIG. 15, a computing apparatus is configured to: store (421) transaction data (109) of a plurality of accounts (e.g., 146); identify (423) spending characteristics (e.g., 403-409) in a plurality of merchant categories based on the transaction data (109); classify (425) the plurality of accounts into ranked groups (413-419) based on the spending characteristics (e.g., 403-409) in each of the plurality of merchant categories; compute (427) a score (400) for each respective account (146) of the plurality of accounts based at least on identification of ranked groups (413-419) in the plurality of merchant categories; select (429) a subset of the plurality of accounts based on the score (400); and provide (431) offers to account holders (e.g., user (101)) of the subset of accounts (e.g., 146).

In one embodiment, the computing apparatus includes at least one processor (173) and a memory (167) storing instructions configured to instruct the at least one processor to: identify spending characteristics (e.g., 403-409) in a plurality of merchant categories based on the transaction data (109); rank the plurality of accounts (e.g., 146) based on the spending characteristics (e.g., 403-409) to generate ranks of the plurality of accounts in the plurality of merchant categories; and compute a score (400) indicative of a opportunity of each account (e.g., 146) of the plurality of accounts based at least on the ranks of the plurality of accounts in the plurality of merchant categories.

In one embodiment, the instructions stored in the memory (167) are configured to instruct the at least one processors (e.g., 173) to further determine a spending level of each account (e.g., 146) of the plurality of accounts and segment the plurality of accounts based on the spending level of and the score (400) for each account (e.g., 146) of the plurality of accounts.

In one embodiment, the instructions stored in the memory (167) are configured to instruct the at least one processors (e.g., 173) to count, for each respective account (e.g., 146) of the plurality of accounts, a number of months, within a predetermined period of time, in which months the respective account (e.g., 146) has at least one transaction meeting a set of predetermined requirements. The score (400) of the respective account (e.g., 146) is determined based on the number of months.

For example, the set of predetermined requirements may include a requirement that the at least one transaction is made at retail locations outside a country in which an account holder of the respective account (e.g., 146) resides.

For example, the set of predetermined requirements may include a requirement that the at least one transaction is of a card-present type of transactions (e.g., a face-to-face transaction, where the user (101) of the respective account (146) presents the account identification device (141) for interaction with transaction terminal (105) positioned in the foreign retail locations to initiate the at least one transaction).

In one embodiment, for the respective account (e.g., 146) of the plurality of accounts, the score is generated by combining the number of months (e.g., 401) and the ranks (e.g., 413-419) of the respective account (e.g., 146) in the plurality of merchant categories among the plurality of accounts. Examples of the plurality of merchant categories are: “restaurant”, “specialty retail”, “lodging”, and “travel and entertainment”.

In one embodiment, in at least one of the merchant categories (e.g., “restaurant”), the ranking is based on the highest transaction amount that is recorded in a single transaction among transactions in each respective account (e.g., 146) account in the plurality of accounts, such as ranking accounts according to the largest ticket size of restaurant transactions.

In one embodiment, instructions stored in the memory (167) are configured to instruct the at least one processors (e.g., 173) to determine decile values (e.g., 413-419) of the respective account based on the ranks of the respective account in the plurality of merchant categories among the plurality of accounts, and combine the decile values (e.g., 413-419) of the respective account and the number of months (e.g., 401) counted for the respective account to compute the score (400) for the respective account (e.g., 146).

In one embodiment, the number of months (e.g., 401) is limited by a predetermined maximum value (e.g., 5) and weighted to have a range consistent with the range of the decile values (e.g., 413-419).

In one embodiment, the combining of the decile values (413-419) and the number of months (401) includes summing results of raising the decile values (413-419) and the number of months (401) to a predetermined power larger than one.

In one embodiment, a decile value (413, 415, . . . , or 419) is associated with a group ranking of an account (e.g., 146) when the accounts are ranked according to the spending characteristics (e.g., 403, 405, . . . , 409). For example, after the accounts are ranked, the accounts are separated into ten groups of equal numbers of accounts. The accounts in the top ranking group are assigned the decile value of 10, and the next group the decile value of 9, etc. The bottom ranking group is assigned the decile value of 0. Thus, the decile values have a range between 0 and 10. The decile values may be normalized (e.g., to have a normalized range between 0 and 1) before raised to the predetermined power (e.g., two) and summed to generate the score (400). In one embodiment, the number of months (401) counted for having the international “card-present” type of transactions is also normalized to a range equal to the normalized range of the decile value to allow the normalized month count to be raised to the same predetermined power (e.g., two) and summed with the respective values computed from the decile values (e.g., 413, . . . , 419) to generate the score (400).

In one embodiment, the rank indicators are based on dividing the ranked accounts into 10 groups. Alternatively, the accounts can be divided into groups according to another predetermined numbers, such as 20, or 100. The group ranking indicators can be similarly normalized, raised to the predetermined power (e.g., a number large than one), and summed to generate the score (400). Further, different values (e.g., 411, . . . , 419) may be weighted different toward the score (400).

In one embodiment, the number of months (401) counted for having “card-present” international transactions represents an international purchase frequency proxy for the respective account (e.g., 146). The number of months (401) may be limited by a predetermined maximum threshold. When the actual number of months (401) counted to have such “card-present” international transactions exceeds the predetermined maximum threshold, the predetermined maximum threshold is used to compute the value (411).

In one embodiment, spending in the merchant category of restaurant is ranked based on highest transaction amount.

For example, in one embodiment, the ranking of the accounts for spending in the merchant category of “restaurant” is based on the largest transaction amount (304) recorded in the transaction record (301) for the transaction in the merchant category (306) corresponding to “restaurant”; and the ranking of the accounts for spending in the merchant category of “specialty retail”, “lodging” or “travel & entertainment” is based on computing the aggregated transaction amounts for transactions in respective accounts in the respective merchant category (e.g., “specialty retail”, “lodging” or “travel & entertainment”).

In some embodiments, rankings in fewer or more merchant categories can be used to generate the score (400). The rankings may also be based on the transaction frequencies in the respective merchant categories in which the accounts are ranked.

In one embodiment, the computing apparatus/system includes at least one of: the portal (143), the profile generator (121), the transaction handler (103), the data warehouse (149), the advertisement selector (133), and the media controller (115).

Details about the system in one embodiment are provided in the section entitled “SYSTEM,” “CENTRALIZED DATA WAREHOUSE” and “HARDWARE.”

### Variations

Some embodiments use more or fewer components than those illustrated in FIGS. 1 and 4-7. For example, in one embodiment, the user specific profile (131) is used by a search engine to prioritize search results. In one embodiment, the correlator (117) is to correlate transactions with online activities, such as searching, web browsing, and social networking, instead of or in addition to the user specific advertisement data (119). In one embodiment, the correlator (117) is to correlate transactions and/or spending patterns with news announcements, market changes, events, natural disasters, etc. In one embodiment, the data to be correlated by the correlator with the transaction data (109) may not be personalized via the user specific profile (131) and may not be user specific. In one embodiment, multiple different devices are used at the point of interaction (107) for interaction with the user (101); and some of the devices may not be capable of receiving input from the user (101). In one embodiment, there are transaction terminals (105) to initiate transactions for a plurality of users (101) with a plurality of different merchants. In one embodiment, the account information (142) is provided to the transaction terminal (105) directly (e.g., via phone or Internet) without the use of the account identification device (141).

In one embodiment, at least some of the profile generator (121), correlator (117), profile selector (129), and advertisement selector (133) are controlled by the entity that operates the transaction handler (103). In another embodiment, at least some of the profile generator (121), correlator (117), profile selector (129), and advertisement selector (133) are not controlled by the entity that operates the transaction handler (103).

For example, in one embodiment, the entity operating the transaction handler (103) provides the intelligence (e.g., transaction profiles (127) or the user specific profile (131)) for the selection of the advertisement; and a third party (e.g., a web search engine, a publisher, or a retailer) may present the advertisement in a context outside a transaction involving the transaction handler (103) before the advertisement results in a purchase.

For example, in one embodiment, the customer may interact with the third party at the point of interaction (107); and the entity controlling the transaction handler (103) may allow the third party to query for intelligence information (e.g., transaction profiles (127), or the user specific profile (131)) about the customer using the user data (125), thus informing the third party of the intelligence information for targeting the advertisements, which can be more useful, effective and compelling to the user (101). For example, the entity operating the transaction handler (103) may provide the intelligence information without generating, identifying or selecting advertisements; and the third party receiving the intelligence information may identify, select and/or present advertisements.

Through the use of the transaction data (109), account data (111), correlation results (123), the context at the point of interaction, and/or other data, relevant and compelling messages or advertisements can be selected for the customer at the points of interaction (e.g., 107) for targeted advertising. The messages or advertisements are thus delivered at the optimal time for influencing or reinforcing brand perceptions and revenue-generating behavior. The customers receive the advertisements in the media channels that they like and/or use most frequently.

In one embodiment, the transaction data (109) includes transaction amounts, the identities of the payees (e.g., merchants), and the date and time of the transactions. The identities of the payees can be correlated to the businesses, services, products and/or locations of the payees. For example, the transaction handler (103) maintains a database of merchant data, including the merchant locations, businesses, services, products, etc. Thus, the transaction data (109) can be used to determine the purchase behavior, pattern, preference, tendency, frequency, trend, budget and/or propensity of the customers in relation to various types of businesses, services and/or products and in relation to time.

In one embodiment, the products and/or services purchased by the user (101) are also identified by the information transmitted from the merchants or service providers. Thus, the transaction data (109) may include identification of the individual products and/or services, which allows the profile generator (121) to generate transaction profiles (127) with fine granularity or resolution. In one embodiment, the granularity or resolution may be at a level of distinct products and services that can be purchased (e.g., stock-keeping unit (SKU) level), or category or type of products or services, or vendor of products or services, etc.

The profile generator (121) may consolidate transaction data for a person having multiple accounts to derive intelligence information about the person to generate a profile for the person (e.g., transaction profiles (127), or the user specific profile (131)).

The profile generator (121) may consolidate transaction data for a family having multiple accounts held by family members to derive intelligence information about the family to generate a profile for the family (e.g., transaction profiles (127), or the user specific profile (131)).

Similarly, the profile generator (121) may consolidate transaction data for a group of persons, after the group is identified by certain characteristics, such as gender, income level, geographical location or region, preference, characteristics of past purchases (e.g., merchant categories, purchase types), cluster, propensity, demographics, social networking characteristics (e.g., relationships, preferences, activities on social networking websites), etc. The consolidated transaction data can be used to derive intelligence information about the group to generate a profile for the group (e.g., transaction profiles (127), or the user specific profile (131)).

In one embodiment, the profile generator (121) may consolidate transaction data according to the user data (125) to generate a profile specific to the user data (125).

Since the transaction data (109) are records and history of past purchases, the profile generator (121) can derive intelligence information about a customer using an account, a customer using multiple accounts, a family, a company, or other groups of customers, about what the targeted audience is likely to purchase in the future, how frequently, and their likely budgets for such future purchases. Intelligence information is useful in selecting the advertisements that are most useful, effective and compelling to the customer, thus increasing the efficiency and effectiveness of the advertising process.

In one embodiment, the transaction data (109) are enhanced with correlation results (123) correlating past advertisements and purchases resulting at least in part from the advertisements. Thus, the intelligence information can be more accurate in assisting with the selection of the advertisements. The intelligence information may not only indicate what the audience is likely to purchase, but also how likely the audience is to be influenced by advertisements for certain purchases, and the relative effectiveness of different forms of advertisements for the audience. Thus, the advertisement selector (133) can select the advertisements to best use the opportunity to communicate with the audience. Further, the transaction data (109) can be enhanced via other data elements, such as program enrollment, affinity programs, redemption of reward points (or other types of offers), online activities, such as web searches and web browsing, social networking information, etc., based on the account data (111) and/or other data, such as non-transactional data discussed in U.S. patent application Ser. No. 12/614,603, filed Nov. 9, 2009 and entitled “Analyzing Local Non-Transactional Data with Transactional Data in Predictive Models,” the disclosure of which is hereby incorporated herein by reference.

In one embodiment, the entity operating the transaction handler (103) provides the intelligence information in real-time as the request for the intelligence information occurs. In other embodiments, the entity operating the transaction handler (103) may provide the intelligence information in batch mode. The intelligence information can be delivered via online communications (e.g., via an application programming interface (API) on a website, or other information server), or via physical transportation of a computer readable media that stores the data representing the intelligence information.

In one embodiment, the intelligence information is communicated to various entities in the system in a way similar to, and/or in parallel with the information flow in the transaction system to move money. The transaction handler (103) routes the information in the same way it routes the currency involved in the transactions.

In one embodiment, the portal (143) provides a user interface to allow the user (101) to select items offered on different merchant websites and store the selected items in a wish list for comparison, reviewing, purchasing, tracking, etc. The information collected via the wish list can be used to improve the transaction profiles (127) and derive intelligence on the needs of the user (101); and targeted advertisements can be delivered to the user (101) via the wish list user interface provided by the portal (143). Examples of user interface systems to manage wish lists are provided in U.S. patent application Ser. No. 12/683,802, filed Jan. 7, 2010 and entitled “System and Method for Managing Items of Interest Selected from Online Merchants,” the disclosure of which is hereby incorporated herein by reference.

### Aggregated Spending Profile

In one embodiment, the characteristics of transaction patterns of customers are profiled via clusters, factors, and/or categories of purchases. The transaction data (109) may include transaction records (301); and in one embodiment, an aggregated spending profile (341) is generated from the transaction records (301), in a way illustrated in FIG. 2, to summarize the spending behavior reflected in the transaction records (301).

In one embodiment, each of the transaction records (301) is for a particular transaction processed by the transaction handler (103). Each of the transaction records (301) provides information about the particular transaction, such as the account number (302) of the consumer account (146) used to pay for the purchase, the date (303) (and/or time) of the transaction, the amount (304) of the transaction, the ID (305) of the merchant who receives the payment, the category (306) of the merchant, the channel (307) through which the purchase was made, etc. Examples of channels include online, offline in-store, via phone, etc. In one embodiment, the transaction records (301) may further include a field to identify a type of transaction, such as card-present, card-not-present, etc.

In one embodiment, a “card-present” transaction involves physically presenting the account identification device (141), such as a financial transaction card, to the merchant (e.g., via swiping a credit card at a POS terminal of a merchant); and a “card-not-present” transaction involves presenting the account information (142) of the consumer account (146) to the merchant to identify the consumer account (146) without physically presenting the account identification device (141) to the merchant or the transaction terminal (105).

In one embodiment, certain information about the transaction can be looked up in a separate database based on other information recorded for the transaction. For example, a database may be used to store information about merchants, such as the geographical locations of the merchants, categories of the merchants, etc. Thus, the corresponding merchant information related to a transaction can be determined using the merchant ID (305) recorded for the transaction.

In one embodiment, the transaction records (301) may further include details about the products and/or services involved in the purchase. For example, a list of items purchased in the transaction may be recorded together with the respective purchase prices of the items and/or the respective quantities of the purchased items. The products and/or services can be identified via stock-keeping unit (SKU) numbers, or product category IDs. The purchase details may be stored in a separate database and be looked up based on an identifier of the transaction.

When there is voluminous data representing the transaction records (301), the spending patterns reflected in the transaction records (301) can be difficult to recognize by an ordinary person.

In one embodiment, the voluminous transaction records (301) are summarized (335) into aggregated spending profiles (e.g., 341) to concisely present the statistical spending characteristics reflected in the transaction records (301). The aggregated spending profile (341) uses values derived from statistical analysis to present the statistical characteristics of transaction records (301) of an entity in a way easy to understand by an ordinary person.

In FIG. 2, the transaction records (301) are summarized (335) via factor analysis (327) to condense the variables (e.g., 313, 315) and via cluster analysis (329) to segregate entities by spending patterns.

In FIG. 2, a set of variables (e.g., 311, 313, 315) are defined based on the parameters recorded in the transaction records (301). The variables (e.g., 311, 313, and 315) are defined in a way to have meanings easily understood by an ordinary person. For example, variables (311) measure the aggregated spending in super categories; variables (313) measure the spending frequencies in various areas; and variables (315) measure the spending amounts in various areas. In one embodiment, each of the areas is identified by a merchant category (306) (e.g., as represented by a merchant category code (MCC), a North American Industry Classification System (NAICS) code, or a similarly standardized category code). In other embodiments, an area may be identified by a product category, a SKU number, etc.

In one embodiment, a variable of a same category (e.g., frequency (313) or amount (315)) is defined to be aggregated over a set of mutually exclusive areas. A transaction is classified in only one of the mutually exclusive areas. For example, in one embodiment, the spending frequency variables (313) are defined for a set of mutually exclusive merchants or merchant categories. Transactions falling within the same category are aggregated.

Examples of the spending frequency variables (313) and spending amount variables (315) defined for various merchant categories (e.g., 306) in one embodiment are provided in U.S. patent application Ser. No. 12/537,566, filed Aug. 7, 2009 and entitled “Cardholder Clusters,” and in Prov. U.S. Pat. App. Ser. No. 61/182,806, filed Jun. 1, 2009 and entitled “Cardholder Clusters,” the disclosures of which applications are hereby incorporated herein by reference.

In one embodiment, super categories (311) are defined to group the categories (e.g., 306) used in transaction records (301). The super categories (311) can be mutually exclusive. For example, each merchant category (306) is classified under only one super merchant category but not any other super merchant categories. Since the generation of the list of super categories typically requires deep domain knowledge about the businesses of the merchants in various categories, super categories (311) are not used in one embodiment.

In one embodiment, the aggregation (317) includes the application of the definitions (309) for these variables (e.g., 311, 313, and 315) to the transaction records (301) to generate the variable values (321). The transaction records (301) are aggregated to generate aggregated measurements (e.g., variable values (321)) that are not specific to a particular transaction, such as frequencies of purchases made with different merchants or different groups of merchants, the amounts spent with different merchants or different groups of merchants, and the number of unique purchases across different merchants or different groups of merchants, etc. The aggregation (317) can be performed for a particular time period and for entities at various levels.

In one embodiment, the transaction records (301) are aggregated according to a buying entity. The aggregation (317) can be performed at account level, person level, family level, company level, neighborhood level, city level, region level, etc. to analyze the spending patterns across various areas (e.g., sellers, products or services) for the respective aggregated buying entity. For example, the transaction records (301) for a particular account (e.g., presented by the account number (302)) can be aggregated for an account level analysis. To aggregate the transaction records (301) in account level, the transactions with a specific merchant or merchants in a specific category are counted according to the variable definitions (309) for a particular account to generate a frequency measure (e.g., 313) for the account relative to the specific merchant or merchant category; and the transaction amounts (e.g., 304) with the specific merchant or the specific category of merchants are summed for the particular account to generate an average spending amount for the account relative to the specific merchant or merchant category. For example, the transaction records (301) for a particular person having multiple accounts can be aggregated for a person level analysis, the transaction records (301) aggregated for a particular family for a family level analysis, and the transaction records (301) for a particular business aggregated for a business level analysis.

The aggregation (317) can be performed for a predetermined time period, such as for the transactions occurring in the past month, in the past three months, in the past twelve months, etc.

In another embodiment, the transaction records (301) are aggregated according to a selling entity. The spending patterns at the selling entity across various buyers, products or services can be analyzed. For example, the transaction records (301) for a particular merchant having transactions with multiple accounts can be aggregated for a merchant level analysis. For example, the transaction records (301) for a particular merchant group can be aggregated for a merchant group level analysis.

In one embodiment, the aggregation (317) is formed separately for different types of transactions, such as transactions made online, offline, via phone, and/or “card-present”transactions vs. “card-not-present” transactions, which can be used to identify the spending pattern differences among different types of transactions.

In one embodiment, the variable values (e.g., 323, 324, . . . , 325) associated with an entity ID (322) are considered the random samples of the respective variables (e.g., 311, 313, 315), sampled for the instance of an entity represented by the entity ID (322). Statistical analyses (e.g., factor analysis (327) and cluster analysis (329)) are performed to identify the patterns and correlations in the random samples.

For example, a cluster analysis (329) can identify a set of clusters and thus cluster definitions (333) (e.g., the locations of the centroids of the clusters). In one embodiment, each entity ID (322) is represented as a point in a mathematical space defined by the set of variables; and the variable values (323, 324, . . . , 325) of the entity ID (322) determine the coordinates of the point in the space and thus the location of the point in the space. Various points may be concentrated in various regions; and the cluster analysis (329) is configured to formulate the positioning of the points to drive the clustering of the points. In other embodiments, the cluster analysis (329) can also be performed using the techniques of Self Organizing Maps (SOM), which can identify and show clusters of multi-dimensional data using a representation on a two-dimensional map.

Once the cluster definitions (333) are obtained from the cluster analysis (329), the identity of the cluster (e.g., cluster ID (343)) that contains the entity ID (322) can be used to characterize spending behavior of the entity represented by the entity ID (322). The entities in the same cluster are considered to have similar spending behaviors.

Similarities and differences among the entities, such as accounts, individuals, families, etc., as represented by the entity ID (e.g., 322) and characterized by the variable values (e.g., 323, 324, . . . , 325) can be identified via the cluster analysis (329). In one embodiment, after a number of clusters of entity IDs are identified based on the patterns of the aggregated measurements, a set of profiles can be generated for the clusters to represent the characteristics of the clusters. Once the clusters are identified, each of the entity IDs (e.g., corresponding to an account, individual, family) can be assigned to one cluster; and the profile for the corresponding cluster may be used to represent, at least in part, the entity (e.g., account, individual, family). Alternatively, the relationship between an entity (e.g., an account, individual, family) and one or more clusters can be determined (e.g., based on a measurement of closeness to each cluster). Thus, the cluster related data can be used in a transaction profile (127 or 341) to provide information about the behavior of the entity (e.g., an account, an individual, a family).

In one embodiment, more than one set of cluster definitions (333) is generated from cluster analyses (329). For example, cluster analyses (329) may generate different sets of cluster solutions corresponding to different numbers of identified clusters. A set of cluster IDs (e.g., 343) can be used to summarize (335) the spending behavior of the entity represented by the entity ID (322), based on the typical spending behavior of the respective clusters. In one example, two cluster solutions are obtained; one of the cluster solutions has 17 clusters, which classify the entities in a relatively coarse manner; and the other cluster solution has 55 clusters, which classify the entities in a relative fine manner. A cardholder can be identified by the spending behavior of one of the 17 clusters and one of the 55 clusters in which the cardholder is located. Thus, the set of cluster IDs corresponding to the set of cluster solutions provides a hierarchical identification of an entity among clusters of different levels of resolution. The spending behavior of the clusters is represented by the cluster definitions (333), such as the parameters (e.g., variable values) that define the centroids of the clusters.

In one embodiment, the random variables (e.g., 313 and 315) as defined by the definitions (309) have certain degrees of correlation and are not independent from each other. For example, merchants of different merchant categories (e.g., 306) may have overlapping business, or have certain business relationships. For example, certain products and/or services of certain merchants have cause and effect relationships. For example, certain products and/or services of certain merchants are mutually exclusive to a certain degree (e.g., a purchase from one merchant may have a level of probability to exclude the user (101) from making a purchase from another merchant). Such relationships may be complex and difficult to quantify by merely inspecting the categories. Further, such relationships may shift over time as the economy changes.

In one embodiment, a factor analysis (327) is performed to reduce the redundancy and/or correlation among the variables (e.g., 313, 315). The factor analysis (327) identifies the definitions (331) for factors, each of which represents a combination of the variables (e.g., 313, 315).

In one embodiment, a factor is a linear combination of a plurality of the aggregated measurements (e.g., variables (313, 315)) determined for various areas (e.g., merchants or merchant categories, products or product categories). Once the relationship between the factors and the aggregated measurements is determined via factor analysis, the values for the factors can be determined from the linear combinations of the aggregated measurements and be used in a transaction profile (127 or 341) to provide information on the behavior of the entity represented by the entity ID (e.g., an account, an individual, a family).

Once the factor definitions (331) are obtained from the factor analysis (327), the factor definitions (331) can be applied to the variable values (321) to determine factor values (344) for the aggregated spending profile (341). Since redundancy and correlation are reduced in the factors, the number of factors is typically much smaller than the number of the original variables (e.g., 313, 315). Thus, the factor values (344) represent the concise summary of the original variables (e.g., 313, 315).

For example, there may be thousands of variables on spending frequency and amount for different merchant categories; and the factor analysis (327) can reduce the factor number to less than one hundred (and even less than twenty). In one example, a twelve-factor solution is obtained, which allows the use of twelve factors to combine the thousands of the original variables (313, 315); and thus, the spending behavior in thousands of merchant categories can be summarized via twelve factor values (344). In one embodiment, each factor is combination of at least four variables; and a typical variable has contributions to more than one factor.

In one example, hundreds or thousands of transaction records (301) of a cardholder are converted into hundreds or thousands of variable values (321) for various merchant categories, which are summarized (335) via the factor definitions (331) and cluster definitions (333) into twelve factor values (344) and one or two cluster IDs (e.g., 343). The summarized data can be readily interpreted by a human to ascertain the spending behavior of the cardholder. A user (101) may easily specify a spending behavior requirement formulated based on the factor values (344) and the cluster IDs (e.g., to query for a segment of customers, or to request the targeting of a segment of customers). The reduced size of the summarized data reduces the need for data communication bandwidth for communicating the spending behavior of the cardholder over a network connection and allows simplified processing and utilization of the data representing the spending behavior of the cardholder.

In one embodiment, the behavior and characteristics of the clusters are studied to identify a description of a type of representative entities that are found in each of the clusters. The clusters can be named based on the type of representative entities to allow an ordinary person to easily understand the typical behavior of the clusters.

In one embodiment, the behavior and characteristics of the factors are also studied to identify dominant aspects of each factor. The clusters can be named based on the dominant aspects to allow an ordinary person to easily understand the meaning of a factor value.

In FIG. 2, an aggregated spending profile (341) for an entity represented by an entity ID (e.g., 322) includes the cluster ID (343) and factor values (344) determined based on the cluster definitions (333) and the factor definitions (331). The aggregated spending profile (341) may further include other statistical parameters, such as diversity index (342), channel distribution (345), category distribution (346), zip code (347), etc., as further discussed below.

In one embodiment, the diversity index (342) may include an entropy value and/or a Gini coefficient, to represent the diversity of the spending by the entity represented by the entity ID (322) across different areas (e.g., different merchant categories (e.g., 306)). When the diversity index (342) indicates that the diversity of the spending data is under a predetermined threshold level, the variable values (e.g., 323, 324, . . . , 325) for the corresponding entity ID (322) may be excluded from the cluster analysis (329) and/or the factor analysis (327) due to the lack of diversity. When the diversity index (342) of the aggregated spending profile (341) is lower than a predetermined threshold, the factor values (344) and the cluster ID (343) may not accurately represent the spending behavior of the corresponding entity.

In one embodiment, the channel distribution (345) includes a set of percentage values that indicate the percentages of amounts spent in different purchase channels, such as online, via phone, in a retail store, etc.

In one embodiment, the category distribution (346) includes a set of percentage values that indicate the percentages of spending amounts in different super categories (311). In one embodiment, thousands of different merchant categories (e.g., 306) are represented by Merchant Category Codes (MCC), or North American Industry Classification System (NAICS) codes in transaction records (301). These merchant categories (e.g., 306) are classified or combined into less than one hundred super categories (or less than twenty). In one example, fourteen super categories are defined based on domain knowledge.

In one embodiment, the aggregated spending profile (341) includes the aggregated measurements (e.g., frequency, average spending amount) determined for a set of predefined, mutually exclusive merchant categories (e.g., super categories (311)). Each of the super merchant categories represents a type of products or services a customer may purchase. A transaction profile (127 or 341) may include the aggregated measurements for each of the set of mutually exclusive merchant categories. The aggregated measurements determined for the predefined, mutually exclusive merchant categories can be used in transaction profiles (127 or 341) to provide information on the behavior of a respective entity (e.g., an account, an individual, or a family).

In one embodiment, the zip code (347) in the aggregated spending profile (341) represents the dominant geographic area in which the spending associated with the entity ID (322) occurred. Alternatively or in combination, the aggregated spending profile (341) may include a distribution of transaction amounts over a set of zip codes that account for a majority of the transactions or transaction amounts (e.g., 90%).

In one embodiment, the factor analysis (327) and cluster analysis (329) are used to summarize the spending behavior across various areas, such as different merchants characterized by merchant category (306), different products and/or services, different consumers, etc. The aggregated spending profile (341) may include more or fewer fields than those illustrated in FIG. 2. For example, in one embodiment, the aggregated spending profile (341) further includes an aggregated spending amount for a period of time (e.g., the past twelve months); in another embodiment, the aggregated spending profile (341) does not include the category distribution (346); and in a further embodiment, the aggregated spending profile (341) may include a set of distance measures to the centroids of the clusters. The distance measures may be defined based on the variable values (323, 324, . . . , 325), or based on the factor values (344). The factor values of the centroids of the clusters may be estimated based on the entity ID (e.g., 322) that is closest to the centroid in the respective cluster.

Other variables can be used in place of, or in additional to, the variables (311, 313, 315) illustrated in FIG. 2. For example, the aggregated spending profile (341) can be generated using variables measuring shopping radius/distance from the primary address of the account holder to the merchant site for offline purchases. When such variables are used, the transaction patterns can be identified based at least in part on clustering according to shopping radius/distance and geographic regions. Similarly, the factor definition (331) may include the consideration of the shopping radius/distance. For example, the transaction records (301) may be aggregated based on the ranges of shopping radius/distance and/or geographic regions. For example, the factor analysis can be used to determine factors that naturally combine geographical areas based on the correlations in the spending patterns in various geographical areas.

In one embodiment, the aggregation (317) may involve the determination of a deviation from a trend or pattern. For example, an account makes a certain number of purchases a week at a merchant over the past 6 months. However, in the past 2 weeks the number of purchases is less than the average number per week. A measurement of the deviation from the trend or pattern can be used (e.g., in a transaction profile (127 or 341) as a parameter, or in variable definitions (309) for the factor analysis (327) and/or the cluster analysis) to define the behavior of an account, an individual, a family, etc.

FIG. 3 shows a method to generate an aggregated spending profile according to one embodiment. In FIG. 3, computation models are established (351) for variables (e.g., 311, 313, and 315). In one embodiment, the variables are defined in a way to capture certain aspects of the spending statistics, such as frequency, amount, etc.

In FIG. 3, data from related accounts are combined (353). For example, when an account number change has occurred for a cardholder in the time period under analysis, the transaction records (301) under the different account numbers of the same cardholder are combined under one account number that represents the cardholder. For example, when the analysis is performed at a person level (or family level, business level, social group level, city level, or region level), the transaction records (301) in different accounts of the person (or family, business, social group, city or region) can be combined under one entity ID (322) that represents the person (or family, business, social group, city or region).

In one embodiment, recurrent/installment transactions are combined (355). For example, multiple monthly payments may be combined and considered as one single purchase.

In FIG. 3, account data are selected (357) according to a set of criteria related to activity, consistency, diversity, etc.

For example, when a cardholder uses a credit card solely to purchase gas, the diversity of the transactions by the cardholder is low. In such a case, the transactions in the account of the cardholder may not be statistically meaningful to represent the spending pattern of the cardholder in various merchant categories. Thus, in one embodiment, if the diversity of the transactions associated with an entity ID (322) is below a threshold, the variable values (e.g., 323, 324, . . . , 325) corresponding to the entity ID (322) are not used in the cluster analysis (329) and/or the factor analysis (327). The diversity can be examined based on the diversity index (342) (e.g., entropy or Gini coefficient), or based on counting the different merchant categories in the transactions associated with the entity ID (322); and when the count of different merchant categories is fewer than a threshold (e.g., 5), the transactions associated with the entity ID (322) are not used in the cluster analysis (329) and/or the factor analysis (327) due to the lack of diversity.

For example, when a cardholder uses a credit card only sporadically (e.g., when running out of cash), the limited transactions by the cardholder may not be statistically meaningful in representing the spending behavior of the cardholder. Thus, in one embodiment, when the numbers of transactions associated with an entity ID (322) is below a threshold, the variable values (e.g., 323, 324, . . . , 325) corresponding to the entity ID (322) are not used in the cluster analysis (329) and/or the factor analysis (327).

For example, when a cardholder has only used a credit card during a portion of the time period under analysis, the transaction records (301) during the time period may not reflect the consistent behavior of the cardholder for the entire time period. Consistency can be checked in various ways. In one example, if the total number of transactions during the first and last months of the time period under analysis is zero, the transactions associated with the entity ID (322) are inconsistent in the time period and thus are not used in the cluster analysis (329) and/or the factor analysis (327). Other criteria can be formulated to detect inconsistency in the transactions.

In FIG. 3, the computation models (e.g., as represented by the variable definitions (309)) are applied (359) to the remaining account data (e.g., transaction records (301)) to obtain data samples for the variables. The data points associated with the entities, other than those whose transactions fail to meet the minimum requirements for activity, consistency, diversity, etc., are used in factor analysis (327) and cluster analysis (329).

In FIG. 3, the data samples (e.g., variable values (321)) are used to perform (361) factor analysis (327) to identify factor solutions (e.g., factor definitions (331)). The factor solutions can be adjusted (363) to improve similarity in factor values of different sets of transaction data (109). For example, factor definitions (331) can be applied to the transactions in the time period under analysis (e.g., the past twelve months) and be applied separately to the transactions in a prior time period (e.g., the twelve months before the past twelve months) to obtain two sets of factor values. The factor definitions (331) can be adjusted to improve the correlation between the two set of factor values.

The data samples can also be used to perform (365) cluster analysis (329) to identify cluster solutions (e.g., cluster definitions (333)). The cluster solutions can be adjusted (367) to improve similarity in cluster identifications based on different sets of transaction data (109). For example, cluster definitions (333) can be applied to the transactions in the time period under analysis (e.g., the past twelve months) and be applied separately to the transactions in a prior time period (e.g., the twelve months before the past twelve months) to obtain two sets of cluster identifications for various entities. The cluster definitions (333) can be adjusted to improve the correlation between the two set of cluster identifications.

In one embodiment, the number of clusters is determined from clustering analysis. For example, a set of cluster seeds can be initially identified and used to run a known clustering algorithm. The sizes of data points in the clusters are then examined. When a cluster contains less than a predetermined number of data points, the cluster may be eliminated to rerun the clustering analysis.

In one embodiment, standardizing entropy is added to the cluster solution to obtain improved results.

In one embodiment, human understandable characteristics of the factors and clusters are identified (369) to name the factors and clusters. For example, when the spending behavior of a cluster appears to be the behavior of an internet loyalist, the cluster can be named “internet loyalist” such that if a cardholder is found to be in the “internet loyalist” cluster, the spending preferences and patterns of the cardholder can be easily perceived.

In one embodiment, the factor analysis (327) and the cluster analysis (329) are performed periodically (e.g., once a year, or six months) to update the factor definitions (331) and the cluster definitions (333), which may change as the economy and the society change over time.

In FIG. 3, transaction data (109) are summarized (371) using the factor solutions and cluster solutions to generate the aggregated spending profile (341). The aggregated spending profile (341) can be updated more frequently than the factor solutions and cluster solutions, when the new transaction data (109) becomes available. For example, the aggregated spending profile (341) may be updated quarterly or monthly.

Various tweaks and adjustments can be made for the variables (e.g., 313, 315) used for the factor analysis (327) and the cluster analysis (329). For example, the transaction records (301) may be filtered, weighted or constrained, according to different rules to improve the capabilities of the aggregated measurements in indicating certain aspects of the spending behavior of the customers.

For example, in one embodiment, the variables (e.g., 313, 315) are normalized and/or standardized (e.g., using statistical average, mean, and/or variance).

For example, the variables (e.g., 313, 315) for the aggregated measurements can be tuned, via filtering and weighting, to predict the future trend of spending behavior (e.g., for advertisement selection), to identify abnormal behavior (e.g., for fraud prevention), or to identify a change in spending pattern (e.g., for advertisement audience measurement), etc. The aggregated measurements, the factor values (344), and/or the cluster ID (343) generated from the aggregated measurements can be used in a transaction profile (127 or 341) to define the behavior of an account, an individual, a family, etc.

In one embodiment, the transaction data (109) are aged to provide more weight to recent data than older data. In other embodiments, the transaction data (109) are reverse aged. In further embodiments, the transaction data (109) are seasonally adjusted.

In one embodiment, the variables (e.g., 313, 315) are constrained to eliminate extreme outliers. For example, the minimum values and the maximum values of the spending amounts (315) may be constrained based on values at certain percentiles (e.g., the value at one percentile as the minimum and the value at 99 percentile as the maximum) and/or certain predetermined values. In one embodiment, the spending frequency variables (313) are constrained based on values at certain percentiles and median values. For example, the minimum value for a spending frequency variable (313) may be constrained at P₁−k×(M−P₁), where P₁ is the one percentile value, M the median value, and k a predetermined constant (e.g., 0.1). For example, the maximum value for a spending frequency variable (313) may be constrained at P₉₉+a×(P99−M), where P₉₉ is the 99 percentile value, M the median value, and k a predetermined constant (e.g., 0.1).

In one embodiment, variable pruning is performed to reduce the number of variables (e.g., 313, 315) that have less impact on cluster solutions and/or factor solutions. For example, variables with standard variation less than a predetermined threshold (e.g., 0.1) may be discarded for the purpose of cluster analysis (329). For example, analysis of variance (ANOVA) can be performed to identify and remove variables that are no more significant than a predetermined threshold.

The aggregated spending profile (341) can provide information on spending behavior for various application areas, such as marketing, fraud detection and prevention, creditworthiness assessment, loyalty analytics, targeting of offers, etc.

For example, clusters can be used to optimize offers for various groups within an advertisement campaign. The use of factors and clusters to target advertisement can improve the speed of producing targeting models. For example, using variables based on factors and clusters (and thus eliminating the need to use a large number of conventional variables) can improve predictive models and increase efficiency of targeting by reducing the number of variables examined. The variables formulated based on factors and/or clusters can be used with other variables to build predictive models based on spending behaviors.

In one embodiment, the aggregated spending profile (341) can be used to monitor risks in transactions. Factor values are typically consistent over time for each entity. An abrupt change in some of the factor values may indicate a change in financial conditions, or a fraudulent use of the account. Models formulated using factors and clusters can be used to identify a series of transactions that do not follow a normal pattern specified by the factor values (344) and/or the cluster ID (343). Potential bankruptcies can be predicted by analyzing the change of factor values over time; and significant changes in spending behavior may be detected to stop and/or prevent fraudulent activities.

For example, the factor values (344) can be used in regression models and/or neural network models for the detection of certain behaviors or patterns. Since factors are relatively non-collinear, the factors can work well as independent variables. For example, factors and clusters can be used as independent variables in tree models.

For example, surrogate accounts can be selected for the construction of a quasi-control group. For example, for a given account A that is in one cluster, the account B that is closest to the account A in the same cluster can be selected as a surrogate account of the account B. The closeness can be determined by certain values in the aggregated spending profile (341), such as factor values (344), category distribution (346), etc. For example, a Euclidian distance defined based on the set of values from the aggregated spending profile (341) can be used to compare the distances between the accounts. Once identified, the surrogate account can be used to reduce or eliminate bias in measurements. For example, to determine the effect of an advertisement, the spending pattern response of the account A that is exposed to the advertisement can be compared to the spending pattern response of the account B that is not exposed to the advertisement.

For example, the aggregated spending profile (341) can be used in segmentation and/or filtering analysis, such as selecting cardholders having similar spending behaviors identified via factors and/or clusters for targeted advertisement campaigns, and selecting and determining a group of merchants that could be potentially marketed towards cardholders originating in a given cluster (e.g., for bundled offers). For example, a query interface can be provided to allow the query to identify a targeted population based on a set of criteria formulated using the values of clusters and factors.

For example, the aggregated spending profile (341) can be used in a spending comparison report, such as comparing a sub-population of interest against the overall population, determining how cluster distributions and mean factor values differ, and building reports for merchants and/or issuers for benchmarking purposes. For example, reports can be generated according to clusters in an automated way for the merchants. For example, the aggregated spending profile (341) can be used in geographic reports by identifying geographic areas where cardholders shop most frequently and comparing predominant spending locations with cardholder residence locations.

In one embodiment, the profile generator (121) provides affinity relationship data in the transaction profiles (127) so that the transaction profiles (127) can be shared with business partners without compromising the privacy of the users (101) and the transaction details.

For example, in one embodiment, the profile generator (121) is to identify clusters of entities (e.g., accounts, cardholders, families, businesses, cities, regions, etc.) based on the spending patterns of the entities. The clusters represent entity segments identified based on the spending patterns of the entities reflected in the transaction data (109) or the transaction records (301).

In one embodiment, the clusters correspond to cells or regions in the mathematical space that contain the respective groups of entities. For example, the mathematical space representing the characteristics of users (101) may be divided into clusters (cells or regions). For example, the cluster analysis (329) may identify one cluster in the cell or region that contains a cluster of entity IDs (e.g., 322) in the space having a plurality of dimensions corresponding to the variables (e.g., 313 and 315). For example, a cluster can also be identified as a cell or region in a space defined by the factors using the factor definitions (331) generated from the factor analysis (327).

In one embodiment, the parameters used in the aggregated spending profile (341) can be used to define a segment or a cluster of entities. For example, a value for the cluster ID (343) and a set of ranges for the factor values (344) and/or other values can be used to define a segment.

In one embodiment, a set of clusters are standardized to represent the predilection of entities in various groups for certain products or services. For example, a set of standardized clusters can be formulated for people who have shopped, for example, at home improvement stores. The cardholders in the same cluster have similar spending behavior.

In one embodiment, the tendency or likelihood of a user (101) being in a particular cluster (i.e. the user's affinity to the cell) can be characterized using a value, based on past purchases. The same user (101) may have different affinity values for different clusters.

For example, a set of affinity values can be computed for an entity, based on the transaction records (301), to indicate the closeness or predilection of the entity to the set of standardized clusters. For example, a cardholder who has a first value representing affinity of the cardholder to a first cluster may have a second value representing affinity of the cardholder to a second cluster. For example, if a consumer buys a lot of electronics, the affinity value of the consumer to the electronics cluster is high.

In one embodiment, other indicators are formulated across the merchant community and cardholder behavior and provided in the profile (e.g., 127 or 341) to indicate the risk of a transaction.

In one embodiment, the relationship of a pair of values from two different clusters provides an indication of the likelihood that the user (101) is in one of the two cells, if the user (101) is shown to be in the other cell. For example, if the likelihood of the user (101) to purchase each of two types of products is known, the scores can be used to determine the likelihood of the user (101) buying one of the two types of products if the user (101) is known to be interested in the other type of products. In one embodiment, a map of the values for the clusters is used in a profile (e.g., 127 or 341) to characterize the spending behavior of the user (101) (or other types of entities, such as a family, company, neighborhood, city, or other types of groups defined by other aggregate parameters, such as time of day, etc.).

In one embodiment, the clusters and affinity information are standardized to allow sharing between business partners, such as transaction processing organizations, search providers, and marketers. Purchase statistics and search statistics are generally described in different ways. For example, purchase statistics are based on merchants, merchant categories, SKU numbers, product descriptions, etc.; and search statistics are based on search terms. Once the clusters are standardized, the clusters can be used to link purchase information based merchant categories (and/or SKU numbers, product descriptions) with search information based on search terms. Thus, search predilection and purchase predilection can be mapped to each other.

In one embodiment, the purchase data and the search data (or other third party data) are correlated based on mapping to the standardized clusters (cells or segments). The purchase data and the search data (or other third party data) can be used together to provide benefits or offers (e.g., coupons) to consumers. For example, standardized clusters can be used as a marketing tool to provide relevant benefits, including coupons, statement credits, or the like to consumers who are within or are associated with common clusters. For example, a data exchange apparatus may obtain cluster data based on consumer search engine data and actual payment transaction data to identify like groups of individuals who may respond favorably to particular types of benefits, such as coupons and statement credits.

Details about aggregated spending profile (341) in one embodiment are provided in U.S. patent application Ser. No. 12/777,173, filed May 10, 2010, and entitled “Systems and Methods to Summarize Transaction Data,” the disclosure of which is hereby incorporated herein by reference.

### Transaction Data Based Portal

In FIG. 1, the transaction terminal (105) initiates the transaction for a user (101) (e.g., a customer) for processing by a transaction handler (103). The transaction handler (103) processes the transaction and stores transaction data (109) about the transaction, in connection with account data (111), such as the account profile of an account of the user (101). The account data (111) may further include data about the user (101), collected from issuers or merchants, and/or other sources, such as social networks, credit bureaus, merchant provided information, address information, etc. In one embodiment, a transaction may be initiated by a server (e.g., based on a stored schedule for recurrent payments).

Over a period of time, the transaction handler (103) accumulates the transaction data (109) from transactions initiated at different transaction terminals (e.g., 105) for different users (e.g., 101). The transaction data (109) thus includes information on purchases made by various users (e.g., 101) at various times via different purchases options (e.g., online purchase, offline purchase from a retail store, mail order, order via phone, etc.)

In one embodiment, the accumulated transaction data (109) and the corresponding account data (111) are used to generate intelligence information about the purchase behavior, pattern, preference, tendency, frequency, trend, amount and/or propensity of the users (e.g., 101), as individuals or as a member of a group. The intelligence information can then be used to generate, identify and/or select targeted advertisements for presentation to the user (101) on the point of interaction (107), during a transaction, after a transaction, or when other opportunities arise.

FIG. 4 shows a system to provide information based on transaction data (109) according to one embodiment. In FIG. 4, the transaction handler (103) is coupled between an issuer processor (145) and an acquirer processor (147) to facilitate authorization and settlement of transactions between a consumer account (146) and a merchant account (148). The transaction handler (103) records the transactions in the data warehouse (149). The portal (143) is coupled to the data warehouse (149) to provide information based on the transaction records (301), such as the transaction profiles (127) or aggregated spending profile (341). The portal (143) may be implemented as a web portal, a telephone gateway, a file/data server, etc.

In one embodiment, the portal (143) is configured to provide information, such as transaction profiles (127) to third parties. Further, the portal (143) may register certain users (101) for various programs, such as a loyalty program to provide rewards and/or offers to the users (101).

In one embodiment, the portal (143) is to register the interest of users (101), or to obtain permissions from the users (101) to gather further information about the users (101), such as data capturing purchase details, online activities, etc.

In one embodiment, the user (101) may register via the issuer; and the registration data in the consumer account (146) may propagate to the data warehouse (149) upon approval from the user (101).

In one embodiment, the portal (143) is to register merchants and provide services and/or information to merchants.

In one embodiment, the portal (143) is to receive information from third parties, such as search engines, merchants, web sites, etc. The third party data can be correlated with the transaction data (109) to identify the relationships between purchases and other events, such as searches, news announcements, conferences, meetings, etc., and improve the prediction capability and accuracy.

In FIG. 4, the consumer account (146) is under the control of the issuer processor (145). The consumer account (146) may be owned by an individual, or an organization such as a business, a school, etc. The consumer account (146) may be a credit account, a debit account, or a stored value account. The issuer may provide the consumer (e.g., user (101)) an account identification device (141) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

In one embodiment, the account identification device (141) is a plastic card having a magnetic strip storing account information (142) identifying the consumer account (146) and/or the issuer processor (145). Alternatively, the account identification device (141) is a smartcard having an integrated circuit chip storing at least the account information (142). In one embodiment, the account identification device (141) includes a mobile phone having an integrated smartcard.

In one embodiment, the account information (142) is printed or embossed on the account identification device (141). The account information (142) may be printed as a bar code to allow the transaction terminal (105) to read the information via an optical scanner. The account information (142) may be stored in a memory of the account identification device (141) and configured to be read via wireless, contactless communications, such as near field communications via magnetic field coupling, infrared communications, or radio frequency communications. Alternatively, the transaction terminal (105) may require contact with the account identification device (141) to read the account information (142) (e.g., by reading the magnetic strip of a card with a magnetic strip reader).

In one embodiment, the transaction terminal (105) is configured to transmit an authorization request message to the acquirer processor (147). The authorization request includes the account information (142), an amount of payment, and information about the merchant (e.g., an indication of the merchant account (148)). The acquirer processor (147) requests the transaction handler (103) to process the authorization request, based on the account information (142) received in the transaction terminal (105). The transaction handler (103) routes the authorization request to the issuer processor (145) and may process and respond to the authorization request when the issuer processor (145) is not available. The issuer processor (145) determines whether to authorize the transaction based at least in part on a balance of the consumer account (146).

In one embodiment, the transaction handler (103), the issuer processor (145), and the acquirer processor (147) may each include a subsystem to identify the risk in the transaction and may reject the transaction based on the risk assessment.

In one embodiment, the account identification device (141) includes security features to prevent unauthorized uses of the consumer account (146), such as a logo to show the authenticity of the account identification device (141), encryption to protect the account information (142), etc.

In one embodiment, the transaction terminal (105) is configured to interact with the account identification device (141) to obtain the account information (142) that identifies the consumer account (146) and/or the issuer processor (145). The transaction terminal (105) communicates with the acquirer processor (147) that controls the merchant account (148) of a merchant. The transaction terminal (105) may communicate with the acquirer processor (147) via a data communication connection, such as a telephone connection, an Internet connection, etc. The acquirer processor (147) is to collect payments into the merchant account (148) on behalf of the merchant.

In one embodiment, the transaction terminal (105) is a POS terminal at a traditional, offline, “brick and mortar” retail store. In another embodiment, the transaction terminal (105) is an online server that receives account information (142) of the consumer account (146) from the user (101) through a web connection. In one embodiment, the user (101) may provide account information (142) through a telephone call, via verbal communications with a representative of the merchant; and the representative enters the account information (142) into the transaction terminal (105) to initiate the transaction.

In one embodiment, the account information (142) can be entered directly into the transaction terminal (105) to make payment from the consumer account (146), without having to physically present the account identification device (141). When a transaction is initiated without physically presenting an account identification device (141), the transaction is classified as a “card-not-present” (CNP) transaction.

In one embodiment, the issuer processor (145) may control more than one consumer account (146); the acquirer processor (147) may control more than one merchant account (148); and the transaction handler (103) is connected between a plurality of issuer processors (e.g., 145) and a plurality of acquirer processors (e.g., 147). An entity (e.g., bank) may operate both an issuer processor (145) and an acquirer processor (147).

In one embodiment, the transaction handler (103), the issuer processor (145), the acquirer processor (147), the transaction terminal (105), the portal (143), and other devices and/or services accessing the portal (143) are connected via communications networks, such as local area networks, cellular telecommunications networks, wireless wide area networks, wireless local area networks, an intranet, and Internet. In one embodiment, dedicated communication channels are used between the transaction handler (103) and the issuer processor (145), between the transaction handler (103) and the acquirer processor (147), and/or between the portal (143) and the transaction handler (103).

In one embodiment, the transaction handler (103) uses the data warehouse (149) to store the records about the transactions, such as the transaction records (301) or transaction data (109). In one embodiment, the transaction handler (103) includes a powerful computer, or cluster of computers functioning as a unit, controlled by instructions stored on a computer readable medium.

In one embodiment, the transaction handler (103) is configured to support and deliver authorization services, exception file services, and clearing and settlement services. In one embodiment, the transaction handler (103) has a subsystem to process authorization requests and another subsystem to perform clearing and settlement services.

In one embodiment, the transaction handler (103) is configured to process different types of transactions, such credit card transactions, debit card transactions, prepaid card transactions, and other types of commercial transactions.

In one embodiment, the transaction handler (103) facilitates the communications between the issuer processor (145) and the acquirer processor (147).

In one embodiment, the transaction terminal (105) is configured to submit the authorized transactions to the acquirer processor (147) for settlement. The amount for the settlement may be different from the amount specified in the authorization request. The transaction handler (103) is coupled between the issuer processor (145) and the acquirer processor (147) to facilitate the clearing and settling of the transaction. Clearing includes the exchange of financial information between the issuer processor (145) and the acquirer processor (147); and settlement includes the exchange of funds.

In one embodiment, the issuer processor (145) is to provide funds to make payments on behalf of the consumer account (146). The acquirer processor (147) is to receive the funds on behalf of the merchant account (148). The issuer processor (145) and the acquirer processor (147) communicate with the transaction handler (103) to coordinate the transfer of funds for the transaction. In one embodiment, the funds are transferred electronically.

In one embodiment, the transaction terminal (105) may submit a transaction directly for settlement, without having to separately submit an authorization request.

In one embodiment, the portal (143) provides a user interface to allow the user (101) to organize the transactions in one or more consumer accounts (145) of the user with one or more issuers. The user (101) may organize the transactions using information and/or categories identified in the transaction records (301), such as merchant category (306), transaction date (303), amount (304), etc. Examples and techniques in one embodiment are provided in U.S. patent application Ser. No. 11/378,215, filed Mar. 16, 2006, assigned Pub. No. 2007/0055597, and entitled “Method and System for Manipulating Purchase Information,” the disclosure of which is hereby incorporated herein by reference.

In one embodiment, the portal (143) provides transaction based statistics, such as indicators for retail spending monitoring, indicators for merchant benchmarking, industry/market segmentation, indicators of spending patterns, etc. Further examples can be found in U.S. patent application Ser. No. 12/191,796, filed Aug. 14, 2008, assigned Pub. No. 2009/0048884, and entitled “Merchant Benchmarking Tool,” U.S. patent application Ser. No. 12/940,562, filed Nov. 5, 2010, and U.S. patent application Ser. No. 12/940,664, filed Nov. 5, 2010, the disclosures of which applications are hereby incorporated herein by reference.

### Transaction Terminal

FIG. 5 illustrates a transaction terminal according to one embodiment. In FIG. 5, the transaction terminal (105) is configured to interact with an account identification device (141) to obtain account information (142) about the consumer account (146).

In one embodiment, the transaction terminal (105) includes a memory (167) coupled to the processor (151), which controls the operations of a reader (163), an input device (153), an output device (165) and a network interface (161). The memory (167) may store instructions for the processor (151) and/or data, such as an identification that is associated with the merchant account (148).

In one embodiment, the reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

In one embodiment, the input device (153) includes key buttons that can be used to enter the account information (142) directly into the transaction terminal (105) without the physical presence of the account identification device (141). The input device (153) can be configured to provide further information to initiate a transaction, such as a personal identification number (PIN), password, zip code, etc. that may be used to access the account identification device (141), or in combination with the account information (142) obtained from the account identification device (141).

In one embodiment, the output device (165) may include a display, a speaker, and/or a printer to present information, such as the result of an authorization request, a receipt for the transaction, an advertisement, etc.

In one embodiment, the network interface (161) is configured to communicate with the acquirer processor (147) via a telephone connection, an Internet connection, or a dedicated data communication channel.

In one embodiment, the instructions stored in the memory (167) are configured at least to cause the transaction terminal (105) to send an authorization request message to the acquirer processor (147) to initiate a transaction. The transaction terminal (105) may or may not send a separate request for the clearing and settling of the transaction. The instructions stored in the memory (167) are also configured to cause the transaction terminal (105) to perform other types of functions discussed in this description.

In one embodiment, a transaction terminal (105) may have fewer components than those illustrated in FIG. 5. For example, in one embodiment, the transaction terminal (105) is configured for “card-not-present” transactions; and the transaction terminal (105) does not have a reader (163).

In one embodiment, a transaction terminal (105) may have more components than those illustrated in FIG. 5. For example, in one embodiment, the transaction terminal (105) is an ATM machine, which includes components to dispense cash under certain conditions.

### Account Identification Device

FIG. 6 illustrates an account identifying device according to one embodiment. In FIG. 6, the account identification device (141) is configured to carry account information (142) that identifies the consumer account (146).

In one embodiment, the account identification device (141) includes a memory (167) coupled to the processor (151), which controls the operations of a communication device (159), an input device (153), an audio device (157) and a display device (155). The memory (167) may store instructions for the processor (151) and/or data, such as the account information (142) associated with the consumer account (146).

In one embodiment, the account information (142) includes an identifier identifying the issuer (and thus the issuer processor (145)) among a plurality of issuers, and an identifier identifying the consumer account among a plurality of consumer accounts controlled by the issuer processor (145). The account information (142) may include an expiration date of the account identification device (141), the name of the consumer holding the consumer account (146), and/or an identifier identifying the account identification device (141) among a plurality of account identification devices associated with the consumer account (146).

In one embodiment, the account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

In one embodiment, the memory includes a nonvolatile memory, such as magnetic strip, a memory chip, a flash memory, a Read Only Memory (ROM), etc. to store the account information (142).

In one embodiment, the information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the communication device (159) includes a semiconductor chip to implement a transceiver for communication with the reader (163) and an antenna to provide and/or receive wireless signals.

In one embodiment, the communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In one embodiment, the account identification device (141) is in the form of a mobile phone, personal digital assistant (PDA), etc. The input device (153) can be used to provide input to the processor (151) to control the operation of the account identification device (141); and the audio device (157) and the display device (155) may present status information and/or other information, such as advertisements or offers. The account identification device (141) may include further components that are not shown in FIG. 6, such as a cellular communications subsystem.

In one embodiment, the communication device (159) may access the account information (142) stored on the memory (167) without going through the processor (151).

In one embodiment, the account identification device (141) has fewer components than those illustrated in FIG. 6. For example, an account identification device (141) does not have the input device (153), the audio device (157) and the display device (155) in one embodiment; and in another embodiment, an account identification device (141) does not have components (151-159).

For example, in one embodiment, an account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide account information (142) in one embodiment.

In one embodiment, the account identification device (141) has the semiconductor chip but not the magnetic strip.

In one embodiment, the account identification device (141) is integrated with a security device, such as an access card, a radio frequency identification (RFID) tag, a security card, a transponder, etc.

In one embodiment, the account identification device (141) is a handheld and compact device. In one embodiment, the account identification device (141) has a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (142).

### Point of Interaction

In one embodiment, the point of interaction (107) is to provide an advertisement to the user (101), or to provide information derived from the transaction data (109) to the user (101).

In one embodiment, an advertisement is a marketing interaction which may include an announcement and/or an offer of a benefit, such as a discount, incentive, reward, coupon, gift, cash back, or opportunity (e.g., special ticket/admission). An advertisement may include an offer of a product or service, an announcement of a product or service, or a presentation of a brand of products or services, or a notice of events, facts, opinions, etc. The advertisements can be presented in text, graphics, audio, video, or animation, and as printed matter, web content, interactive media, etc. An advertisement may be presented in response to the presence of a financial transaction card, or in response to a financial transaction card being used to make a financial transaction, or in response to other user activities, such as browsing a web page, submitting a search request, communicating online, entering a wireless communication zone, etc. In one embodiment, the presentation of advertisements may not be a result of a user action.

In one embodiment, the point of interaction (107) can be one of various endpoints of the transaction network, such as point of sale (POS) terminals, automated teller machines (ATMs), electronic kiosks (or computer kiosks or interactive kiosks), self-assist checkout terminals, vending machines, gas pumps, websites of banks (e.g., issuer banks or acquirer banks of credit cards), bank statements (e.g., credit card statements), websites of the transaction handler (103), websites of merchants, checkout websites or web pages for online purchases, etc.

In one embodiment, the point of interaction (107) may be the same as the transaction terminal (105), such as a point of sale (POS) terminal, an automated teller machine (ATM), a mobile phone, a computer of the user for an online transaction, etc. In one embodiment, the point of interaction (107) may be co-located with the transaction terminal (105), or produced by the transaction terminal (e.g., a receipt produced by the transaction terminal (105)). In one embodiment, the point of interaction (107) may be separate from and not co-located with the transaction terminal (105), such as a mobile phone, a personal digital assistant, a personal computer of the user, a voice mail box of the user, an email inbox of the user, etc.

For example, the advertisements can be presented on a portion of media for a transaction with the customer, which portion might otherwise be unused and thus referred to as a “white space” herein. A white space can be on a printed matter (e.g., a receipt printed for the transaction, or a printed credit card statement), on a video display (e.g., a display monitor of a POS terminal for a retail transaction, an ATM for cash withdrawal or money transfer, a personal computer of the customer for online purchases), or on an audio channel (e.g., an interactive voice response (IVR) system for a transaction over a telephonic device).

In one embodiment, the white space is part of a media channel available to present a message from the transaction handler (103) in connection with the processing of a transaction of the user (101). In one embodiment, the white space is in a media channel that is used to report information about a transaction of the user (101), such as an authorization status, a confirmation message, a verification message, a user interface to verify a password for the online use of the account information (142), a monthly statement, an alert or a report, or a web page provided by the portal (143) to access a loyalty program associated with the consumer account (146) or a registration program.

In other embodiments, the advertisements can also be presented via other media channels which may not involve a transaction processed by the transaction handler (103). For example, the advertisements can be presented on publications or announcements (e.g., newspapers, magazines, books, directories, radio broadcasts, television, etc., which may be in an electronic form, or in a printed or painted form). The advertisements may be presented on paper, on websites, on billboards, or on audio portals.

In one embodiment, the transaction handler (103) purchases the rights to use the media channels from the owner or operators of the media channels and uses the media channels as advertisement spaces. For example, white spaces at a point of interaction (e.g., 107) with customers for transactions processed by the transaction handler (103) can be used to deliver advertisements relevant to the customers conducting the transactions; and the advertisement can be selected based at least in part on the intelligence information derived from the accumulated transaction data (109) and/or the context at the point of interaction (107) and/or the transaction terminal (105).

In general, a point of interaction (e.g., 107) may or may not be capable of receiving inputs from the customers, and may or may not co-located with a transaction terminal (e.g., 105) that initiates the transactions. The white spaces for presenting the advertisement on the point of interaction (107) may be on a portion of a geographical display space (e.g., on a screen), or on a temporal space (e.g., in an audio stream).

In one embodiment, the point of interaction (107) may be used primarily to access services not provided by the transaction handler (103), such as services provided by a search engine, a social networking website, an online marketplace, a blog, a news site, a television program provider, a radio station, a satellite, a publisher, etc.

In one embodiment, a consumer device is used as the point of interaction (107), which may be a non-portable consumer device or a portable computing device. The consumer device is to provide media content to the user (101) and may receive input from the user (101).

Examples of non-portable consumer devices include a computer terminal, a television set, a personal computer, a set-top box, or the like. Examples of portable consumer devices include a portable computer, a cellular phone, a personal digital assistant (PDA), a pager, a security card, a wireless terminal, or the like. The consumer device may be implemented as a data processing system as illustrated in FIG. 7, with more or fewer components.

In one embodiment, the consumer device includes an account identification device (141). For example, a smart card used as an account identification device (141) is integrated with a mobile phone, or a personal digital assistant (PDA).

In one embodiment, the point of interaction (107) is integrated with a transaction terminal (105). For example, a self-service checkout terminal includes a touch pad to interact with the user (101); and an ATM machine includes a user interface subsystem to interact with the user (101).

### Hardware

In one embodiment, a computing apparatus is configured to include some of the modules or components illustrated in FIGS. 1 and 4, such as the transaction handler (103), the profile generator (121), the media controller (115), the portal (143), the profile selector (129), the advertisement selector (133), the user tracker (113), the correlator, and their associated storage devices, such as the data warehouse (149).

In one embodiment, at least some of the modules or components illustrated in FIGS. 1 and 4, such as the transaction handler (103), the transaction terminal (105), the point of interaction (107), the user tracker (113), the media controller (115), the correlator (117), the profile generator (121), the profile selector (129), the advertisement selector (133), the portal (143), the issuer processor (145), the acquirer processor (147), and the account identification device (141), can be implemented as a computer system, such as a data processing system illustrated in FIG. 7, with more or fewer components. Some of the modules may share hardware or be combined on a computer system. In one embodiment, a network of computers can be used to implement one or more of the modules.

Further, the data illustrated in FIG. 1, such as transaction data (109), account data (111), transaction profiles (127), and advertisement data (135), can be stored in storage devices of one or more computers accessible to the corresponding modules illustrated in FIG. 1. For example, the transaction data (109) can be stored in the data warehouse (149) that can be implemented as a data processing system illustrated in FIG. 7, with more or fewer components.

In one embodiment, the transaction handler (103) is a payment processing system, or a payment card processor, such as a card processor for credit cards, debit cards, etc.

FIG. 7 illustrates a data processing system according to one embodiment. While FIG. 7 illustrates various components of a computer system, it is not intended to represent any particular architecture or manner of interconnecting the components. One embodiment may use other systems that have fewer or more components than those shown in FIG. 7.

In FIG. 7, the data processing system (170) includes an inter-connect (171) (e.g., bus and system core logic), which interconnects a microprocessor(s) (173) and memory (167). The microprocessor (173) is coupled to cache memory (179) in the example of FIG. 7.

In one embodiment, the inter-connect (171) interconnects the microprocessor(s) (173) and the memory (167) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The foregoing description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed or physically configured to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

What is claimed is:

1. An apparatus, comprising:
means for storing transaction data of a plurality of accounts;
means for identifying spending characteristics in a plurality of merchant categories based on the transaction data;
means for ranking the plurality of accounts based on the spending characteristics to generate ranks of the plurality of accounts in the plurality of merchant categories; and
means for computing an opportunity score indicative of a opportunity of each account of the plurality of accounts based at least on the ranks of the plurality of accounts in the plurality of merchant categories.

2. The apparatus of claim 1, further comprising:
means for determining a spending level of each account of the plurality of accounts; and
means for segmenting the plurality of accounts based on the spending level of and the opportunity score for each account of the plurality of accounts.

3. The apparatus of claim 1, further comprising:
means for counting for each respective account of the plurality of accounts, a number of months, within a predetermined period of time, in which months the respective account has at least one transaction meeting a set of predetermined requirements, wherein the opportunity score of the respective account is based on the number of months.

4. The apparatus of claim 3, wherein the set of predetermined requirements include a requirement that the at least one transaction is made at retail locations outside a country in which an account holder of the respective account resides.

5. The apparatus of claim 4, wherein the set of predetermined requirements include a requirement that the at least one transaction is of a card-present type of transactions.

6. The apparatus of claim 3, wherein for each respective account of the plurality of accounts, the opportunity score is generated by combining the number of months and the ranks of the respective account in the plurality of merchant categories among the plurality of accounts.

7. The apparatus of claim 6, wherein the plurality of merchant categories includes more than one category selected from the group consisting of:
restaurant; specialty retail; lodging; and travel and entertainment.

8. The apparatus of claim 7, wherein in at least one of the merchant categories, the ranking is based on highest transaction amount in a single transaction among transactions in each account in the plurality of accounts.

9. The apparatus of claim 8, wherein the at least one of the merchant categories in which the ranking is based on highest transaction amount includes a category of transactions in restaurant.

10. The apparatus of claim 9, further comprising:
means for determining decile values of the respective account based on the ranks of the respective account in the plurality of merchant categories among the plurality of accounts;
means for combining the decile values of the respective account and the number of months counted for the respective account to obtain the opportunity score for the respective account.

11. The apparatus of claim 10, wherein the number of months is limited by a predetermined maximum value and weighted to have a range consistent with decile values.

12. The apparatus of claim 8, wherein combining the decile values and the number of months includes summing results of raising the decile values and the number of months to a predetermined power larger than one.

13. The apparatus of claim 1, further comprising:
means for selecting a subset of the plurality of accounts based on the opportunity score; and
means for providing offers to account holders of the subset of accounts.

14. A method comprising:
storing, by at least one specifically programmed processor, transaction data of a plurality of accounts;
identifying, by the at least one specifically programmed processor, spending characteristics in a plurality of merchant categories based on the transaction data;
ranking, by the at least one specifically programmed processor, the plurality of accounts based on the spending characteristics to generate ranks of the plurality of accounts in the plurality of merchant categories; and
computing, by the at least one specifically programmed processor, an opportunity score indicative of a opportunity of each account of the plurality of accounts based at least on the ranks of the plurality of accounts in the plurality of merchant categories.

15. A computing apparatus, comprising:
at least one processor; and
a memory storing instructions to physically configure the at least one processor to at least:
store transaction data of a plurality of accounts;
identify spending characteristics in a plurality of merchant categories based on the transaction data;
rank the plurality of accounts based on the spending characteristics to generate ranks of the plurality of accounts in the plurality of merchant categories, wherein the ranks identify decile rank of the respective account in spending in the plurality of merchant categories among the plurality of accounts, wherein the plurality of merchant categories includes restaurant, specialty retail, and lodging; and
compute an opportunity score indicative of a opportunity of each respective account of the plurality of accounts based at least on the ranks of the plurality of accounts in the plurality of merchant categories.

16. The computing apparatus of claim 15, wherein the memory further stores instructions to physically configure the at least one processor to:
determine an international purchase frequency proxy for the respective account based on counting a number of months, within a predetermined time period, in which months the respective account has at least one transactions that is performed at retail locations outside of a country in which an account holder of the respective account resides and that is performed using a payment instrument configured to present account information to identify the respective account.

17. The computing apparatus of claim 16, wherein the number of months is limited to a predetermined maximum value and weighted to generate the international purchase frequency proxy having a range consistent with a range of the ranks.

18. The computing apparatus of claim 17, wherein the ranks and the frequency proxy are each raised to a predetermined power and summed to obtain the opportunity score.

19. The computing apparatus of claim 15, wherein spending in the merchant category of restaurant is ranked based on highest transaction amount.

20. A method, the method comprising:
storing, in a computing apparatus, transaction data of a plurality of accounts;
identifying spending characteristics in a plurality of merchant categories based on the transaction data;
ranking, by the computing apparatus, the plurality of accounts based on the spending characteristics to generate ranks of the plurality of accounts in the plurality of merchant categories;
counting, by the computing apparatus, for each respective account of the plurality of accounts, a number of months, within a predetermined period of time, in which months the respective account has at least one transaction meeting a set of predetermined requirements, wherein the predetermined requirements include a requirement that the at least one transaction is made at retail locations outside a country in which an account holder of the respective account resides and a requirement that the at least one transaction is of a card-present type of transactions;
computing, by the computing apparatus, an opportunity score indicative of a opportunity of each account of the plurality of accounts based at least on the ranks of the plurality of accounts in the plurality of merchant categories and the number of months;
determining, by the computing apparatus, a spending level of each account of the plurality of accounts;
segmenting the plurality of accounts based on the spending level of and the opportunity score for each account of the plurality of accounts;
selecting a subset of the plurality of accounts based on the opportunity score; and
providing offers to account holders of the subset of accounts.

21. The method of claim 20, the method further comprising:
selecting the spending characteristics based on spending patterns of a second plurality of accounts.

22. The method of claim 20, further comprising:
providing the opportunity score to account issuers of the account holders.

23. The method of claim 20, wherein the plurality of merchant categories includes restaurant; specialty retail; lodging; and travel and entertainment.

24. The method of claim 20, further comprising
determining an aggregate opportunity score based on computed opportunity scores for each of the plurality of accounts of a single account holder.
